(19) United States
(12) Patent Application Publication
(10) Pub. No.: US 2005/0281999 A1
(43) Pub. Date: Dec. 22, 2005

(54) Structural and other composite materials and methods for making same

(75) Inventors: Ray F. Hofmann, Capistrano Beach, CA (US); Bruce Ackert, Henderson, NV (US); Craig K. Collins, San Diego, CA (US); Randy E. Meirowitz, San Diego, CA (US); Tyler M. Dylan, San Diego, CA (US)

Correspondence Address: FOLEY & LARDNER, P.O. BOX 80278, SAN DIEGO, CA, 92138-0278, US

(73) Assignee: PetriTech, Inc.

(21) Appl. No.: 11/061,301

(22) Filed: Feb. 17, 2005

Related U.S. Application Data
(63) Continuation-in-part of application No. 10/947,647, filed on Sep. 22, 2004.
Application No. 10/947,647 is a continuation-in-part of application No. 10/918,663, filed on Aug. 12, 2004.
Application No. 10/918,663 is a continuation-in-part of application No. 10/840,947, filed on May 7, 2004, now abandoned.
Application No. 10/840,947 is a continuation-in-part of application No. 10/799,366, filed on Mar. 12, 2004, now abandoned.
Application No. 10/799,366 is a continuation-in-part of application No. 10/388,295, filed on Mar. 12, 2003, now abandoned.

(51) Int. Cl. B32B 3/26; B32B 27/00; B32B 9/00

(52) U.S. Cl. 428/304.4; 428/318.4; 428/319.3; 428/312.2; 264/46.4; 264/271.1

(57) ABSTRACT

In accordance with the present invention, structural and other composite materials have been developed which have superior performance properties, including high compressive strength, high tensile strength, high shear strength, and high strength-to-weight ratio, and methods for preparing same. Invention materials have the added benefits of ease of manufacture, and are inexpensive to manufacture. The superior performance properties of invention materials render such materials suitable for a wide variety of end uses. For example, a variety of substances can be applied to invention materials without melting, dissolving or degrading the basic structure thereof. This facilitates bonding invention materials to virtually any surface or substrate. Moreover, the bond between invention materials and a variety of substrates is exceptionally strong, rendering the resulting bonded article suitable for use in a variety of demanding applications. Invention materials can be manufactured in a wide variety of sizes, shapes, densities, in multiple layers, and the like; and the performance properties thereof can be evaluated in a variety of ways.

### RELATED APPLICATIONS

This application is a continuation-in-part of application Ser. No. 10/947,647, filed Sep. 22, 2004, now pending, which is a continuation-in-part of application Ser. No. 10/918,663, filed Aug. 12, 2004, now pending, which is a continuation-in-part of application Ser. No. 10/840,947, filed May 7, 2004, now pending, which is a continuation-in-part of application Ser. No. 10/799,366, filed Mar. 12, 2004, now pending, which is a continuation- in-part of application Ser. No. 10/388,295, filed Mar. 12, 2003, now abandoned, the entire contents of each of which are hereby incorporated by reference herein.

### FIELD OF THE INVENTION

The present invention relates to structural and other composite materials and methods for making such materials. In a particular aspect, the present invention relates to building materials. In another aspect, the present invention relates to structural and other composite materials having a variety of shapes, sizes and physical properties. In yet another aspect, the present invention relates to various applications of invention structural and other composite materials. In still another aspect, the present invention relates to lightweight, high- strength articles prepared from invention structural and other composite materials.

### BACKGROUND OF THE INVENTION

Polymeric materials have long been used in the art for the manufacture of structural elements. In one application, a structural element can be simply formed as a solid sheet of polymeric material, for example, by extrusion. However, structural elements prepared in this way tend to be fairly heavy (due to the density of the polymeric material), and have poor thermal insulating properties. In addition, such structures also tend to be quite expensive since a considerable amount of polymeric material is required to form such structures.

An alternate method employed in the art for preparation of structural elements is the use of foamed polymeric materials, such as, for example, polyethylene, polypropylene, polystyrene or polyurethane. While the resulting structures are much less dense than an equivalent solid structural element, and have enhanced insulating properties, they are generally rather expensive structures to produce. Moreover, specifically in the case of polystyrene, the resulting foam structures have relatively poor structural integrity.

To form a structural element from foamed polyurethane using a typical two- component system, a resin is mixed with an isocyanate, and the mixture is then introduced into a mold, which is then closed. The foaming reaction takes place inside the mold, and the volume of the polymeric material inside the mold increases. Once the volume of the foamed material becomes equal to the volume of the mold, the foam is compressed against the mold, increasing the strength of the resulting element. In order to obtain a high-strength structural element, it is necessary to allow for a substantial amount of compression to occur, which requires the use of a large amount of polyurethane, thus increasing the expense of the structural element. Furthermore, as the foam is compressed to provide increased strength, the density of the foam is increased such that the thermal insulation properties of the resulting article are quite poor. Moreover, the above-described method must be carried out quickly to ensure that the reaction components are all introduced into the mold before the foaming reaction commences.

Yet another method known in the art for the preparation of structural elements from foamed polymeric materials involves the use of expanded polystyrene or polypropylene beads, which are placed in a mold and subjected to steam heating, which softens the beads, which can then be coalesced to form a structural element. While the resulting structural element is relatively light, it is not particularly strong. In addition, the final foam product is of an open cell structure, and thus permeable to liquids and gases. Moreover, since the volume of the structural element is reduced as the beads coalesce, this method also requires the use of large quantities of starting materials.

Still another method for the preparation of building materials employing expanded polystyrene beads is described in UK Patent Application No. GB 2,298,424, which discloses a lightweight thermally insulating filler disposed within a rigid foamed plastics matrix. The principal thermally insulating filler disclosed in the '424 application is referred to as “expanded polystyrene” with no details given as to the chemical and/or physical properties of the material employed in the preparation of the claimed product. Similarly, the only rigid foamed plastics matrix disclosed in the '424 application is a single, specific rigid polyurethane, defined only in terms of one of several components used for the preparation thereof, i.e., the polyurethane employed in the '424 application is prepared from “resin” (described only as “a polyol blend”) and isocyanate (described only as a mixture of diphenylmethane diisocyanate and “polymeric components”). The actual makeup of the polyurethane employed in the '424 application is obtainable only by reference to an allegedly commercially available material by reference to its trade name only.

Additional methods for preparing structural materials are described in U.S. Pat. No. 4,714,715 (directed to a method of forming fire retardant insulation material from rigid plastic foam scrap); U.S. Pat. No. 5,055,339 (directed to a shaped element comprising a panel of a soft foamed material having a cellular lattice comprised of webs defining open cells and granules of a soft foamed material having a cellular lattice comprised of webs defining cells and of at least one additional filler material); U.S. Pat. No. 5,791,085 (directed to a method of preparing a porous solid material for the propagation of plants consisting of a single step of reacting a polyisocyanate and a polyethylene oxide derivative in the presence of granules of a porous expanded mineral and in the presence of 0.5 weight % water or less to produce a substantially dry, solid porous open-cell foamed hydrophilic water- retentive polyurethane hydrogel material matrix, which is substantially rigid in the dry condition and which is capable of absorbing water and becoming pliant when wet); U.S. Pat. No. 5,885,693 (directed to a three-dimensional shaped part having a predetermined volume); U.S. Pat. No. 6,042,764 (directed to a method of producing a three-dimensional shaped plastic foam part); U.S. Pat. No. 6,045,345 (directed to an installation for producing a three-dimensional shaped plastic foam part from plastic foam granules bonded together by foaming a liquid primary material); U.S. Pat. No. 6,265,457 (directed to an isocyanate- based polymer foam); U.S. Pat. No. 6,583,189 (directed to an extruded article comprising a closed cell foam of a first thermoplastic, containing between about 1% and 40% of powdered diatomaceous earth by weight, the extruded article being formed with diatomaceous earth containing no more than about 2% by weight of moisture); and U.S. Pat. No. 6,605,650 (directed to a process of generating a polyurethane foam by forming a mixture comprising isocyanate and polyol reactants, catalyst, and blowing agent, which mixture reacts exothermically to yield a rigid polyurethane foam).

There remains, however, a need in the art for structural and other composite materials which can be strong and lightweight, which are preferably also relatively moisture resistant, and yet which do not require large amounts of starting materials for the preparation thereof. The present invention addresses this and related needs in the field, as detailed by the specification and claims which follow.

### SUMMARY OF THE INVENTION

In accordance with the present invention, a variety of structural and other composite materials can be produced which exhibit one or more desired performance properties, including high compression strength, high tensile strength, high flexural strength, high shear strength, and/or high strength-to-weight ratio. Invention materials can likewise be produced which exhibit high compression, tensile, flexural and shear moduli. In addition, invention materials can be substantially moisture resistant or they can be produced to be moisture absorbing if desired for a particular application. Invention materials can have the added benefits of ease of manufacture, and can also be relatively inexpensive to manufacture. In addition, invention materials can be prepared at relatively low temperatures, frequently requiring little heating or cooling during preparation. The superior and selectable performance properties of invention materials render such materials suitable for a wide variety of end uses.

For example, numerous adhesives can be applied to invention materials without melting, dissolving or degrading the basic structure of invention materials. This facilitates bonding invention materials to virtually any surface or substrate, including bonding of two or more pieces of invention materials (which may be of the same or differing formulation) to one another as an alternate way to generate a desired shape. Moreover, the bond between invention materials and a variety of substrates (including the bond between two or more pieces of invention materials) is exceptionally strong, rendering the resulting bonded article suitable for use in a variety of demanding applications. Indeed, the adhesion between invention materials and a substrate can be further enhanced by abrading the surface of the substrate (for example, mechanically or by chemical etching) prior to contact with invention materials.

Similarly, invention materials can be modified by application of coatings such as liquid polyester resin coatings, liquid styrene or other liquid polymer coatings thereto. Such coatings can be sprayed or otherwise directly applied to invention materials without substantially dissolving or otherwise compromising the core structure provided by invention material. As illustrated herein, the use of adhesives and/or liquid coatings that result in limited amounts of surface dissolution prior to drying can actually enhance adhesion of applied materials and/or coatings to invention materials.

Invention materials can be manufactured in a wide variety of sizes, shapes, densities, in multiple layers, and the like; and the performance properties thereof can be evaluated in a variety of ways.

### BRIEF DESCRIPTION OF THE FIGURES

FIG. 1 is a scanning electron microscope image of a cross section of an expanded polystyrene bead.

FIG. 2 is a scanning electron microscope image of an expanded polystyrene bead.

FIG. 3 is a schematic depiction of a cross section of a polymer matrix containing porous beads illustrating polymer filaments or other projections extending into a porous bead.

FIG. 4 is a cross-sectional view of an exemplary invention article, wherein large beads of a porous material (10) are incorporated into a polymer matrix (1). Invention structural and other composite materials are also sometimes referred to herein as PetriFoam™ brand structural and other composite materials.

FIG. 5 is a cross-sectional view of another exemplary invention article, wherein small beads of a porous material (11) are incorporated into a polymer matrix (1).

FIG. 6 is a cross-sectional view of yet another exemplary invention article, wherein a mixture of large and small beads of a porous material (10 and 11) are incorporated into a polymer matrix (1).

FIG. 7 is a cross-sectional view of an invention article further comprising structural material according to the invention (20) and a facing material (30) adhered thereto.

FIG. 8 is a cross-sectional view of an invention article comprising structural material according to the invention (20), further comprising a coating (31) thereon.

FIG. 9 is a cross-sectional view of an invention article in the form of a sandwich structure, comprising PetriFoam™ brand structural material(s) (20) bound to, or incorporating, a reinforcement material (32).

FIG. 10 presents a graph of results of flexural modulus tests with representative invention materials.

FIG. 11 presents a graph of results of compression tests with representative invention materials.

### DETAILED DESCRIPTION OF THE INVENTION

In accordance with one aspect of the present invention, there are provided structural and other composite materials comprising:
a porous material, wherein the porous material has a diameter (or other maximum dimension) in the range of about 0.05 mm up to about 60 mm, and a bead (or other particle) density in the range of about 0.1 kg/m³ up to about 1000 kg/m³, typically in the range of about 1 kg/m³ up to about 100 kg/m³, and
a polymer, wherein the polymer is prepared from a polymerizable component capable of curing at a temperature below the melting point of the porous material, wherein the polymer encapsulates the porous material, and wherein filaments or other projections comprising the polymer extend into the porous material. As readily recognized by those of skill in the art, polymer material can extend into the porous material to varying degrees, depending on such factors as the viscosity of the polymer system, the dimension of the pores in the porous material, the pressure to which the system is subjected, and the like.

In certain embodiments of the invention, the polymer is prepared from a gas- generating polymerizable component such as polyurethane, and the polymer comprises a substantially solid matrix. As used herein, “substantially solid” refers to a material with sufficient structural integrity so as to retain a given shape absent any extraordinary outside forces. Without wishing to be bound by theory, it is believed that the preparation of gas- generating polymerizable component in close proximity with porous materials can yield a polymer matrix that is significantly more solid than matrix prepared in the absence of such porous materials because the porous materials can serve as a proximal reservoir or sink to contain some portion of the generated gas which might otherwise form macroscopic and/or microscopic bubbles within the matrix, thereby weakening its structural integrity. As contemplated herein, pressure and/or other means can be used to further enhance these processes. Such methods of generating structural and other composite materials can have the added advantage of reducing the amounts of volatile organic compounds that are released during preparation. By virtue of such technical features, structural and other composite materials according to the present invention can be generated in which the matrix is 5-20, 20- 40, 40-80, 80-120 percent or even more solid (i.e. dense) as compared to matrix prepared in the absence of such porous materials). Since at the same time, the porous material can provide a lightweight structure that can be encapsulated and/or penetrated by the matrix as described herein, the resulting products can exhibit highly desirable properties of being relatively lightweight yet strong. Partial physical ingress and/or bonding of the matrix to the porous material can also be used to enhance structural integrity of the composite by providing a means of mechanically and/or chemically “locking” the matrix to the porous material. As described below, materials of the present invention can readily be prepared to exhibit superior properties in terms of a number of strength as well as other mechanical and/or other physicochemical or electrical characteristics. Illustrative examples of such materials are provided herein and as will be apparent to those of skill in the art, based on the detailed teachings and descriptions provided herein, various additions and/or alternatives known in the art can be readily employed in connection with the practice of the present invention. Substantially solid materials according to the present invention can range from substantially rigid (i.e., substantially non-deformable) to substantially flexible (i.e., deformable, yet potentially with sufficient memory so as to return to the original shape once the deforming perturbation is removed).

Structural and other composite materials according to the present invention typically comprise a relatively continuous homogeneous phase (comprising the polymer) and a relatively discontinuous inhomogeneous phase (comprising the porous material). As discussed in greater detail herein, the continuous phase can be based on any of a variety of homopolymeric systems, as well as co- and multi-polymeric systems, including block copolymers, graft copolymers, and the like, as well as mixtures and combinations of polymers forming interpenetrating or semi-interpenetrating polymer networks. Similarly, the discontinuous phase material can be selected from a variety of porous materials which, as illustrated and/or described herein, can also be based on a variety of homopolymeric systems, as well as co- and multi-polymeric systems, including block copolymers, graft copolymers, and the like, as well as mixtures and combinations of polymers forming interpenetrating or semi-interpenetrating polymer networks. As further illustrated in various embodiments herein in which the porous material is a polymeric material, the porous material is provided in its final, i.e. polymerized, state prior to its combination with the continuous phase material comprising the polymer, and the polymerization temperature of the continuous phase material is below the melting temperature of the porous material.

In accordance with another aspect of the present invention, there are provided structural and other composite materials comprising:
a porous material, wherein the porous material has a diameter (or other maximum dimension) in the range of about 0.05 mm up to about 60 mm, and a bead (or other particle) density in the range of about 0.1 kg/m³ up to about 1000 kg/m³, typically in the range of about 1 kg/m³ up to about 100 kg/m³, and
a polymer, wherein the polymer is prepared from a first polymerizable component which is capable of polymerizing within pores of the porous material, and from a second polymerizable component which is capable of binding to polymers of the first polymerizable component, either directly or through a linker,
wherein the polymerizable components, upon curing, produce a substantially solid matrix which encapsulates and partially penetrates the porous material.

In accordance with another aspect of the present invention, there are provided articles having a defined shape, excellent compression strength and modulus, and a high flexural modulus, the articles comprising a polymer matrix containing a porous material substantially uniformly distributed therethrough, wherein filaments or other projections comprising the polymer extend at least partially into the porous material.

The extent of penetration of the porous material by polymer can be readily modified as desired for a particular application. For example, relative strength can generally be enhanced by increasing the extent of penetration, and can be increased still further if desired by causing filaments of penetrating polymer to bind to each other and/or to surfaces within the porous material. Such increased penetration can be achieved by a variety of means, including for example, selecting a polymer and porous material combination that favors interaction and penetration (e.g., by selecting combinations having particularly compatible surface energies), by having or applying additional pressure during polymerization to drive penetration, by raising the temperature or by other kinetic or thermodynamic means that facilitate the interaction and potential for penetration. Similarly, it is possible to enhance penetration by employing a less viscous polymer or otherwise lowering the viscosity of the polymer, or by first applying a less viscous precursor of the polymer as illustrated below. It is also possible to include an agent that promotes or facilitates the interaction (such as a surfactant) which may be included during polymerization or may for example be used to pre-treat the porous material to make it particularly receptive to penetration by the polymer. As another alternative, use of a graft copolymer system as described herein can be employed to achieve desired levels of penetration while at the same time allowing the external portion of the polymer matrix to be relatively independently selected for other advantageous characteristics such as strength or other desirable features.

Conversely, the amount and cost of polymer material and the corresponding weight of the overall composite material required for particular applications can be reduced by decreasing the extent of penetration of the polymer into the porous material, which can be accomplished by countering the factors delineated above (e.g., by selecting polymer and porous material combinations having less compatible surface energies, by reducing pressure and/or temperature during polymerization, by employing a more viscous polymer, by employing an agent or conditions that hinder the interaction between the polymer and porous material, by simply decreasing the porosity or pore size of the porous material), and the like.

As yet another alternative, a combination of polymers that can form an interpenetrating polymer network (IPN) or semi-interpenetrating polymer network (SIPN) can be used. In the case of polymers based on IPNs or SIPNs, one of the polymers used can be selected for its relatively greater ability to penetrate pores in the porous material, thereby forming a penetrating or anchoring portion of the network (which can be optimized for a desired level of bead or other porous particle penetration for example) and a second polymer can be selected which is preferentially partitioned outside of the porous material (which can be optimized for desired properties of the matrix between porous particles). The ability of the different polymers to form interlaced or intertwined networks where they polymerize in proximity to each other provides a strong linkage near, for example, the surface of the porous material, thus linking the phases to each other. Porous materials such as those comprising polyolefins and other synthetic polymers can also be comprised of copolymers, IPNs, SIPNs and other combinations of polymers known in the art, and can likewise be selected to facilitate interactions between the polymer matrix and the porous material based on, for example, favorable intermolecular interactions between a portion of the polymer matrix that penetrates the porous material and the portion of the porous material that is penetrated.

By applying any combination of the above-described techniques to structural and other composite materials of the present invention, filaments or other projections of the polymer can readily be caused to extend to varying degrees into a given porous material. Relatively high-strength structural and other composite materials of the present invention can thus be prepared in which the polymer matrix can extend 1-10, 10-20, 20-30, 30-40,40-50, 50-60, 60-70, 70-80, 80-90, or 90-100 percent into the diameter (or other linear dimension) of the porous material, as desired. Structural materials and other composites having a range of strengths and weights as described and illustrated herein can thus be prepared, for use in various applications such as those described below.

In certain embodiments, articles of the present invention can have compression strengths exceeding 20 pounds per square inch (psi), preferably exceeding 40, 100, 150, 210, 300 or 400 psi; compression modulus exceeding 2000 psi, preferably exceeding 4000, 8000, 10,000, 20,000, 40,000 or 100,000 psi; flexural strength exceeding 50 psi, preferably exceeding 100, 200, 350-375 or 500 psi; flexural modulus exceeding 2000 psi, preferably exceeding 4000, 8000, 10,000, 20,000, 40,000 or 100,000 psi; shear strength exceeding 20 psi, preferably exceeding 40, 100, 150, 210, 300 or 400 psi; and shear modulus exceeding 1000 psi, preferably exceeding 2000, 3000, 4000, 5000, 6000, 8000 or 10,000 psi; tensile strength exceeding 40 psi, preferably exceeding 80, 100, 150, 210, 300 or 400 psi; and tensile modulus exceeding 1000 psi, preferably exceeding 2000, 3000, 4000, 5000, 6000, 8000 or 10,000 psi.

As employed herein, “high compression strength,” as determined, for example, by ASTM 1621, refers to the capacity of invention materials to withstand exposure to compressive forces without suffering significant breakdown of the basic structure thereof. Invention materials can readily be produced which display compression strengths substantially in excess of what one would expect when comparing to the performance properties of the individual components from which invention materials are prepared. Descriptions of ASTM standards and testing can be found in the publications of ASTM International as well as their web sites (see, e.g., www.astm.org).

As employed herein, “high tensile strength,” as determined, for example, by ASTM 1623, refers to the capacity of invention materials to withstand longitudinal strain, i.e., the maximum force the material can endure without separating. Invention materials can readily be produced which display tensile strengths substantially in excess of what one would expect when comparing to the performance properties of the individual components from which invention materials are prepared.

As employed herein, “high shear strength,” as determined, for example, by ASTM 273, refers to the resistance of invention materials to deformation when subjected to a defined stress. Invention materials can readily be produced which display shear strengths substantially in excess of what one would expect when comparing to the performance properties of the individual components from which invention materials are prepared.

As employed herein, “high flexural strength,” as determined, for example, by ASTM 790, refers to the resistance of invention materials to deformation when subjected to a bending stress. Invention materials can readily be produced which display flexural strengths substantially in excess of what one would expect when comparing to the performance properties of the individual components from which invention materials are prepared.

As employed herein, “high strength-to-weight ratio” refers to the surprisingly high strength of certain invention materials, in spite of their relatively low weight. For example, an invention article weighing a fraction of the weight of prior art materials is capable of providing the same or better performance properties than materials of substantially greater weight, such as, for example, wood or concrete. Invention materials can readily be produced which have strength-to-weight ratios in excess of what one would expect when comparing to the ratios of materials prepared from the individual materials from which invention materials are prepared, such as for example, from materials made from a polymer such as polyurethane.

Invention materials can also be readily prepared to exhibit, and thus can be characterized in terms of their superior impact strength, hardness or surface stiffness (such by the Rockwell hardness test of a material's ability to resist surface indentation), as well as by other properties including the density of the resulting product, thermal conductivity and thermal expansion of the resulting product, as well as the thermal conductivity and thermal expansion of each component material, coefficient of expansion, coefficient of absorption (i.e., conductivity), dielectric strength and volume and arc resistance, flammability (such as by oxygen index or UL flammability ratings), shrinkage, water and water vapor permeability and absorption, specific gravity and other such physicochemical, mechanical, thermal or electric properties.

Invention materials can also be readily prepared to exhibit superior toughness, which is generally characterized by resistance to crack propagation. Without wishing to be bound by theory, it is believed that the ability to provide relatively tough matrices, such as that provided by polymer matrices of the present invention (particularly when combined with the incorporation of structurally and mechanically distinct material within the composite, such as that provided by the porous material), can contribute substantially to the resistance to crack migration from one phase to the next (and thus to promote crack termination which would require crack reinitiation in order to cause a rupture across the invention material). One measure of toughness in the case of such structural and other composite materials can be seen in stress to strain curves of composites showing that the materials can bear relatively large stresses with limited strain.

Invention materials can also be readily made resistant to moisture, since the particulate material can be substantially encapsulated in a polymer matrix and the polymer can be selected to be relatively resistant to moisture uptake and absorption (for example by selecting a relatively hydrophobic polymer or by coating the polymer or article with a relatively hydrophobic agent). Standard tests for moisture include, for example, ASTM D570-98, ASTM 2842-01, BS4370: Method 8, DIN 53434, and others known in the art. Using ASTM D570, for example, invention materials can readily be prepared having a range of different water absorptions in weight percent after 24 hours, typically less than 5, 4, 3, 2, 1, 0.5, 0.2, 0.1, 0.05, 0.01 or even lower as desired for a particular application. Conversely, it is also possible to prepare invention materials having relatively high rates of water absorption for applications in which that may be desirable (such as applications in which it is desired that a material absorb and hold a large volume of liquid, and potentially release it over time). In the latter regard, agents that promote water absorption can be employed (such as sodium polyacrylates, and the like) as well as, for example, agents that control or effect release of fluid over time.

In accordance with yet another aspect of the present invention, there are provided methods of making structural and other composite materials, the method comprising:
combining porous material and a polymerizable component, and
subjecting the resulting combination, in a mold or other container (which may be open or closed), to conditions suitable to cure the polymerizable component in the optional presence of blowing agent(s), whereby said blowing agent(s) and any gases generated during curing and/or compression of the porous materials are substantially absorbed by the porous material to produce a composite structural material. Alternatively, or in addition to absorption of blowing agent(s) and other gases by the porous material, controlled forced change in pressure (e.g., vacuum) can be applied to remove such gases from the composite material. Where increased strength is desired, a portion of the polymerizable component can be forced into the porous material, thereby producing structural material comprising the porous material encapsulated in a solid polymer matrix, and wherein filaments or other projections comprising the polymer extend into the porous material.

In accordance with still another aspect of the present invention, there are provided formulations comprising:
a porous material,
a polymerizable component, and
at least one additive selected from the group consisting of flow enhancers, plasticizers, cure retardants, cure accelerators, strength enhancers, UV protectors, dyes, pigments and fillers,
wherein the porous material has a diameter (or other maximum dimension) in the range of about 0.05 mm up to about 60 mm, and a bead (or other particle) density in the range of about 0.1 kg/m³ up to about 1000 kg/m³, preferably in the range of about 1 kg/m³ up to about 100 kg/m³, and
wherein the polymerizable component is capable of curing at a temperature below the melting point of the porous material, wherein the polymerizable component, upon curing, produces a substantially solid matrix which encapsulates the porous material, and wherein filaments or other projections comprising the polymer extend into the porous material. Also contemplated are structural and other composite materials prepared from the above-described formulations.

In accordance with a further aspect of the present invention, there are provided formulations comprising:
a porous material, and
a polymerizable component,
wherein the porous material is not expanded polystyrene, and has a diameter (or other maximum dimension) in the range of about 0.05 mm up to about 60 mm, and a bead (or other particle) density in the range of about 0.1 kg/m³ up to about 1000 kg/m³, preferably in the range of about 1 kg/m³ up to about 100 kg/m³, and
wherein the polymerizable component is capable of curing at a temperature below the melting point of the porous material, wherein the polymerizable component, upon curing, produces a substantially solid matrix which encapsulates the porous material, and wherein filaments or other projections comprising the polymer extend into the porous material. Also contemplated are structural and other composite materials prepared from the above-described formulations.

In accordance with a still further aspect of the present invention, there are provided formulations comprising:
a porous material, and
a polymerizable component,
wherein the porous material has a diameter (or other maximum dimension) in the range of about 0.05 mm up to about 60 mm, and a bead (or other particle) density in the range of about 0.1 kg/m³ up to about 1000 kg/m³, preferably in the range of about 1 kg/m³ up to about 100 kg/m³, and
wherein the polymerizable component is not a polyurethane, and is capable of curing at a temperature below the melting point of the porous material, wherein the polymerizable component, upon curing, produces a substantially solid matrix which encapsulates the porous material, and wherein filaments or other projections comprising the polymer extend into the porous material. Also contemplated are structural and other composite materials prepared from the above-described formulations.

In accordance with a still further aspect of the present invention, there are provided formulations comprising:
a porous material,
a first polymerizable component which is capable of polymerizing within pores of the porous material,
a second polymerizable component which is capable of binding to polymers of the first polymerizable component, either directly or through a linker,
wherein the porous material has a diameter (or other maximum dimension) in the range of about 0.05 mm up to about 60 mm, and a bead (or other particle) density in the range of about 0.1 kg/m³ up to about 1000 kg/m³, preferably in the range of about 1 kg/m³ up to about 100 kg/m³, and
wherein the polymerizable components, upon curing, produce a substantially solid matrix which encapsulates and at least partially penetrates the porous material. Also contemplated are structural and other composite materials prepared from the above-described formulations.

Optionally, invention formulations may also contain one or more additional additives selected from the group consisting of fire retardants, light stabilizers, antioxidants, antimicrobial agents, plasticizers, metal soap stabilizers, UV absorbers, pigments, dyes, antistatic agents, blowing agents, antifoam agents, foaming agents, lubricity agents, reinforcing agents, thermal stabilizers, particulate fillers, fibrous fillers, mineral fillers, process aids, flow enhancers, slip additives, crosslinking agents and co-agents, cure retardants, cure accelerators, strength enhancers, impact modifiers, catalysts, adhesion promoters, friction enhancers, abrasion resistors, heat resistors or thermal stabilizers, antiozonants, extenders, and the like. As readily recognized by those of skill in the art, many components can serve a multitude of functions, e.g., carbon additives (both activated and not), starches, clay crystallites, waxes, glass, silicates, alumina, and the like. The materials can be waterproof or water resistant, ultraviolet (UV) stable, resistant to insects, microbes, fungi, atmospheric conditions, moisture, dry rot, and the like. Preferred materials also generally do not emit significant quantities of volatile organic compounds (VOCs), such as regulated VOCs.

Porous materials contemplated for use in the practice of the present invention can be rigid, semi-rigid, flexible, or compressible, and can have any of a variety of shapes, e.g., beads, granules, rods, ribbons, irregularly shaped particles, and the like. As readily recognized by those of skill in the art, shaped porous materials in other forms can also be employed, for example, sheets, lattices, tubes, open celled three dimensional structures, woven fabrics, non-woven fabrics, felts, sponges, and the like. See also, U.S. Pat. No. 5,458,963 for additional shapes which are contemplated for use herein. The applications in which invention materials are employed play a role in the selection of a suitable particulate or shaped porous material. For example, if blocks of the material are to be formed, and later cut to size, then a particulate porous material can be desirable. In contrast, if the material is to be used for preparation of a fixed sized object, then a sheet or monolith of a porous material can be desirable. For example, porous sheets can preferably be employed in the preparation of a resilient floor tile, or a monolithic lattice of porous material can be employed in the preparation of a load-bearing form. Porous material in the form of spherical beads is especially preferred in certain embodiments of the invention.

Porous materials contemplated for use in the practice of the present invention typically have a particle size (i.e., the cross-sectional diameter at the largest dimension of the particle (or other maximum dimension)) in the range of about 0.05 mm up to about 60 mm, with particle sizes in the range of about 0.1, 0.2, 0.3, 0.4, 0.5, 0.6, 0.7, 0.8, 0.9 or 1.0 mm to about 5.5, 6, 7, 8, 9, 10, 11, 12, 13, 14, 15, 20, 25, 30, 35, 40, 45, 50, or 55 mm (with particle sizes of from about 1 mm to about 5 mm preferred, and more preferably from about 1.0, 1.25, 1.5, 1.75, 2.0, 2.25, or 2.5 mm to about 2.75, 3.0, 3.25, 3.5, 3.75, 4.0, 4.25, 4.5, or 5.0 mm).

Porous materials contemplated for use in the practice of the present invention typically have a bead (or other particle) density in the range of about 0.1 kg/m³ up to about 1000 kg/m³, typically in the range of about 1 kg/m³ up to about 100 kg/m³, with bead (or other) particle densities varying as a function of the end use contemplated. Typically, bead (or other particle) densities fall in the range of about 1, 2, 3, 4, 5, 6, 7, 8, 9, 10, 11, 12, 13, 14, or 15 kg/m³ to about 75, 100, 150, 200, 250, 300, 350, 400, 450, 500, 550, 600, 650, 700, 750, 800, 850, 900 or 950 kg/m³, more preferably from about 16, 17, 18, or 19 kg/m³ to about 51, 52, 53, 54, 55, 60, 65, 70, 80, 90, 100, 110, 120, 130, 140, 150 160, 170, 180 190 or 200 kg/m³, and most preferably from about 20, 21, 22, 23, 24, 25, 26, 27, 28, 29, or 30 kg/m³ to about 31, 32, 33, 34, 35, 36, 37, 38, 39, 40, 41, 42, 43, 44, 45, 46, 47, 48, 49, 50, 60, 70, 80, 90 or 100 kg/m³.

Presently preferred porous materials contemplated for use herein can be further characterized as having a porosity sufficient to absorb at least 10%, 20%, 30%, 40%, 50%, 60%, 70%, 80%, 90%, 95% or substantially all of the gas(es) generated upon curing the polymer system employed in the practice of the present invention. In certain preferred embodiments, the porosity of the porous material is also such that at least a portion of the polymeric material can be drawn or forced into the porous material (e.g., by passive flow, pressure-driven flow, and/or capillary flow or by other kinetic and/or thermodynamic processes), resulting in microscopic and potentially macroscopic tendrils, fingers, filaments or other projections of the polymer penetrating into the body of the porous material. In addition, the ability of the porous material to serve as a reservoir for at least a portion of the generated gas can allow reduction in the number and/or size of gas bubbles that become trapped within the polymer matrix, thereby increasing the strength and density of the polymer matrix. In contrast, non-porous materials would not have such ability, and would allow escape of substantial amounts of the gas(es) generated upon curing a gas-generating polymer system which may be employed in the practice of the present invention.

The average pore size of porous materials contemplated for use in the practice of the present invention is typically in the range of about 0.05 microns or less up to about 1,000 microns or more, preferably from about 0.1 microns up to about 500 microns, and more preferably from about 1, 5, 10, 15, 20, 25, 30, 35, or 40 microns up to about 50, 60, 70, 80, 90, 100, 150, 200, 250, 300, 350, 400, or 450 microns. While these average pore sizes are generally preferred, smaller or larger pore sizes can be preferred in certain embodiments. Likewise, while a tight pore size distribution is generally preferred, broader pore size distributions can be acceptable or desirable in certain embodiments. For example, where it is desired to increase the relative strength of the invention structural and other composite materials by causing more of the polymer matrix to enter the porous material, the number and depth of the pores can be increased or decreased as needed to enhance or discourage capillary flow into the pores. Alternatively, it is also possible to increase polymer ingress into the porous material by applying increased pressure and/or temperature to the material during preparation, by lowering the viscosity of the polymer, by selecting a polymer and porous material combination (or modifying a selected porous material) to provide similar or compatible surface energies for interaction, as well as other kinetic and/or thermodynamic processes that favor ingress of the polymer matrix into the porous material.

It is also possible to employ a graft copolymer system in which a first polymer component may be preferentially polymerized within pores of the porous material, and may also project outside of the porous material, which first polymer component may be joined (either directly or through one or more linker molecules) to a second polymer component which can form a relatively continuous matrix outside of the porous material. As another alternative, the first and second polymer components can be ones which form an interpenetrating polymer network (IPN) or semi-interpenetrating polymer network (SIPN) and are therefore capable of being interlaced or intertwined even though they are not covalently bound. Indeed, in the case of IPNs, the networks are so interlaced or intertwined that they generally cannot be separated without breaking chemical bonds. Polymer combinations that form IPNs or SIPNs can also be selected such that one of the polymers (analogous to the first polymer component of the graft copolymer above) may be preferentially partitioned within pores of the porous material, relative to the second polymer which may be preferentially partitioned outside of the porous material, even though the polymers tend to interlace or intertwined where they polymerize in close proximity. As a result of employing such systems of copolymers, IPNs, SIPNs or other combinations of polymers, a first polymer component can be selected to facilitate the desired level of penetration of the porous material, while a second polymer component can be selected to promote desired properties of the matrix, such as strength and other physicochemical, thermal, electrical or other properties. The resulting structural and other composite materials can exhibit superior properties by virtue of their comprising a potentially lightweight porous material that is substantially encapsulated and penetrated by a potentially strong matrix material. The resulting mechanical and/or chemical interlocking of matrix and porous material can contribute to substantially improved properties of the resulting structure materials, including for example in compression strength and modulus, shear strength and modulus, flexural strength and modulus, and tensile strength and modulus. Using two polymer components has an advantage in allowing each of them to be relatively independently optimized to maximize their respective functional properties.

In the case of graft copolymer systems, IPNs, SIPNs or other combinations of polymers, preparation can be via a multi- or one-step polymerization process. For example, in a multi-step process, the first polymer component can be allowed to polymerize within pores of the porous material, after which porous material with first polymer may be subjected to additional steps in which a second polymer component is joined directly or via linkers to the first, to form a matrix that both encapsulates and penetrates the porous material. In an exemplary one-step process, the first polymer is selected or introduced in a manner that results in the first polymer being preferentially partitioned within the pores of the porous material and the second polymer is selected or introduced in a manner that results in the second polymer being preferentially partitioned outside of the pores of the porous material, and polymerization (with or without linker molecules) is allowed to proceed to graft the first and second polymer components to each other (in the case of copolymers) or to allow the polymers to form interlaced or intertwined networks (in the case of IPNs or SIPNs) or to otherwise promote intermolecular interactions between the first and second polymers (in the case of other combinations).

Porous materials contemplated for use herein can be further characterized by the surface area thereof. Typically, surface areas in the range of about 0.5 up to about 500 m/g² are contemplated, with surface areas in the range of about 2 up to about 100 m/g² presently preferred.

As readily recognized by those of skill in the art, the shape and dimension of porous material employed in the practice of the present invention can be varied so as to provide a finished product having different physical properties (e.g., different strengths and densities). In general, the smaller the particles employed, the higher the compression strength, shear strength, and weight of the resulting product. Conversely, the larger the particles employed, generally the more flexible, less rigid and lighter are the products obtained. With respect to particle density, in general, the higher the density of the particles employed, the higher the compression strength, shear strength and weight of the resulting product. Conversely, the lower the density of the particles employed, generally the higher the insulating properties and the lighter the weight of the resulting product. Porous material such as polystyrene, polyethylene, polypropylene, other polyolefin or polyolefin-like materials, or other beads (or other particles) can be manufactured in various densities in order to meet the requirements of a specific end-use application. For lightweight formulations which are preferred for a number of applications, porous materials can be made from a variety of available polymers that are inherently foamable (i.e. producing gas during polymerization) or can be foamed with a blowing agent or mechanically to introduce desirable levels of gas into the polymer to increase the porosity and decrease the density of the resulting material. For example, various densities of expanded polystyrene or other beads (or other particles) can be obtained in a variety of ways, e.g., by adjustment of the quantity or type of blowing agent employed in the preparation of the bead (or other particle) precursor. As used herein, the term polyolefin refers to one or more vinylic polymers (i.e., polymers made from monomers comprising a vinylic group of double-bonded carbons which can act to facilitate polymer chain propagation). As used herein, polyolefin-like refers to polymers which have many of the characteristics of polyolefins, yet differ in one or more of the following ways, e.g., the presence of non-hydrocarbon substituents thereon (e.g., halogens, acids, esters, and the like), the presence of one or more non-carbon atoms in the backbone thereof (e.g., N, O, S, and the like).

In accordance with the present invention, porous (particulate or non-particulate) material typically comprises in the range of about 25 to 50 up to greater than 90 volume percent of the volume of the finished article. Preferably, volumes fall in the range of 50, 60, 70, 75, 76, 77, 78, 79, 80, 81, 82, 83, 84, 85, 86, 87, 88, 89, 90, 91, 92, 93, 94, 95, 96, 97, 98, or 99 volume percent of the above-described formulation, with the preferred volume percent depending on the end use contemplated. For example, higher particulate contents are preferred where product buoyancy is desired (e.g., materials for use in boats, surfboards, flotation devices, dock buoys, and the like), whereas lower particulate contents are preferred where high structural integrity is required. Generally (for applications favoring relatively lightweight composites), a material having at least about 90% by volume porous material is preferred, with at least about 95, 96, 97, 98 or 99% by volume being especially preferred. It should be noted that since the material may be subject to compression during preparation, as described herein, the volume of input porous material may be substantially greater than 100% of the volume of the finished material, with such volumes readily exceeding 110, 120, 130, 140, 150, 160, 170, 180, 190, 200, 220, 240, 260, 280, 300, 400, 500 up to about 800 percent of the volume of the finished material. In certain embodiments, those of skill in the art recognize that higher or lower volume percents can also be acceptable or desirable.

Further in that regard, invention articles can be described in terms of the percent compression to which they can be subjected during preparation. Compression can be mediated by physicochemical expansion of the formulation within a confined space (such as a mold) or exogenously applied to a gas-generating or other polymer system contained within a mold or other confined space. During preparation, invention materials may be subjected to compressions of as little as 5-10 volume percent, with compressions up to and exceeding 80 or 90 volume percent contemplated herein. Compressions in the range of about 5, 10 15, 20, 25 or 30 volume percent up to about 35, 40, 45, 50, 55, 60, 65, 70, or 75 volume percent are presently preferred for applications in which a range of increased strengths is desirable. In certain embodiments, those of skill in the art recognize that higher or lower volume percents can also be acceptable or desirable.

In terms of the relative weight of the components employed for the preparation of invention formulations, porous material typically comprises in the range of about 5 wt % up to about 90 wt % of the formulation, with the weight range of the porous particulate material varying based on the contemplated end use. Preferably the porous material comprises about 10, 12, 15, 18, 20, 25, 30, 35, 40, or 45 wt. % to about 50, 55, 60, 65, 70, 75, 80, or 85 wt. % of the formulation. In certain embodiments, those of skill in the art recognize that higher or lower weight percents can also be acceptable or desirable.

For example, when used for insulation and strengthening the acrylic tub of a spa, thermal insulation and compressive strength are both desirable features of the material. Satisfactory compressive strength can reduce the likelihood of fracture of the acrylic due to weight loading caused by the contained water and occupants of the spa. By way of illustration of such an embodiment, the porous material can be present in the range of about 40-80 wt. %, preferably in the range of about 50-70 wt. %, or more preferably at about 60 wt. % (using a mixture of 5 mm or smaller polyolefin beads (e.g., expanded polystyrene and polyethylene beads) with a final density of about 2 pounds per cubic foot). Alternatively, when used for production of surfboards, it is desired that the resulting product be lightweight and have a strength exceeding that of a toluene diisocyanate (TDI) or diphenylmethane diisocyanate (MDI) homogeneous polyurethane foam. By way of illustration of such an embodiment, the porous material can be present in the range of about 30-70 wt. %, preferably in the range of about 40-60 wt. %, or more preferably at about 50 wt. % (using 1.2 mm beads with a final density of about 3 pounds per cubic foot). As another alternative; when used for production of construction materials, materials having lightweight and high strength characteristics are desired. By way of illustration of such an embodiment, the porous material can be present in the range of about 10-40 wt. %, preferably in the range of about 15-30 wt. %, with about 18 wt. % being presently preferred (using, for example, 1.2 mm beads with a final density of about 10.5 pounds per cubic foot).

Exemplary porous materials contemplated for use in the practice of the present invention include polyolefins (e.g., beads (or other particles) comprising polyethylene, polypropylene, polystyrene, and the like, as well as mixtures and/or copolymers thereof), gravel and other silica-based materials, glass beads, ceramics, vermiculite, perlite, lytag, pulverized fly ash, unburned carbon, activated carbon, and the like, as well as mixtures of any two or more thereof. In the case of many synthetic polymers, the individual monomers can be polymerized into large and highly branched or ramified macromolecules constituting macromolecular networks. Copolymers are comprised of two or more monomers that become covalently bonded within the macromolecular polymer to form graft copolymers, random copolymers, alternating copolymers, block copolymers, and the like. Mixtures in which two or more types of monomers are polymerized together (i.e., in physical and temporal proximity to each other), but are not covalently bonded to each other, can form an interpenetrating polymer network (IPN) in which two or more macromolecular networks become at least partially interlaced or intertwined on a molecular scale. Although the individual macromolecules in an IPN are not covalently bonded to each other, this interpenetration can result in a network that cannot be separated without breaking chemical bonds. In semi-interpenetrating networks (SIPNs), one or more linear or branched polymers partially penetrates a network of another polymer but the networks can be separated without breaking chemical bonds and may therefore be referred to as a polymer blend. A large variety of polymers, copolymers, IPNs, SIPNs, and other mixtures and combinations of polymers are known in the art and can be employed within the context of the present invention. In view of the many porous materials contemplated for use herein, in certain embodiments of the invention, the use of porous materials other than polystyrene, polyethylene, polypropylene, and the like is contemplated herein.

Illustrative porous materials contemplated for use in the practice of the present invention include expanded polystyrene (and other polyolefins) having a particle size broadly in the range of about 0.4-25 mm, and a density in the range of about 0.75-60 lb/ft³; with expanded polystyrene preferably having a particle size in the range of about 0.75-15 mm, and a density in the range of about 0.75-30 lb/ft³; with presently preferred expanded polystyrenes having a particle size in the range of about 0.75-10 mm, and a density in the range of about 0.75-10 lb/ft³. Exemplary expanded polystyrenes include those have a particle size in the range of about 0.4-0.7 mm, and a density in the range of about 1.25-2.0 lb/ft³, expanded polystyrene having a particle size in the range of about 0.4-0.7 mm, and a density in the range of about 1.5-3.0 lb/ft³, expanded polystyrene having a particle size in the range of about 0.7- 1.1 mm, and a density in the range of about 1.0-1.5 lb/ft³, expanded polystyrene having a particle size in the range of about 0.7-1.1 mm, and a density in the range of about 1.5-3.0 lb/ft³, expanded polystyrene having a particle size in the range of about 1.1-1.6 mm, and a density in the range of about 1.0-1.2 lb/ft³, expanded polystyrene having a particle size in the range of about 1.1-1.6 mm, and a density in the range of about 1.5-3.0 lb/ft³, expanded polystyrene having a particle size in the range of about 0.4-0.65 mm, and a density in the range of about 1.25-4.0 lb/ft³, expanded polystyrene having a particle size in the range of about 0.6-0.85 mm, and a density in the range of about 1.25-4.0 lb/ft³, expanded polystyrene having a particle size in the range of about 0.75-1.2 mm, and a density in the range of about 1.25-4.0 lb/ft³, expanded polystyrene having a particle size in the range of about 0.375-0.75 mm, and a density in the range of about 1.35-2.0 lb/ft³, expanded polystyrene having a particle size in the range of about 0.65-2.0 mm, and a density in the range of about 1.15-2.0 lb/ft³, expanded polystyrene having a particle size in the range of about 0.4-0.8 mm, and a density in the range of about 1.35-1.8 lb/ft³, expanded polystyrene having a particle size in the range of about 0.8-1.3 mm, and a density in the range of about 0.9-1.35 lb/ft³, expanded polystyrene having a particle size in the range of about 1.3-1.6 mm, and a density in the range of about 0.75-1.15 lb/ft³, and the like.

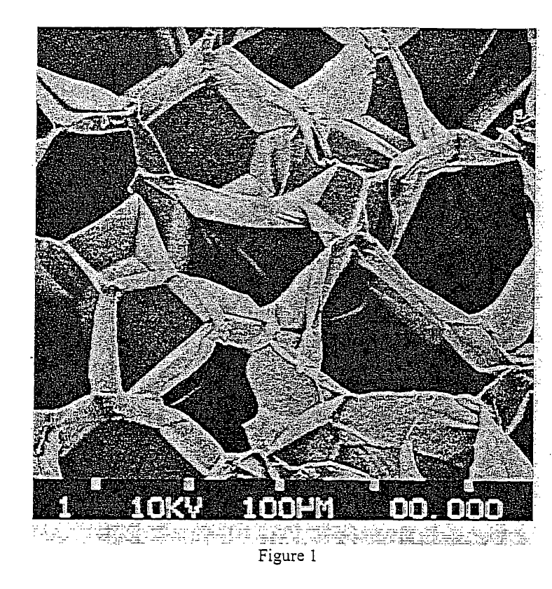

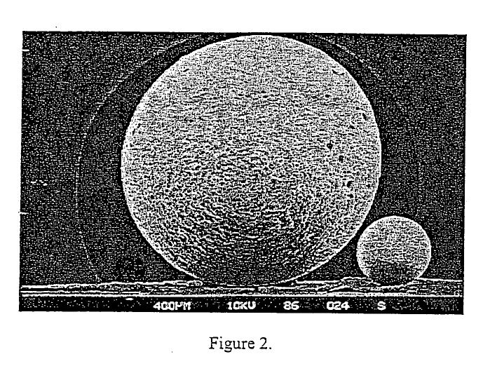

An exemplary polyolefin, expanded polystyrene, is typically made by heating crystalline polystyrene, referred to in the trade as “sugar” because of its similar appearance, with a blowing agent, such as cyclopentane, which has been entrained in the crystalline polystyrene during the manufacturing process. Crystal size is controlled to yield a final bead (or other particle) size distribution of the desired modal diameter (or other maximum cross- sectional dimension). Under controlled heat and pressure conditions, the crystal softens and the blowing agent gasifies, forming microscopic gaseous bubbles within the crystal body. After sufficient softening, the crystal is eventually transformed by capillary forces into a spherical shape, with an internal structure comprising a honeycomb like, semi-hexagonally close packed cellular structure of somewhat irregularly shaped and sized cells, as depicted in FIG. 1. After expansion, the bead (or other particle) is removed from the reaction vessel to storage for curing. The bead (or other particle) is typically cooled gradually to prevent implosion of the bead (or other particle) surface into the interior and collapse of the cells while the entrained blowing agent continues to off-gas at atmospheric pressure. When sufficiently cooled, the bead preferably retains its spherical shape without coalescing with its neighboring beads. The external appearance of the bead is typically rough and irregular, with craters and ridges, as depicted in FIG. 2. The percentage of air in expanded polystyrene beads is typically about 90 to 97%. Technical features of numerous other materials that can be employed as porous materials in connection with the present invention are known in the art, see, e.g., the references provided following the Examples below.

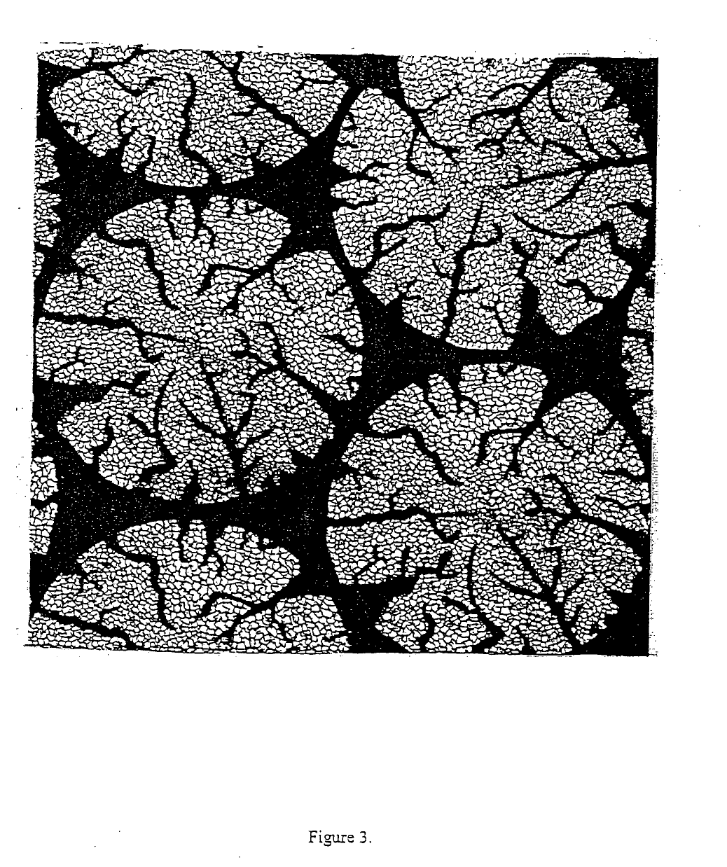

When porous materials, such as, for example, expanded polystyrene, polypropylene, other polyolefin or other porous materials as described herein and in the art, are thoroughly mixed with gas-generating polymer precursors under controlled conditions such that each individual bead (or other particle) can be wetted with the polymer mix, and the polymerization reaction begins to occur, the liquid polymer can be drawn or forced into the interior structure of the bead (or other particle) in a threadlike or branched filamentous fashion, through surface imperfections and voids by the gases produced by the polymerization chemical reaction when the mass is constrained in a closed mold. As will be appreciated by those of skill in the art, the pressure or force under which a given liquid will be drawn into a pore at a given pressure can generally be estimated according to the Young- Laplace equation, and the extent of wicking of a liquid in a porous medium can generally be estimated according to the Washburn equation (see, e.g., Chatterjee, Pronoy K., Absorbent Technology (2002, Elsevier). Optionally, additional pressure could be applied to force additional amounts of polymer into the porous material, thereby resulting in a stronger, but somewhat more dense material. When cooled and cured, the microscopic filaments or other projections harden, becoming rigid, while the polymer remaining on the exterior of each bead (or other particle) acts to hold the molded structure together in a more or less uniform matrix. Depending on the choice of porous material and polymer, some filaments or other projections may conjoin within the spherical expanded polystyrene bead (or other particle) while others do not. A cross section of a polymer matrix containing porous beads is depicted schematically in FIG. 3. The beads include portions into which filaments or other projections of polymer material have penetrated, as well as porous areas that have absorbed gases generated upon curing. While not wishing to be bound to any particular theory, it is believed that the filaments or other projections formed (e.g., by controlled hydraulic pressure caused by the off gassing of the polymerization reaction or exogenously applied, and/or by capillary pressures or other forces) contribute to the superior strength and other properties of invention materials when compared to conventional materials.

Conversely, decreasing the extent of penetration of polymer into the particulate material (e.g. by decreasing the extent of porosity of the particle and/or using other means as discussed previously) can be used to reduce the amount (and thus, cost) of polymer material required, and to reduce the overall density of the final material which may be particularly desirable for certain applications in which low cost, light weight, buoyancy and/or thermally insulative properties are particularly important. Varying the proportion of porous material (e.g., expanded polyolefin such as polystyrene, polyethylene, or the like) to total polymer can thus be used to prepare a range of materials that are strong and very light on one end of the spectrum to materials that are significantly heavier and exceedingly stronger than conventional foamed polymer of the same density.

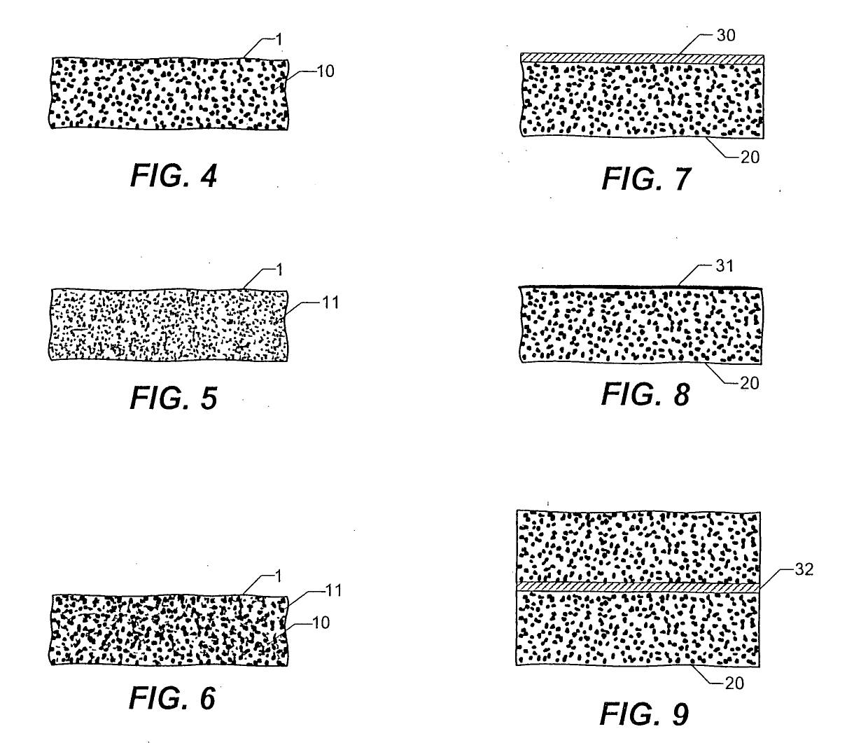

An exemplary material according to the invention incorporating large beads (10) in a polymer matrix (1) is depicted schematically in FIG. 4. An exemplary material according to the invention incorporating small beads (11) in a polymer matrix (1) is depicted schematically in FIG. 5. An exemplary material according to the invention incorporating a mixture of large beads (10) and small beads (11) in a polymer matrix (1) is depicted schematically in FIG. 6.

Polymerizable components contemplated for use in the practice of the present invention include polymer systems which generate gas upon polymerization thereof, or which can be treated with one or more blowing agents during cure, as well as other systems. Such systems can be further characterized in a variety of ways, for example, in terms of their viscosity. Suitable polymerizable components contemplated for use herein typically have a viscosity at 25° C. in the range of about 200 up to about 50,000 centipoise, with viscosities in the range of about 400 up to about 20,000 centipoise being presently preferred, with especially preferred viscosities falling in the range of about 800 up to about 10,000 centipoise.

As readily recognized by those of skill in the art, there are many polymer systems known in the art which are suitable for use in the practice of the present invention. For example, homopolymers, copolymers, block copolymers, graft copolymers, interpenetrating or semi-interpenetrating polymer networks, and the like, as well as other mixtures and combinations of polymers, can be employed. Exemplary polymers contemplated for use herein include polyethylenes, polyvinyl resins, polypropylenes (high and low density), polystyrenes and other polyolefins, acrylonitrile-butadiene-styrene (ABS) copolymers, polyurethanes, polyisocyanurates, polyvinylchloride, silicone based polymers, epoxies, latex and sponge, fluoropolymers, phenolics, wood flour composites, and the like, as well as combinations of any two or more thereof, each with specific pre-cure and post-cure physical properties.

As will be further appreciated by those of skill in the art (particularly in view of the descriptions, teachings and illustrations of the present application), depending on the particular application and attributes desired, a number of different types of polymers are known in the art and new polymers are regularly being developed that can be employed as or incorporated into the polymer, the porous material and/or reinforcements or additives used to prepare structural and other composite materials of the present invention. In addition to the illustrative polymers described and/or exemplified elsewhere herein, the following exemplary types of polymers serve to illustrate the sorts of organic as well as inorganic polymer systems known in the art that can be employed in the context of particular applications by applying the design, preparation and testing approaches illustrated herein and elaborated upon in the published literature; see, e.g., Seymour, Raymond B. et al., Polymer Chemistry (1988, Marcel Dekker); Allcock, Harry et al., Contemporary Polymer Chemistry (1990, Prentice Hall); Klempner, Daniel et al. (eds.), Polymeric Foams and Foam Technology (2004, Hanser Gardner Publications); and other various texts describing polymers and polymer chemistry referred to therein, elsewhere in this specification, or in the art.

Illustrative organic polymer systems include, for example, those based on polyurethanes, as well as systems based on vinylic or polyolefin compounds (such as polyacrylamides, polyacrylates, polyacrylonitriles, poly(acrylonitrile-acrylamide) copolymers, poly(acrylonitrile-butadiene) copolymers, poly(acrylonitrile-butadiene-styrene) ABS copolymers, poly(acrylonitrile-vinyl chloride) copolymers, polybutadienes, poly(1-butenes), poly(butyl-cyanoacrylates), poly(chloroprenes), poly(chlorotrifluoroethylene-vinyldiene fluoride) copolymers, poly(ethyl acrylates), poly(vinyl ethers), polyethylenes, polymethylenes, poly(ethylene-vinyl acetate) copolymers, poly(ethylene-propylene) copolymers, fluorinated ethylene-propylene copolymers, polyisobutylenes, poly(cis-1,4- isoprenes), poly(trans-1,4,-isoprenes), polymethacrylates, poly(methyl acrylates), poly(methyl-2-cyanoacrylates), poly(methyl methacrylates), poly(styrene-butadiene) copolymers, poly(styrene-methylstyrene) copolymers, poly(tetrafluoroethylenes), poly(tetrafluoroethylene-hexafluoropropylene) copolymers, poly(vinyl acetates), poly(vinyl alcohols), poly(vinyl butyrals), poly(N-vinylcarbazoles), poly(vinyl chlorides), poly(vinyl chloride vinyl acetates), poly(vinyl cinnamates), poly(vinyl fluorides), poly(vinyl pyrrolidones), poly(vinylidine chlorides), poly(vinylidine fluorides), poly(vinylidine fluoride-hexafluoropropylene) copolymers, poly(methyl vinyl ethers), polypropylenes, polystyrenes, and the like), and the like.

Additional illustrative organic polymer systems include, for example, those based on: (A) polyamides (such as poly(decamethylene carboxamides), poly(hexamethylene adipamides), poly(hexamethylene sebacamides), poly(nonamethylene ureas), polycaprolactams, poly(pentamethylene carboxamides), poly(aminohexanoic acids), poly(phenylene isophthalamides) and the like); (B) polyesters and polycarbonates (such as poly(cyclohexane-1,4-dimethylene terephthalates), poly(ethylene terephthalates), poly(butylene terephthalates), poly(4,4′-isopropylidine-diphenyl carbonates), poly(4,4′-carbonato-2,2-diphenylpropanes), and the like); (C) polyethers (such as poly(epichlorohydrins), poly(formaldehydes), poly(tetramethylene oxides), poly(tetrahydrofurans), poly(xylenols), poly(2,6-dimethyl-1,4-phenylene oxides), poly(phenylene sulfides), and the like); (D) phenol- and amine-formaldehydes (such as poly(phenol formaldehyde) resins, poly(melamine formaldehyde) resins, poly(urea formaldehyde) resins, and the like; (E) polyimides (such as poly(pyromellitimides), other poly(imides), and the like); (F) polyimines (such as poly(ethylene imines), and the like; (G) polysaccharides (such as celluloses, carboxymethylcelluloses, cellulose acetates, cellulose nitrates, and the like); (H) polysulfones (such as polyether sulfones, poly(diphenyl sulfone-diphenylene oxide sulfone) copolymers, Udel polysulfones, and the like); (I) polyalkynes (such as polyacetylenes and the like); and the like.

Illustrative inorganic, mineralogical or organic-inorganic polymer systems include, for example, those based on: (A) Polyphosphazenes (such as poly[bis(aryloxy) phosphazenes], poly[bis(trifluoroalkoxy) phosphazenes], and the like; (B) Polysiloxanes (such as poly(arylene-siloxanes), poly(carborane-siloxanes), poly(dimethylsiloxanes), organosiloxane ladder polymers, and the like); (C) Polysilanes and polycarbosilanes; (D) Poly(sulfur nitrides) (polythiazyls); (E) Phthalocyanine polymers; (F) Boron nitrides; (G) Carbon and carbon fibers; (H) Glass and glass fibers; (I) Polysilicates and ceramics; and the like.

For applications in which low weight, low cost and/or thermally insulative properties are particularly important, the use of foamable polymers provides advantages derived from the reduced amount of starting materials typically required to be incorporated into the polymeric phase, and the relatively low density of the resulting material. Exemplary foamable polymer systems include those in which the polymer system generates gas during polymerization, as well as those in which gas is introduced by use of a blowing agent or by physical means such as frothing (as described in the art and various references provided below regarding polymers and foamable polymer systems; see, e.g., Klempner, Daniel et al. (eds.), Polymeric Foams and Foam Technology, Hanser Gardner Publications 2004).

In one embodiment of the present invention, a combination of polymeric components can be employed to coat the porous material and form the polymer matrix. Thus, in one aspect, a first polymer can be employed to coat the porous material (frequently a low viscosity material having good wettability for the porous material, thereby facilitating coating of the porous material and ingress into the pores thereof), and thereafter, the coated particles can be further contacted with a second polymer, which, upon cure, substantially forms the matrix of the finished article. In another aspect, two or more polymeric components can be mixed with each other and then employed to coat the porous material, and the combination allowed to cure to form the finished article. In preferred embodiments, the first and second polymeric materials are selected such that, upon cure of each polymer system, the two polymer systems will also react or interact with one another to further enhance the properties of the resulting article. The first and second polymers can be selected such that they are capable of forming interpenetrating or semi-interpenetrating networks wherever they are polymerized in proximity to each other, in which case they can be tightly bound to, or associated with, each other even without being covalently bonded together. In another aspect, the functional properties of the two different polymer systems referred to above can be combined in a single, graft copolymer, such that a portion of the graft copolymer will have significant affinity for the porous material, and the remainder of the graft copolymer will form a strong matrix upon cure.

Some curing processes are exothermic and some are endothermic. Presently preferred polymer systems contemplated for use in the practice of the present invention are mildly or moderately endothermic or exothermic, so that only minimal heating and cooling are required in the preparation of invention materials. Mildly or moderately exothermic systems offer particular convenience in the manufacture of materials according to the present invention in that they do not require that heat be applied to drive the reaction, and yet do not generate so much heat as to melt many of the materials contemplated for use herein as the porous component of invention structural and other composite materials, or potential additives thereto. In presently preferred aspects of the present invention, lightweight, high- strength materials can be readily and cost-effectively produced without the need for exogenously applied heating or cooling during manufacture. However, for certain applications and where more rapid cycling is desired, it is possible to apply exogenous heat and/or cooling to facilitate processing, as is known in the art.

Some polymer systems generate gas as part of the curing process, while some polymer systems require the addition of external blowing agents, of which there are a wide variety with different physical characteristics (e.g., pentane, cyclopentane, carbon dioxide, nitrogen, and the like). As recognized by one of skill in the art, blowing agents can be introduced externally, or they can be generated in situ during preparation of invention materials (e.g., by compression of the porous material, which may contain gas entrapped therein). The generation of foamed materials, which can be particularly lightweight, can be brought about using any of a variety of techniques as known in the art, including: gas production as a result of reaction, expansion of a particulate material with entrapped gas (e.g. expanded polystyrene), expansion with a physical blowing agent, expansion with a chemical blowing agent, inert gas blowing agents, inert liquid blowing agents, reactive blowing agents, syntactic fillers, frothing of liquid polymer, nucleation and bubble growth. In the case of syntactic foams, a variety of different materials and techniques can be used to create micro- balloons that can be incorporated into a polymer to provide “pre-formed” voids of any of a variety of sizes and other attributes. As will be appreciated by those of skill in the art, both organic and inorganic or metallic syntactic foams are known which can be employed in the context of the present invention. Polymerization of the above-described systems can occur at a variety of temperatures, sometimes exceeding 100° C.; such processes sometimes are carried out at elevated pressures as well, e.g., up to several or more bars. As discussed herein, increasing the pressure during preparation of invention structural and other composite materials can be used to compact the components thereof, and/or to drive additional polymer matrix into the interior of the porous material, each of which tends to strengthen the resulting product. The amount of pressure to be applied is preferably sufficient to force some (i.e. a desired amount of) ingress of polymer into the porous material (e.g. to provide a desirable strength-to-weight ratio for a particular application), without being so great as to cause collapse of a substantial portion of the porous material. In view of the many gas-generating polymer systems contemplated for use herein, in certain embodiments of the present invention, the use of gas-generating polymer systems other than polyurethane is contemplated herein.

Alternatively, graft copolymer systems can be employed such that one portion of the graft copolymer is preferentially localized within the porous material and another portion of the graft copolymer is preferentially localized outside of the porous material, and joining of the two copolymer components (either directly or through linker molecules) results in a porous material core that is substantially encapsulated within and penetrated by a polymer matrix, resulting in structural and other composite materials that are of relatively low weight and yet high strength and structural integrity. As another alternative, the first and second polymer components can form an interpenetrating polymer network (IPN) or semi- interpenetrating polymer network (SIPN), and the polymer combinations can be selected such that one of the polymers (analogous to the first polymer component of the graft copolymer above) may be preferentially partitioned within pores of the porous material relative to the second polymer which may be preferentially partitioned external to the porous material.

Preferably, polymerizable components employed in the practice of the present invention are stable to temperatures of at least about 50° C. This facilitates handling of these materials, and minimizes the occurrence of premature curing. In addition, it is also frequently desirable that polymerizable components employed in the practice of the present invention be stable to such exposures as light, atmosphere, oxygen, water, and the like, which can impact the stability and/or reactivity thereof.

As readily recognized by one of skill in the art, numerous combinations of porous material plus polymerizable system(s) can be employed in the practice of the present invention. In selecting suitable combinations, one should take into account the compatibility of the two components, with reference to such considerations as the contact angle between the two components, the surface tension of the polymerizable system relative to the porous material, the pore size(s) of the porous material, the capillary radius of the pores of the porous material, the pressure to be applied upon processing of the selected combination, and the like. As will be appreciated by those of skill in the art, varying such aspects can be used to alter the “wettability” of the porous material as well as altering the relative penetration of the polymer into the porous material (and thereby potentially increasing strength of the resulting structural and other composite material) as described herein. The ability to easily produce a variety of different materials having properties optimized for various particular applications, provides a significant advantage of this approach.

The presently most preferred processes according to the invention employ a gas- generating polymer system, based, for example, on diisocyanates, for the preparation of a polyurethane matrix. The curing of diisocyanate has the benefit of being simple, occurring at or about room temperature and generating its own gas (i.e., carbon dioxide) and only moderate heat during the polymerization of the reactants, isocyanate and polyol. As discussed above, the gas generated during curing can be substantially absorbed by the porous material.

Among the advantages of invention formulations based on presently preferred urethane matrices is the fact that these formulations emit substantially no volatile organic compounds (VOCs) upon cure, unlike many conventional gas-generating formulations.

Presently preferred gas-generating polymerizable components contemplated for use in the practice of the present invention include polyurethanes, substituted polyurethanes, and the like, as well as mixtures of any two or more thereof. As is well known in the art, polyurethanes can be prepared in a variety of forms, including rigid foams, flexible foams, solids, adhesives, and the like.

As readily recognized by those of skill in the art, a wide variety of diisocyanate and polyol starting materials can be employed for the preparation of polyurethanes useful in the practice of the present invention. For example, a wide variety of aromatic diisocyanates can be employed, such as, for example, m-phenylene diisocyanate, p-phenylene diisocyanate, 4,4′-diphenylmethane diisocyanate, 2,4-toluene diisocyanate, 3,3′-dimethyl-4,4′-biphenylene diisocyanate, durene diisocyanate, 4,4′-diphenylisopropylidene diisocyanate, 4,4′-diphenyl sulfone diisocyanate, 4,4′-diphenyl ether diisocyanate, biphenylene diisocyanate, 1,5- naphthalene diisocyanate, and the like. Alternatively, a wide variety of aliphatic diisocyanates can be employed.

Similarly, a wide variety of polyol starting materials are suitable for use in the preparation of polyurethanes according to the present invention, including ethylene glycol, 1,2-propanediol, 1,4-butanediol, 1,4-cyclohexanediol, glycerol, 1,2,4-butanetriol, trimethylol propane, poly(vinyl alcohol), partially hydrolyzed cellulose acetate, and the like. Fire retardants can be added to the porous material (e.g. prior to mixing with resin) or they can be incorporated during or after polymerization according to the present invention.

Fire retardants contemplated for use in certain embodiments of the present invention include any compound which retards the propagation of fire, such as, for example, butylated triphenyl phosphate, and the like. As will be appreciated by those of skill in the art, a variety of different fire retardant additives (many of which comprise halogens and/or phosphorous groups) are available that can be incorporated into structural and other composite materials of the present invention. Such fire resistant additives include, for example, various phosphates and phosphonates, including both halogenated and non- halogenated forms, (see, e.g., the phosphates and phosphonates available from Akzo Nobel, www.akzonobel.com); expandable graphites such as graphite intercalation compound (GIC) (see, e.g., the expandable graphites available from Nyacol, www.nyacol.com); borates (e.g. zinc, manganese, etc.) (see, e.g., the borates available from Borax, www.borax.com); aluminum trihydrates (ATH) (see, e.g., the ATH products available from Almatis, www.almatis.com); ammonium polyphosphates (see, e.g., the ammonium polyphosphate products available from JLS Flame Retardants Chemical Co., wwwjlschemical.com).

Combinations of fire resistant or fire retardant compositions can likewise be used. By way of illustration, combinations of zinc borate with magnesium hydroxide and/or talc can be used to improve the fire resistance of various structural and other composite materials according to the invention. Indeed, combinations of a number of fire retardants, such as mixtures of antimony trioxides and organic bromo compounds (e.g. tetrabromophthalic anhydride) can act synergistically and thus be much more effective than single retardants.

In some cases, the addition of fire retardant additives to the composition may alter the structural or performance features of structural and other composite materials according to the present invention, or the processing thereof, in ways that are not desired for a particular application. In such cases alternative additives or external applications may be useful. As an example of the use of alternative additives in the case of organic polymers such as polyurethane-based foams, the use of compounds comprising nitrogen and/or phosphorous can be useful for providing fire resistance, and the inclusion of organic functional groups on an inorganic fire retardant can act to further facilitate the incorporation of a retardant into a polymer network and can enhance the usefulness of such applications. As an example of the use of external applications, the fire retardant properties may be provided by a coating or layer that is external to the core of the structure. Fire retardants can also be incorporated into coatings used to coat structural and other composite materials according to the present invention and/or into or onto facing materials or other layers or structures that are incorporated on one or more external surfaces, or between layers of composite materials, or within a composite material (such as by incorporation within a lattice or honeycomb structure that is integral to a composite structure). A large number of such coatings and materials are available (see, e.g., the fire retardant and firestop products of Fabrite Laminating Corporation, fabrite.com; Pacor Inc., www.pacorinc.com; Pyro-Chem, www.pyro-chem.com; Fire Retardants, Inc., www.fireretardantsinc.com; LIT Industries, www.litnc.com).

Flow enhancers contemplated for use in certain embodiments of the present invention include any compounds which reduce the viscosity and/or improve the flow properties of the formulation, such as, for example, 2,2-dimethyl-1(methylethyl)-1,3- propanediyl bis(2-methylpropanoate), and the like.

Plasticizers (also called flexibilizers) contemplated for use in certain embodiments of the present invention include compounds that reduce the brittleness of the formulation, such as, for example, branched polyalkanes or polysiloxanes that lower the glass transition temperature (Tg) of the formulation. Such plasticizers include, for example, polyethers, polyesters, polythiols, polysulfides, phthalates, tricresyl phosphates, sebacates, citrates, phosphate esters, and the like. Plasticizers, when employed, are typically present in the range of about 0.5 wt. % up to about 30 wt. % of the formulation.

Cure retardants (also known as cell size regulators or quenching agents) contemplated for use in certain embodiments of the present invention include compounds which form radicals of low reactivity, such as, for example, silicone surfactants (generally), nitrobenzene compounds, quinones, and the like.

Cure accelerators contemplated for use in certain embodiments of the present invention include compounds which enhance the rate of cure of the base polymer system, such as, for example, catalytically active materials, aldehyde-amine reaction products, amines, guanidines, thioureas, thiazoles, sulfenamines, dithiocarbamates, xanthates, water, and the like.

Strength enhancers contemplated for use in certain embodiments of the present invention include compounds which increase the performance properties of the polymeric material to which they are added, such as, for example, crosslinking agents, methylacrylato chrome complexes, zirconates, silanes, titanates, and the like.

UV protectors contemplated for use in certain embodiments of the present invention include compounds which absorb incident ultraviolet (UV) radiation, thereby reducing the negative effects of such exposure on the resin or polymer system to which the protector has been added. Exemplary UV protectors include bis(1,2,2,6,6-pentamethyl-4- piperidinyl) sebacate, silicon, powdered metallic compounds, aliphatic diisocyanates, hindered amines, benzotriazoles, substituted acrylonitriles (e.g. ethyl-2-cyano-3,3′-diphenyl acrylate), metallic complexes (e.g. nickel dibutyl-diothiocarbamate), phenyl salicylates, some pigments (e.g. carbon black), and the like.

Dyes contemplated for use in certain embodiments of the present invention include nigrosine, Orasol blue GN, phthalocyanines, and the like. When used, organic dyes in relatively low amounts (i.e., amounts less than about 0.2% by weight) provide contrast. By way of further illustration, dyes comprising organic moieties such as azo groups, anthroquinones, xanthenes, azines, aminoketones, indigoids, and the like can be used.

Pigments contemplated for use in certain embodiments of the present invention include any particulate material added solely for the purpose of imparting color to the formulation, e.g., carbon black, metal oxides (e.g., Fe₂O₃, titanium oxide), and the like. When present, pigments are typically present in the range of about 0.5 wt. % up to about 5 wt. %, relative to the base formulation. By way of further illustration, pigments comprising organic moieties such as azo groups, lithols, diarylides, dianisidines, quinacridones, carbazoles, anthraquinones, dioaxazines, isoindolines, perylenes, and the like can be used.

Other additives contemplated for use in certain embodiments of the invention include, by way of illustration, antioxidants (such as additives comprising hindered amines, secondary amines, derivatives of phenol and hindered phenols (e.g., di-tert-butyl-para-cresol), phosphates, thioesters, and the like); antistatics (such as additives comprising electrically- conductive materials, quaternary ammonium complexes, amines (e.g., hydroxyalkylamines), organic phosphates, derivatives of polyhydric alcohols (e.g., sorbitols), glycol esters of fatty acids, and the like); impact modifiers (such as additives comprising natural rubber, synthetic polyisoprenes, polybutadienes, and the like); antiblocking, lubrication, mold release or slip agents (such as additives comprising fatty primary amides, fatty acid esters, metallic salts of fatty acids (e.g. metallic stearates), waxes, polysiloxanes, polyfluorocarbons, and the like); and the like.

Fillers are also contemplated for use in certain embodiments of the invention. Fillers can be introduced into invention formulations to enhance one or more of the following properties: compression strength, shear strength, pliability, internal resistance (useful, for example, for holding nails, screws, and the like), wear durability, impact strength, fire resistance, corrosion resistance, increased density, decreases density, and the like. Fillers contemplated for use in certain embodiments of the present invention include metals, minerals, natural fibers, synthetic fibers, and the like. By way of further illustration, organic fillers (such as materials comprising cellulose, wood flour, nut shell flour, starch, proteinaceous fillers (e.g., soybean residues), cotton flock, jute, sisal, textile byproducts, lignin-type products (e.g., barks and processed lignins), synthetic fibers (e.g., polyamides, polyesters and polyacrylonitriles), carbon black, graphite filaments and whiskers, and the like), as well as inorganic fillers (such as talcs, micas, calcium carbonates (e.g., chalk, limestone and precipitated calcium carbonates), silica products (e.g., sands, quartz, diatomaceous earth and processed and pyrogenic silicas), calcium silicates, aluminum silicates, aluminum trihydrates, kaolins, glass materials (e.g., glass flakes, solid or hollow glass spheres and fibrous glass materials), metals, boron filaments, metallic oxides (e.g., zinc oxides, alumina, magnesia and titania, beryllium oxides, thorium oxides, zirconium oxides), metallic non-oxides (e.g., aluminum nitrides, beryllium carbides, boron carbides, silicon carbides and nitrides, tungsten carbides), barium ferrites, and the like) can be used. Such fillers can optionally be conductive (electrically and/or thermally). Electrically conductive fillers contemplated for use in certain embodiments of the present invention include, for example, transition metals (such as silver, nickel, gold, cobalt, copper), aluminum, silver- coated graphite, nickel-coated graphite, alloys of such metals, and the like, as well as non- metals such as graphite, conducting polymers, and the like, and mixtures of any two or more thereof.

Both powder and flake forms of filler may be used in the compositions of the present invention. Preferably, the flake has a thickness of about 2 microns or less, with planar dimensions of about 20 to about 25 microns. Flake employed herein preferably has a surface area of about 0.15 to 5.0 m²/g and a tap density of about 0.4 up to about 5.5 g/cc. In certain embodiments, flakes of different sizes, surface areas, and tap densities may desirably be employed. It is presently preferred that powders employed in the practice of the invention have a diameter (or other maximum dimension) of about 0.5 to 15 microns. If present, the filler typically comprises in the range of about 5 vol. % up to about 95 vol. % of the formulation, preferably 10, 15, 20, or 25 vol. % to about 90 vol. % of the formulation, more preferably about 30, 35, 40, 45, 50, 55 vol. % to about 60, 65, 70, 75, 80, or 85 vol. % of the formulation.

Thermally conductive fillers contemplated for use in certain embodiments of the present invention include, for example, aluminum nitride, boron nitride, silicon carbide, diamond, graphite, beryllium oxide, magnesia, silica, alumina, and the like. Preferably, the particle size of these fillers will fall in the range of about 0.1 up to about 100 microns, preferably about 0.5 to about 10 microns, and most preferably about 1 micron. However, larger or smaller particle sizes can be employed in certain embodiments. If aluminum nitride is used as a filler, it is preferred that it is passivated by an adherent, conformal coating (e.g., silica, or the like).

Optionally, a filler can be used that is neither an electrical nor thermal conductor. Such fillers can be desirable to reduce costs, to ease or improve production processes, and/or to impart some other property to invention formulations such as, for example, reduced thermal expansion of the cured material, reduced dielectric constant, improved toughness, increased hydrophobicity, and the like. Examples of such fillers include synthetic materials, such as, for example, perfluorinated hydrocarbon polymers, thermoplastic polymers (e.g., polypropylene), thermoplastic elastomers, poly-paraphenylene terephthalimide, fiberglass, graphite plies, graphite fibers, nylon, rayon, recycled polymers, recycled solid materials, solid scrap, solid polymeric material, scrap metal, re-ground chips, flaked chips, powder, paper, crumb, rubber, glass, hollow polymer beads, solid polymer beads, hollow glass beads, solid glass beads, scrap glass, recycled composition shingles, recycled asphalt, recycled roofing materials, recycled concrete, recycled tires, carbon, as well as a variety of other post- industrial or post-consumer plastics and other materials, and the like. Fillers can also include naturally occurring materials, such as, for example, mica, fumed silica, fused silica, sand, sawdust, gravel, stone aggregate, cotton, hemp, rice hulls, coconut husk fibers, shrimp carcasses, bamboo fiber, paper, popcorn, popcorn aggregate, bone, seeds, shredded straw fibers (e.g., from rice, wheat or barley), and the like, as well as mixtures of any two or more thereof. Fillers may be either porous or relatively non-porous. In the case of porous fillers, the polymeric matrix of invention materials may extend into, as well as, around such fillers, thereby potentially contributing further strength to invention materials.

Invention structural and other composite materials, sometimes referred to herein as PetriFoam™ brand structural and other composite materials, can be made to have superior compression moduli (as desired), which can fall in the range of about 8000 psi up to about 10,000 psi or higher. Depending on the desired application, materials of the present invention can be prepared having compression moduli exceeding 2000, 4000, 8000, 10,000, 20,000, 40,000, 100,000 or higher. In addition to the superior compression strength of invention materials, these materials are capable of withstanding compressive pressures exceeding 400, 1000, 4000, 8000, 12,000, or even higher before fracture. Indeed, exposure of invention articles, after curing of invention materials, to elevated compression pressures (but short of fracture) can produce an article with enhanced strength.

Invention structural and other composite materials may also have superior resilience, as measured, for example, by the flexural modulus of a sample. Such materials are useful in a variety of specific applications, as set forth in detail below. Typically invention materials have a flexural modulus which falls in the range of about 10,000 psi up to about 14,000 psi or higher. Even higher flexural modulus materials can be obtained by the use of suitable fillers. For example, flexibility can be enhanced if desired for certain applications by incorporating flexible materials such as flexible plastics or rubber, which can be from recycled materials, as well as other flexible materials.

Additional desirable properties which can be provided by invention materials include superior insulating properties, water resistance (or absorption) properties, energy absorption properties, memory effects (wherein invention materials return substantially to their original shape after impact), mold and/or other microbe or pest resistance, radar absorption, and the like.

As described and illustrated herein, a number of additives, fillers and/or other components can be employed in combination with the porous materials and polymers as described in the present application to potentially provide new properties and/or enhance one or more attributes of the resulting structural and other composite materials according to the invention. For example, fire retardants, UV protectants, pigments, electrically and/or thermally conductive fillers, as well as numerous other components, may be added to invention materials to improve one or more properties desired for a particular application. Depending on the particular combination of porous material, polymer and additive, and the particular application and/or properties desired of the resulting composite, the incorporation of the additive preferably imparts whatever property or benefit is sought by the additive and improves, or at least does not substantially reduce, the strength and/or other beneficial properties of the underlying composite. Similarly, potentially preferred combinations of additives with porous material and polymer will typically be those in which the interactions between the additive and the other invention materials enhance, or at least do not substantially impair, the process of preparing such composites (in terms of their ease of preparation, mixing, molding, and the like).

For some combinations of porous material and polymer, the incorporation of a potentially preferred additive may alter aspects of the preparation process and/or the resulting structural and other composite materials that may make it less optimal for a particular application. This may occur more frequently in cases in which the porous material and/or polymer are organic or largely organic materials (such as polyolefins and polyurethane) and the additive is largely an inorganic material, or vice versa. Without wishing to be bound by theory, the intermolecular interactions between various organic compounds, which may be mediated by hydrogen bonding, van der Waals forces, ionic interactions and/or dipole-dipole interactions, may not be similarly promoted or may be impaired by the introduction of certain inorganic compounds.

In circumstances such as the foregoing, a number of different technical approaches can be applied for enhancing interactions between a desired additive and the porous material and/or the polymer matrix. One such technical approach is to select additives having a primary structure that interacts favorably with the porous material and/or the polymer matrix as desired (for example, selecting an organic additive to be employed with an organic porous material and polymer combination). Alternatively, versions of additives may be selected or prepared in which one or more functional side groups is incorporated into the additive to enhance interactions between the additive and the porous material and/or polymer (e.g., an additive having principally inorganic groups may be functionalized by the addition of organic side groups). As another alternative, additive functional groups (i.e., molecules that perform one or more functions of an additive, such as phosphates in the case of fire retardants) may be incorporated onto an organic backbone which may likewise function as a bifunctional additive that is readily incorporated into a composite of porous material and polymer (such an organic composite of polyolefin and polyurethane for example). As still another alternative, the additive functional groups may be incorporated directly into the structural or other composite material according to the present invention by using such a bifunctional additive as one of the polymers of the composite (e.g., in a copolymer or in a form of interpenetrating or semi-interpenetrating polymer network) or incorporating it into the porous material.

By way of illustration of the preceding principles, taking fire retardants as an example, a number of commonly effective fire retardants are based on one or more inorganic groups such as various materials containing phosphorous and/or nitrogen, which may act synergistically. Selecting or preparing versions of such additives that comprise one or more organic side groups can potentially be used to enhance interactions between such additives and an organic porous material and/or polymer combination, such as a polyolefin and a polyurethane for example. Thus a number of inorganic compounds which comprise phosphorous and/or nitrogen can potentially be used as effective fire retardants for materials such as polyurethane, and incorporating carboxylic acid and/or other organic functional groups into the otherwise inorganic additive can be used to enhance its integration into an organic material such as polyurethane. An alternative approach can be to employ an organic backbone (designed to interact favorably with an organic polymer and/or porous material) which is modified by inclusion of the “additive” groups (e.g. phosphorous and/or nitrogen) as side chains. Employing such bifunctional molecules, or modifying known additives to introduce such bifunctionality, can be employed to enhance interactions between particular combinations of porous material and/or polymer and one or more desirable additives.

In embodiments of the invention where superior strength is a desired feature of the resulting structural material, it is preferred that the polymer matrix comprises fewer and smaller cavities formed during foaming. For such an embodiment, a majority and preferably at least 20, 30, 40, 50, 60, 70, 80, 90, 95, 98% or more preferably substantially all of the gas generated during curing of the polymer is absorbed by the porous material, and a quantity of the polymeric material is preferably drawn or forced into the body of the porous material. The resulting polymer matrix is preferably relatively solid, except for those portions occupied by the porous material, and filaments or other projections of polymer extend into the body of the porous material. While not wishing to be bound by any particular theory, it is believed that the combination of a relatively solid polymer matrix with polymer filaments or other projections extending into the body of the porous material contributes to the exceptional properties of invention materials, including strength, flexural modulus, and compression. While a relatively solid polymer matrix is generally preferred, in certain embodiments where strength can be reduced, a matrix having cavities can be acceptable, or even desirable since it can be used to generate lighter materials and at a lower cost.

In order to produce structural and other composite materials having even greater structural integrity suitable for use in an even wider range of potential applications, one or more reinforcement structures can be incorporated within invention materials. Exemplary reinforcement materials include natural fibers, synthetic fibers, silica-based materials, or other structures, as well as combinations of any two or more thereof. Such reinforcement materials can be of any size, shape, length, etc. Reinforcement materials, may be conveniently mixed with composite precursors before addition of a component or components responsible for initiating polymerization of the polymer. By way of illustration, in a composite prepared from mixing a polyolefin or other bead (or other particle) with the first component of a two-component polymer system such as a polyurethane system, fibers or other reinforcement materials may be introduced into a mixture of beads (or other particles) that have been wetted with the first polymer component. A variety of fibers that can be used to provide reinforcement within polymer matrices, such as glass, aramid, carbon and other fibers are known in the art. Without wishing to be bound by theory, it is believed that the composite polymer matrix of the present invention can serve to spread loads applied to the composite among the various fibers or other reinforcement materials as well, and at the same time can protect such materials from abrasion and other external stresses, resulting in a high performance but relatively lightweight composite. Generally speaking, while aramid and carbon-based fibers are somewhat more expensive than glass-based fibers, they tend to exhibit greater strength and relative stiffness which can make them more desirable for applications in which those overall features are critical.

Depending on the application and desired attributes, a number of other fibers can be used, including, for example, fibers based on nylon, polyvinyl alcohol, polyacrylonitrile, polyester, and the like. For increased strength, structural and other composite materials according to the present invention can comprise continuous filaments that have been impregnated with resin prior to curing, that have been pyrolized (e.g., graphite fibers), or have been subjected to deposition with groups such as boron atoms (e.g., boronated tungsten or graphite filaments). Such fibers may provide other attributes as well as strength; for example, sodium hydroxycarbonate microfibers improve both the physical properties and flame resistance of a number of polymers. Single crystals or whiskers of a number of materials (e.g., alumina, chromia and boron carbide) can also be used to improve performance properties of composites. As is also known in the art, fibers may be introduced into structural and other composite materials according to the present invention in random or relatively directional manners as desired in order to provide additional strength, either randomly throughout the composite or in certain directions that are expected to be subject to increased loads or stresses.

As with additives, bifunctional compounds or coupling agents can be used to improve the interface between a number of different fillers and/or reinforcement materials and polymers that may be used in the context of the present invention. Such coupling agents can increase the tensile and other strengths of the resulting composite structure and potentially improve its performance attributes and thus desirability for particular applications. A large number of such coupling agents are known in the art for improving the interface between particular combinations of materials. By way of illustration, the interface between fibrous glass and resins such as polyesters can be enhanced through the use of mercaptopropyltrimethoxysilanes (apparently through the silane moieties interacting with silanol groups on the fibrous glass and the mercapto moieties coupling with the polymer). Similarly, many silane zirconate and titanate coupling agents (e.g., triisostearyl isopropyl titanate) have been used to enhance the interactions between various polymers and materials used as fillers or reinforcements; stearic acid has been used to improve the interfacial interactions between resins and calcium carbonate fillers; o-hydoxybenzyl alcohol or ethylene alcohol have been used to improve the interfacial interactions between resins and silica-based fillers. Although many such coupling agents are typically applied to first treat or coat a filler, reinforcement or additive, bridging can also be accomplished by incorporation of coupling agents such as titanates or silanes into the polymer first, or into a mixture of the polymer (or pre-polymer) and filler, reinforcement material and/or additive. Without wishing to be bound by theory, it is believed that in many structural and other composite materials according to the present invention comprising combinations of a relatively continuous polymeric phase or matrix, and a relatively discontinuous phase (comprising the porous material of the present invention and/or a filler, reinforcement material or additive that has been co-incorporated), stresses applied to the continuous phase may be transferred to one or more of the associated discontinuous phases; and the effectiveness of such stress transfers may be enhanced by reducing the levels of moisture that may be present and/or employing coupling agents that improve the interfacial attractions.

Reinforcement structures can be conveniently provided as preformed structures, but they can also be formed coincidentally with preparation of the composite. In the case of reinforcement structures that are pre-formed prior to introduction into the composite, they may be conveniently introduced after all components have been mixed but before polymerization is complete. By way of illustration, a reinforcement structure or structures may be introduced into a mixture of composite precursors such as beads (or other particles) that have been wetted with polymer components. One particularly useful type of reinforcement structure is a lattice or honeycomb structure that can be combined with composite materials as described herein to form structures having high strength-to-weight ratios. In such combinations, the honeycomb structure can form a layer or surface that is coated or surrounded by composite material, that is adhered to the outside of a core of composite material, or that is integrated within composite material, depending on the desired application. In the latter regard, by way of illustration, a honeycomb lattice or other structure may be placed into a batch of composite precursors (such as polymer wetted porous beads) or composite precursors may be introduced into an open-cell honeycomb lattice or other structure, after which polymerization of the polymer results in a composite material having an integral structural reinforcement. In the case of filled honeycombs, the presence of composite or other material filling the open cells can enhance the mechanical properties of the lattice by stabilizing the cell walls, as well as enhancing properties such as thermal and sound insulation, and providing an overall structure that can exhibit very high strength to weight ratios. Where lamina or exterior surfaces are bound to the outside of the honeycomb or other lattice structure, the filling of at least exterior cells of the honeycomb can also provide a greater surface area for bonding. In addition, as described herein, since composite materials of the present invention can be selected to form tight bonds with such laminas, the wrapping or surfacing of a filled honeycomb core can be further enhanced by strongly bound lamination.

Exemplary honeycomb lattice structures include open-cell (or partially open-cell) structures, such as rigid or semi-rigid structures comprised of paper or other organic derivative material or fiber, plastic or other such synthetic material, or aluminum or other metal. Aluminum and other metal honeycombs, particularly when they are integrated into composite material, can provide structures of considerable strength, with high compression, tensile, flexural, shear and/or strength-to-weight ratios. Honeycomb lattices and other structures of less dense materials, such as honeycombs made of polypropylene and/or other polyolefins, polyamide fibers, and the like, can also provide considerable strength while generally contributing less to the overall weight of the composite. A large variety of metallic lattices, polyolefin lattices as well as lattices made from polyamides such as aramid fibers (e.g. Kevlar or Nomex) are available. Honeycombs and other lattice structures can also be made of Kraft paper, carbon fibers, balsa and other lightweight woods, and other lightweight materials which can, if desired, be impregnated with other materials such as phenolic resins to enhance integrity. One of skill in the art can readily determine suitable dimensions of any added reinforcement materials, depending on the end use contemplated for the material.

As an alternative to including one or more reinforcement(s) in invention materials, or in addition to such inclusion, one or more facing materials can be applied to invention materials, optionally employing a suitable adhesive material, adhesive promoter, or tie coat, as needed. A wide variety of facing materials are suitable for such purpose, such as, for example, facings comprising metal, polymers, cloth, plant fiber or other natural fibers, synthetic fibers, glass, ceramic, expanded metals and screens, and the like, as well as combinations of any two or more thereof. Additional facing materials contemplated for use herein include naturally occurring materials (such as, for example, wood), synthetic sheet materials (such as, for example, acrylic sheet material), natural or synthetic woven materials (such as for example, a Kevlar weave), and the like. While only illustrated in FIG. 7 as being bonded to one face of the invention material, facing materials can be bonded to a plurality of faces of invention materials (e.g., top and bottom of invention materials may have a facing material applied thereto, all faces of invention materials may have a facing material applied thereto, various facing materials may be applied between layers of invention materials (which layers may be of the same or differing formulation), as well as other variations which will be apparent to those of skill in the art). Such facing materials can be in the form of a solid surface, a porous surface, a surface that can be chemically etched, a chemically etched surface, a surface that can be physically abraded, a physically abraded surface, and the like, as well as combinations of any two or more thereof. In a particularly preferred embodiment, a length of bamboo is filled with invention material, yielding a strong structural member suitable for use in, e.g., construction materials, or scaffolding. Suitable adhesive materials contemplated for use in this aspect of the present invention include epoxies, polyesters, acrylics, urethanes, rubbers, cyanoacrylates, and the like, as well as combinations of any two or more thereof.

Among the advantages of exemplary invention structural and other composite materials is the fact that these materials emit substantially no off-gases, unlike many conventional structural and other composite materials, especially those prepared employing gas-generating formulations.

In accordance with yet another embodiment of the present invention, there are provided methods of making structural and other composite materials having a compression modulus of at least about 8000 psi, and a flexural modulus in the range of about 10,000 psi up to about 14,000, the method comprising:
combining porous material with a gas-generating polymerizable component, and
subjecting the resulting combination to conditions suitable to allow the polymerizable component to polymerize. Preferably, during the polymerization process using a substantially closed or pressurized system, substantially all of the gas generated is absorbed by the porous material and some of the polymeric material can be forced into the body of the porous material.

The combining contemplated by the invention method can be carried out in a variety of ways. For example, the gas-generating polymerizable component(s) and the porous material (and any additional components contemplated for a specific use) can be mixed, then the gas-generating polymerizable component allowed to cure. Where there are multiple polymer components (or precursors such as components of a multi-component polymer system), these may be mixed with each other prior to combination with the porous material; or alternatively one or more of the polymer components or precursors may be first mixed with the porous material prior to introduction of an additional polymer component or precursor. In one embodiment of the present invention, the mixture is introduced into a mold, the mold closed, and the gas-generating polymerizable component is allowed to set. In another embodiment of the present invention, the mixture is introduced into a confined space and compressed to a volume less than the original volume of the starting components. The mixture may, as another alternative, be prepared in an open system, or may be sprayed or otherwise applied onto a surface. If additional strength is desired, it may be cured under compression such that the generated gases are substantially absorbed by the porous material and such that some of the polymer is forced into the body of the porous material.

When invention formulations are subjected to pressure to reduce the volume thereof, a wide range of pressures can be employed, typically in the range of about 1 up to about 10 psi, but higher pressures can also be applied if desired to produce relatively higher strength composites. Alternatively, without regard to the pressure that may be involved, invention formulations can be cured in a confined space so that the cured article is of reduced volume relative to the volume of the starting materials. Volume reductions in the range of about 5-10 percent, up to 20-40, 40-60, 60-80, 80-90 percent, or higher, are contemplated in the practice of the present invention.

In still another embodiment of the invention, rather than prepare invention articles in a mold to achieve a specific shape, standardized “building block” structures can be prepared and thereafter combined into a desired shaped article. This is desirable, for example, when the topology of the invention articles does not admit to molding in a single piece. This is possible because invention materials can be readily adhered to one another using standard adhesive materials such as, for example, urethanes, epoxies, and the like. Blocks or other units of composite materials can likewise be conveniently prepared from larger panels by processes including scoring or partitioning. By way of illustration panels or sheets of invention composites could be scored after polymerization to allow for separation into individual blocks, or a partitioning device could be included during polymerization to facilitate separation in much the same manner that an ice cube tray works. Such scored panels could optionally have a flexible facing such as nylon or other material that could serve as a backing.

When the polymerizable component (such as a foamable polymerizable component) is prepared from a multi-component (e.g., a two-component) system, and when polymerization proceeds relatively rapidly (i.e., relative to the amount of time required for mixing and mold filling), then it can be convenient for the porous material to be first mixed with only one of the polymerizable components, before introduction of the second component into the reaction vessel. In such a case, it is generally preferred that the porous material first be mixed with the less viscous of the components of the two-component system. For example, the surface of the porous material can be substantially completely coated with a precursor of the polymerizable component. Alternatively, the surface of the porous material can be only partially coated with a precursor of the polymerizable component. As another alternative, multiple components of a multi-component polymer system, which may or may not be sufficient to initiate polymerization, can be first mixed with each other and then applied to partially or substantially completely coat the surface of the porous material. Pre- mixing of liquid components, such as multiple components of a polymer system, and application of the complete volume to the porous material can be particularly convenient in situations in which the formulation comprises a large relative volume of porous material to be coated, and/or situations in which the porous material first absorbing one component of a multi-component polymer system adversely impacts the preferred stoichiometry of the components of a multi-component system. Optimization of such conditions for a particular formulation and application can be readily accomplished by applying techniques as described herein and in the art. As will be appreciated, where such multiple components do initiate polymerization, then the mixing with porous material would preferably be conducted relatively soon thereafter such that mixing can occur prior to the completion of polymerization. The rate of polymerization can also be modulated as desired to allow sufficient time for mixing, for example, by reducing the amount of, or eliminating the presence of polymerization catalyst(s), by use of a polymerization retardant or conditions to slow polymerization, and the like. Alternatively, the porous material can be mixed with two or more polymerization components that do not themselves substantially initiate polymerization, and then a polymerization initiator or environmental conditions can be used, for example, to trigger polymerization.

Alternatively, invention articles can be prepared from a one-component monomer (e.g., polyurethane), wherein all components of the polymer are combined with the porous material, and cure of the polymer is commenced by addition of water thereto. Copolymers can also be employed, such as block copolymers, in which the matrix can be designed to incorporate two or more different functional polymer groups, and/or graft copolymers such as the copolymer system designed to facilitate porous material penetration as described above. Other combinations of polymers that have desirable attributes and that can be bound together or intimately associated with one another by noncovalent means, including those which form interpenetrating polymer networks and semi-interpenetrating polymer networks, as well as other polymer combinations or mixtures, can also be used.

Facings or coatings can be applied to invention articles by introducing facings and/or coatings into the mold before the reaction mixture is introduced. Alternatively, facings and/or moldings can be applied after molding. It is also within the scope of the present invention to add reinforcement materials (such as metallic meshes, ceramic or silica- based materials, textiles or other fabrics, rubber, and the like) to the mold so as to produce an integral reinforced material. As described and illustrated herein, such reinforcement materials may be incorporated within, outside or between portions of invention materials. A schematic depiction of an example article according to the present invention having a facing material attached thereto is presented in FIG. 7.

Facing materials contemplated for application to invention materials include naturally-occurring materials (such as, for example, wood, bamboo or other plant-derived fiber), synthetic sheet materials (such as, for example, acrylic sheet material), natural woven materials (such as for example, cotton or hemp), synthetic woven materials (such as for example, KEVLAR weave, weaves of various synthetic fibers such as carbon, graphite, glass fibers, and the like), and the like. As readily recognized by those of skill in the art, facing materials can be bonded to one or a plurality of faces of invention materials (e.g., the top and bottom faces of invention materials may have facing materials applied thereto, all faces of invention materials may have facing materials applied thereto, as well as other variations as are apparent to those of skill in the art).

As readily recognized by those of skill in the art, a wide variety of coatings can be applied to invention materials. Coating materials contemplated for application to invention materials include Portland cement (typically applied as a slurry in water, or with a silica- based material, imparting fire retardant properties to the treated article), gypsum, gel coat, clear coat, color layers, non-stick coatings, slip resistant coatings, adhesives, scratch resistant coatings, metallized coatings, and the like. FIG. 8 provides a schematic depiction of invention material having a coating material applied thereto. For some coating materials, it is beneficial to enhance the ability of coatings to adhere to invention articles. This can be accomplished in a variety of ways, such as, for example, by physically and/or chemically etching the surface of such articles. Thus, as illustrated herein, the surface area of the article to which a coating is to be applied can be increased, thereby improving ability of the coating material to adhere to the article being treated.

When facing materials and/or coatings are to be applied to invention materials, the surface of the invention material to which the facing and/or coating is to be applied can be subjected to physical and/or chemical abrasion to increase the porosity of the substrate and enhance the adhesion of facing materials and/or coatings thereto. For example, the invention materials can be subjected to sandblasting and/or chemical etching or abrasion to abrade the surface skin thereof, rendering the surface of the invention material more receptive to application of facing materials and/or coatings thereon. In certain embodiments of the present invention, one can apply facing material and/or coating to either side of a support. Such a configuration is depicted schematically in FIG. 9.

Those of skill in the art can readily determine conditions suitable to allow the gas- generating or other polymerizable component employed herein to polymerize. Typically, such conditions comprise adding polymerizing agent to the combination of porous material and precursor of the gas-generating or other polymerizable component, generally at or about room temperature. Thus, the heating and cooling requirements of the invention process are minimal, such that the process can readily be accomplished, for example, by vibrating the vessel containing porous material, precursor of the gas-generating or other polymerizable component and the polymerizing agent immediately after introduction of polymerizing agent thereto.

In accordance with certain embodiments of the present invention, up to about 25, 30, 35, 40, 45, 50 wt. % or more of the porous material employed can comprise recycled (ground) structural material as described herein. As readily recognized by those of skill in the art, even higher amounts of recycled invention material can be employed, depending on the material being recycled and the end use contemplated therefor.

In accordance with another aspect of the present invention, there are provided articles prepared according to the above-described methods.

In accordance with yet another aspect of the present invention, there are provided articles fabricated from invention materials. Such articles can have a defined shape, superior compression strength and modulus, and if desired, a high flexural modulus. Such articles can comprise a flexible or rigid polymer matrix containing porous material substantially uniformly distributed therethrough. Invention articles have superior performance properties that render them suitable for a wide variety of applications. An especially useful application of invention materials is in applications where a structure prepared therefrom is at risk of exposure to seismic activity. Because invention materials can have such high strength and other desirable properties (including superior structural elasticity and memory), and relatively low weight, very low momentum is generated if a structure prepared therefrom is subjected to seismic forces. Thus, invention materials have particularly desirable properties for use in a variety of construction applications.

A non-exhaustive list of examples of the wide variety of applications for which invention articles can be employed is provided herein. Invention articles can be shaped as appropriate to facilitate any of the following uses:
aircraft/aerospace/defense/power generation (e.g., airplane components, remotely piloted vehicle components, cruise missiles, solar powered aircraft, heat shields, rocket motor casings, accessories, military drones, kit planes, ultralight planes, aircraft security/stealth components, lightweight/strengthened doors, aircraft furniture, panels, homeland security structural protection systems, wind-power-generation propellers and blades, water power generating wheels or blades, turbines, supporting structures for solar power generation, wings-in-ground-effect craft, radar absorption materials, aircraft engine cowlings, aircraft propeller blades, aircraft flaps, aircraft rudders, aircraft fuselage, aircraft ailerons, seaplane floats, hang gliders, insulation for rocket motor fuel tanks, and the like),
agricultural (e.g., plant protectors and planters, livestock feeders, electric fencing posts, livestock pens, and the like),
yard/lawn/garden/pet/horticultural/greenhouses (e.g., doghouses, feeding and watering dishes, shelters and canopies, kennels, sleeping mats, animal shipping cages, dog and cat beds, cat scratchier, plastic furniture (e.g., for lawn, porch, garden, patio, and the like), decorative art panels and screens, decorative stampings and trims, snow fencing, flower boxes, pots, tubes, vases, lawn and garden fountains, garden ornamentals, urns, and the like),
electronics (e.g., telecommunications antennas, cable reels, cable trays, battery boxes, battery storage racks, photovoltaic, cellular antennas, electric wiring raceways, and the like),
appliances (e.g., household appliances, such as refrigerators, dishwashers, ranges, microwave ovens, washers, dryers, and the like, as well as housing for various appliances, such as, for example, housing for televisions, computers, CRTs, business machines, microwave ovens, dishwashers, laundry washers and dryers, compactors, freezers, refrigerators, air conditioners, dehumidifiers, portable heaters, and the like),
refrigeration (e.g., cold storage buildings, champagne buckets, ice buckets, beverage coolers, condenser drip pans, walk in freezers, refrigerated railroad freight cars, ice bunkers, reefer trailers, refrigeration insulation, and the like),
business equipment and electronics (e.g., copiers, computers, computer components, computers, television components, telephones, appliance moldings and casings, electrical tools, electronic cases and racks, and the like),
building and construction—any application which can benefit from materials impervious to mold, termite infestation, and the like, such as, for example, swimming pools, swimming pool covers, hot tubs, hot tub covers, cooling towers, tub and shower units, bridge decks, bridges, overpass structures, seismic reinforcement structures, highway signs, freeway energy absorbing barriers and acoustic absorbent side walls, insulated structural panels, home building construction, panels for commercial building construction, architectural details and facades, sound attenuation barriers, insulation, waterproofing materials, concrete forms and molds, manufacturing forms and molds, structural framing systems, pilings, sandwich components, highway delineators, pre- manufactured homes, pre-manufactured offices, highway impact-absorption barriers, racetrack impact absorption barriers, roofing, flooring, siding, door laminates, woodwork laminates, dimensional lumber and panels, disaster and military-temporary living shelters, sanitary waste processing buildings and tanks, hospitals and operating rooms, clean rooms and laboratories, decontamination buildings, bathhouses, refrigerated storage buildings, kitchens, mess hall's, offices, warehouses, workshops and vehicle maintenance buildings, computer control rooms, furniture, tables, doors, airplane hangers, stretchers, coffins, beds, garbage cans, insulated drinking water cans, insulated perishable food containers, insulated ductwork for heating and air- conditioning units, on-site fabrication and construction of homes, housing, offices, temporary quarters, construction building blocks and bricks, arctic structures, internal structural fill for expanded polystyrene foam formed houses, replacement for green board for under tiled landing surfaces, countertops, tabletop, desktops, workbench surfaces, trim boards, sash, shutters, siding, sheeting, architectural moldings and ornamental moldings, doors, doorframes, window frames, insulated and structural sliding panels, retaining walls, lightweight portable walkways and personnel bridges, decking, railing, fences, gates, corrals, carports, awnings, mud mats for heavy equipment, crane rigging mats, automobile and pedestrian barricades, traffic cones, guardrails and posts, caution and safety signs, cab and bus stand shelters, farm buildings and storage sheds, portable buildings, prefab structures, pre-engineered buildings and structures, cabanas, canopies, wallboard, portable classrooms, clean rooms, cofferdams, construction forms for placement of cement and concrete, contractor mixing pans, composite dimensional lumber, various types of sheeting, engineered lumber and beams, extruded sheeting and shapes, cast fireplace mantels, roof and floor trusses, insulated doors, insulated roofing systems, laminated veneer sheets, sandwich honeycomb panels, noise barriers, pedestrian bridges, garage doors, roofing sheets, roofing shingles, roads, scaffolding systems, scaffold planks, sauna buildings and baths, door skins, temporary sidewalk plates, sub floors, cabinets, and the like,
industrial (e.g., storage buildings, bullet resistant enclosures and systems and traps, hoods, canteens, loading booms, chutes, spouts, gaskets, tubes, light fixtures, ceiling fan blades, air diffusers, laundry hampers, fan housings, wheels, vanes, manhole and covers, fire hose cabinets, safety guard covers, palette wrapping, mailboxes, palettes (reusable and/or recyclable), palette box, overhead doors, parking barricades, parking curbs, room dividers, seats and benches, shelving, ballistic shields, shower and bathroom stalls, reels and stools, trays, and the like),
industrial liners (e.g., bulk container liners and systems, railroad car liners, closet liners, all types of coatings, drum liners, hoods, irrigation ditch lining, noise control enclosures, and the like),
furniture (e.g., upholstered furniture frames, benches, bleacher seats, chairs, stools, folding card tables, tables, office partitions, and the like),
consumer and industrial packaging products (e.g., refuse containers and tote boxes, food preservation containers, ultra-light airfreight containers, reusable boxes and shipping containers, crates, burial vaults, mausoleums, recyclable packaging, packing and shipping containers, cemetery vaults, cartons, canisters, cannons, cartridge boxes and ammunition boxes, casks and barrels, collapsible boxes and shipping crates, oceangoing shipping containers, corrugated plastic containers and packing, custom molded plastic boxes and housings, drums, egg cartons and cases, instrument cases, folding boxes, cartons, garbage cans, grain bins, retail store fixtures, shelving, molded cases and boxes, countertops, furniture, and the like),
signs and product displays (e.g., bulletin boards, erasable boards, changeable letter boards, clipboards, display boards, boxes, cab nets, cases, fixtures, panels, racks and stands, tables, trays, light boxes, picture frames, military targets (land, sea, air), outdoor advertising signs, stage scenery and props, tradeshow booths and displays, and the like),
recreational goods (e.g., sports equipment, golf clubs, campers, exercise equipment, snowboards, surfboards, boogie boards, golf carts, bowling equipment, totes and boxes, motorcycle helmets, bicycle helmets, other sports helmets, elbow and knee protectors, gloves, athletic and non-athletic footwear including shoes and boots, skis, skateboards, camping trailers, rifles, shotguns, revolver stocks, forearms, decoys, snowshoes, riding saddles, snow sleds, and the like),
children's toys/yard toys (e.g., castles, playhouses, swing seats, slides, sandboxes, toy chests and boxes, building blocks, alphabet toys, passenger safety seats and restraints, furniture such as high chairs, chairs, crlbs, desk, beds, sandboxes, tables, toy vehicles and ride in vehicles, wagons, swing seats, spring-loaded riding animals, hobby horses, rocking horse, and the like),
corrosion-resistant equipment (e.g., pollution-prevention equipment, wastewater treatment products, pipe fittings, aboveground and underground storage tanks, pumps, containers, and various equipment used in the chemical processing, pulp/paper processing and oil/gas industries, oil and gas recovery equipment, wheels that generate power, and the like),
electrical/electronic equipment (e.g., housing and circuit breaker boxes, pole line hardware, electronic connections and insulation, rods and tubes, substation equipment, electronic microwave components, electrical enclosures and lighting enclosures, 3D boards, polyester panel boards, and the like),
marine (e.g., yachts, boats, jet skis, canoes, marine docks, personal watercraft and moorings, naval boats, ships, racing craft, commercial ships and component parts, including marine equipment and motor covers, marine vehicles that operate in ground effect, marker buoys, mooring buoys, channel, instrumented, scientific buoys, weather buoys, fishnet buoys, life rafts, boat fenders, rigid hulls for inflatable boats, dock storage boxes, dingy and water tenders, floatable paddles and oars, water sport toys, diveyaks, crab and lobster trap markers, hatch covers, composition boat anchors, dock steps, swimming platform floats, boarding ladders, pontoon boats, steering consoles, portable and built-in galley ice chests, refrigerators, galley tables and cabinets, fish cleaning stations, cockpit tables, life preservers, life ring buoys, rigid sails for sailboats, artificial fishing bait and lures, fish ladders, collapsible boats, pontoon and decks, dagger boards and rudders for sailboats, houseboats, boat and ship hulls, lifeboats, sailboards, and the like),
docks (e.g., floating, folding, portable, ramps, composite dock boards and timbers, canopies, covers, shelters, handrail, diving floats, floating storage docks for dry storage of personal watercraft, and the like),
transportation (e.g., automobile components, truck cabs, auto cabs and interiors, recreational vehicle (RV) components, farming equipment, bumper reinforcement, side-impact reinforcement, structural enhancements, safety equipment, boxes, shipping containers, train components, subway components, boxcars, composite railroad ties, motorcycles, scooters, automotive panels, appearance accessories, police vehicle reinforcements, prefab impact units for protection from rear-end impacts and fires, front and rear bumpers, new production vehicles and back-fitting of existing fleets, reinforcing monocouqe body designs, reinforcing cages design and enhancing crumpled zones designs, making the unitized body more rigid, enabling vehicles to withstand higher impacts without losing structural integrity, tire doughnuts, with reinforcements according to the invention inside the tire, between the rim and contact tread surface (enabling a vehicle to come to a safe stop after tire failure or blowout, averting vehicle swerving, lane crossover, and rollover, and eliminating the need for a spare tire), sun visors, steering wheels, collapsible armrests, wheel covers, running boards, thermal and acoustical automotive insulation for firewall, roof, hoods, doors, floorboards, occupant interior cab impact absorbers, pillars, door panels, roof, dashboard, backside of front seats, seat frames, lined rear fender inside panels with invention materials, trunk lid and floor, backseat anchor panel, around gas tank to help stop frame point anchor penetration ruptures and fires and absorb the energy caused from rear end collisions to the vehicle, side impacts, side intrusions, truck and vehicle bumpers, automotive and commercial, industrial equipment, cab bodies, floor mats, railroad cars, car stops and chocks, armored cars and trucks, custom trailers, vans, vehicles, dashboards, aircraft, boats, ships, ship hole dick covers, auto and boat battery cases, cable gondola cars, moving vans, and the like),
environmental/wastewater treatment (e.g., temporary and portable secondary spill containment systems for hazardous material accidents and decontamination material containment systems, floating tank tops, floating sewage lagoon covers, modular tanks, flumes, sluice gates, weir gates, stop logs, floating decanters, oil spill booms, spill basins and pans, cesspools, cisterns and covers, chutes, cooling vats, digester tanks, wind tunnels, field erected storage tanks, fish farming tanks, fishponds, floats for oil spill recovery systems, lagoon liners, landfill liners, oil spill recovery systems, solar collector panels, and the like),
medical/healthcare (e.g., casts, fittings, casings for medical equipment, orthopedic devices, prosthetics, disposable splints, furniture, and the like), and so on.

Presently preferred applications of invention methods and articles produced thereby include preparation of building panels, structural reinforcements, soundproofing, insulation, waterproofing, countertops, swimming pools, swimming pool covers, surfboards, hot tubs, hot tub covers, cooling towers, bathtubs, shower units, storage tanks, automotive components, personal watercraft components, and the like.

In accordance with additional embodiments of the present invention, the above- described articles can be further modified in a variety of ways, depending upon the end use. For example, a fireproof coating, a non-slip coating, a wood facing, an acrylic layer, a woven fabric facing, or the like, can be applied thereto (see, for example, FIGS. 7, 8 and 9). The article can be formed into a predetermined shape, or the article can be subjected to sufficient compression energy to reduce the thickness thereof. Desirable shapes can be cut and/or drilled into the article, the article can be ground up for total recycling, sanded, planed, shaped, drilled, compressed, routed, or the like.

In accordance with still another embodiment of the present invention, there are provided articles produced by any of the above-described methods.

In accordance with a still further embodiment of the present invention, there are provided methods of making structural and other composite materials having enhanced properties, including a compression modulus of at least 20,000 psi, and a flexural modulus in the range of about 10,000 psi up to about 14,000 psi, the method comprising:
combining porous material with a gas-generating polymerizable component to produce a pre-polymerization mix,
subjecting the pre-polymerization mix to conditions suitable to allow the gas- generating polymerizable component to polymerize, thereby producing a cured article, and thereafter
subjecting the cured article to compression pressure in the range of about 5-10, 10-40, 40-80, 80-100, 100-400, 400-800, 800-1600, 1600-3000, 3000-5000 or 5000-10,000 psi or higher for a time sufficient for the article to achieve the desired physical properties.

Those of skill in the art can readily determine conditions suitable to allow the gas- generating polymerizable component to polymerize. The conditions selected depend upon the type of polymerizable component employed. Polyurethanes, for example, once the various components of a polyurethane resin are combined, will typically initiate cure at relatively mild temperatures (i.e., in the range of about room temperature (about 25° C.) up to about 70° C.).

In accordance with yet another embodiment of the present invention, there are provided methods of making structural and other composite materials having a compression modulus of at least 20,000 psi, and a flexural modulus in the range of about 10,000 psi up to about 14,000 psi, the method comprising:
subjecting a pre-polymerization mix comprising particulate material, at least a portion of which is porous, and a foamable polymerizable component to conditions suitable to allow the foamable polymerizable component to polymerize, thereby producing a cured article, and thereafter
subjecting the cured article to compression pressure in the range of about 5-10, 10-40, 40-80, 80-100, 100-400, 400-800, 800-1600, 1600-3000, 3000-5000 or 5000-10,000 psi or higher for a time sufficient for the article to achieve the desired physical properties.

In accordance with still another embodiment of the present invention, there are provided methods of making structural and other composite materials having a compression modulus of at least 20,000 psi, and a flexural modulus in the range of about 10,000 psi up to about 14,000 psi, the method comprising:
subjecting the cured article to compression pressure in the range of about 5-10, 10-40, 40-80, 80-100, 100-400, 400-800, 800-1600, 1600-3000, 3000-5000 or 5000-10,000 psi or higher for a time sufficient for the article to achieve the desired physical properties,
wherein the cured article is prepared by subjecting a pre-polymerization mix comprising particulate material, at least a portion of which is porous, and a foamable polymerizable component to conditions suitable to allow the foamable polymerizable component to polymerize, thereby producing the cured article.

The invention will now be described in greater detail with reference to the following non-limiting examples.

### EXAMPLE 1

Several polyurethane formulations were prepared for blending with porous material in accordance with the present invention. For each formulation, all ingredients (of each component) were introduced into a closed system mixing pot, then blended under constant agitation for 1 to 2 hours, depending on the batch size. No heating was required to carry out the curing process.

Formulation 1 (BLACK/Fire Retardant)
Wt. % Range

| Component A - Isocyanate: | |
|---|---|
| Diphenylmethane Diisocyanate (Polymeric MDI) | 88.5-94.5 |
| Trichloropropylphosphate (Fire Retardant) | 5.5-11.5 |
| Component B - Polyol: | |
| Polyether Polyol (Sucrose/Glycol Blend), | 73.1-93.4 |
| Hydroxyl # 375 to 400 | |
| Polyol Polyether Diol, Hydroxyl # 265 | 8.4-12.5 |
| Tertiary Amine (Catalyst) | 0.1-2.50 |
| Dimethylethanol Amine (DMEA) (Catalyst) | 0.35-1.2 |
| Water (Blowing Agent) | 0.4-1.5 |
| Silicone Surfactant | 0.08-2.2 |
| Black Pigment (in Polyether Polyol dispersion) | 0.3-1.5 |

Formulation 2 (WHITE)
Wt. % Range

| Component A - Isocyanate: | |
|---|---|
| Modified Monomeric MDI | 100.00 |
| Component B - Polyol: | |
| Polyether Polyol (Sucrose/Glycol Blend) PO Tip, | 82.5-91.5 |
| Hydroxyl # 375 to 400 | |
| Polyol Polyether Triol, Hydroxyl #250 | 5.5-13.5 |
| Silicone Surfactant | 0.08-1.5 |
| Dimethylethanol Amine (DMEA) (Catalyst) | 0.35-1.0 |
| Water | 0.20-1.3 |
| Tertiary Amine (Catalyst) | 0.25-1.2 |
| Organo Surfactant (9 to 10 Mol) | 0.35-0.7 |

Formulation 3 (NATURAL COLOR)
Wt. % Range

| Component A - Isocyanate: | |
|---|---|
| Diphenylmethane Diisocyanate (Polymeric MDI) | 100.00 |
| Component B - Polyol: | |
| Sucrose Amine, Hydroxyl # 350 | 30.5-42.0 |
| Sucrose Amine, Hydroxyl # 530 | 45.0-60.0 |
| Amine Polyol, Hydroxyl # 600 | 2.8-9.0 |
| Water | 0.20-1.3 |
| Silicone Surfactant | 0.35-0.7 |

Formulation 4
Wt. % Range

| Component A - Isocyanate: | |
|---|---|
| Diphenylmethane Diisocyanate (Polymeric MDI) | 100.00 |
| Component B - Polyol: | |
| Aromatic Polyol, Hydroxyl # 350 | 37.0-60.0 |
| Polyether Polyol (Sucrose/Glycol Blend), Hydroxyl # 370 | 60.0-35.0 |
| DEG (Diethylene Glycol) | 1.5-4.0 |
| Silicone Surfactant | 0.08-1.5 |
| Dimethylethanol Amine (DMEA) (Catalyst) | 0.35-1.0 |
| 245(a) HCFC (Blowing Agent) | 0.4-1.5 |
| Water | 0.4-1.5 |

Formulation 5 (One Component Formulation):
Wt. % Range

| | |
|---|---|
| Polyol Polyether Triol, Hydroxyl #34 | 40.0-50.0 |
| Diphenylmethane Diisocyanate (Polymeric MDI) | 40.0-50.0 |
| Plasticizer | 0.00-20.0 |
| Diamine Catalyst | 0.01-0.2 |

### EXAMPLE 2

### Performance Properties

Several polymer systems useful in the practice of the present invention were prepared and the performance properties thereof evaluated, as summarized herein.

Formulation 1 described in Example 1 was used to produce a two component, rigid, water blown polyurethane structural material. This material provides superior performance for applications requiring a hard or tough surface, and is a cost-effective replacement for wood, thereby finding use in a variety of industries such as the furniture industry (e.g., for manufacture of furniture, cabinetry, and the like) and the picture frame business. Parts can be easily molded out of urethane materials that would otherwise require labor intensive carving or lathing. Typical physical properties of the cured material are presented in Table 1.

TABLE 1
TYPICAL PHYSICAL PROPERTIES

| | TEST | | |
|---|---|---|---|
| | METHOD | Component A | Component B |
| (For Components) | | | |
| Viscosity, cps | ASTM D-2393 | 100-200 | 1000-1400 |
| Brookfield LVF, | | | |
| Spindle #2 @ 12 rpm | | | |
| Specific gravity | ASTM D-1638 | 1.2 | 1.04 |
| Weight/gal. lb | | 10.0 | 8.68 |
| Mix ratioby weight | 52 | 48 | |
| Mix ratioby volume | 50 | 50 | |

| | |
|---|---|
| (For Cured Material) | |
| Density, lbs./ft.³ | 10 (other densities |
| | also available) |

The cream time of the formulation was about 30 to about 60 seconds, and can be modified by adjusting process conditions or through the use of additives. The rise time was about 2 to about 4 minutes, and can be modified by adjusting process conditions or through the use of additives. The shelf or storage life of Component A (isocyanate) and Component B (resin) can be maximized by maintaining the materials at a temperature of from about 65° F. to about 85° F. Protection from moisture and foreign material is afforded by keeping storage containers tightly closed.

Formulation 2 described in Example 1 (IPS 3001-10LV) is a two-component rigid, water blown polyurethane structural material. This material also provides superior performance for applications requiring a hard or tough surface and can be used as a cost- effective replacement for wood. Parts can be easily molded out of urethane-based materials that otherwise would require labor intensive carving or lathing. Typical physical properties thereof are summarized in Table 2.

TABLE 2
TYPICAL PHYSICAL PROPERTIES

| | TEST METHOD | Component A | Component B |
|---|---|---|---|
| (For Components) | | | |
| Viscosity, cps | ASTM D-2393 | 200-300 | 2400-2600 |
| Brookfield LVF, | | | |
| Spindle #2 @ | | | |
| 12 rpm | | | |
| Specific gravity | ASTM D-1638 | 1.2 | 1.04 |
| Weight/gal. (Lbs.) | | 10.0 | 8.68 |
| Mix ratioby weight | 52 | 48 | |
| (For Cured | | | |
| Material) | | | |
| Density, Lbs./ft³. | 35-40 | | |
| Shore D hardness | 10 | | |

The mixture can be hand mixed with a jiffy mixer (3″ diameter) at 1,200 rpm. The cream time of the formulation was about 180 seconds, and can be modified by adjusting process conditions or through the use of additives. The rise time was about 60 to about 70 minutes, and can be modified by adjusting process conditions or through the use of additives. The shelf or storage life of Component A (isocyanate) and Component B (resin) can be maximized by maintaining the materials at a temperature of from about 65° F. to about 85° F. Protection from moisture and foreign material is afforded by keeping storage containers tightly closed.

Formulation 3 described in Example 1 is a two component, rigid, water blown polyurethane structural material. This material also provides superior performance for applications requiring a hard or tough surface, and can also be used as a cost-effective replacement for wood. Parts can be easily molded out of urethane materials that would otherwise require labor intensive carving or lathing. Typical physical properties thereof are summarized in Table 3.

TABLE 3
TYPICAL PHYSICAL PROPERTIES

| | TEST | | |
|---|---|---|---|
| | METHOD | Component A | Component B |
| (For Components) | | | |
| Viscosity, cps | ASTM D-2393 | 100-200 | 1000-1400 |
| Brookfield LVF, | | | |
| Spindle #2 @ 12 rpm | | | |
| Specific gravity | ASTM D-1638 | 1.2 | 1.04 |
| Weight/gal. lb | | 10.0 | 8.68 |
| Mix ratioby weight | 52 | 48 | |
| Mix ratioby volume | 50 | 50 | |

| | |
|---|---|
| (for cured material) | |
| Density, lbs./ft.³ | 10 (other densities also |
| | available) |

The cream time of the formulation was about 4 seconds, and can be modified by adjusting process conditions or through the use of additives. The rise time was about 14 minutes, and can be modified by adjusting process conditions or through the use of additives. The shelf or storage life of Component A (isocyanate) and Component B (resin) can be maximized by maintaining the materials at a temperature of from about 65° F. to about 85° F. Protection from moisture and foreign material is afforded by keeping storage containers tightly closed. Fire retardant can be added to the formulation.

### EXAMPLE 3

### Making an Exemplary PetriFoam™ Material

As discussed above, the proportion of ingredients in the reaction mixture depends upon the desired physical characteristics of the end product and hence can not be specified in detail without identifying the final application of the material.

Invention process can be carried out in both batch and continuous mode. Batch mode can be carried out as follows. An amount of porous particulate material (e.g., expanded polystyrene beads (or other particles), or polyethylene beads (or other particles), or polypropylene beads (or other particles), or mixtures of any two or more thereof) sufficient to overcharge the mold volume by ten to twenty percent is placed in a mixing vat. A resin (e.g., isocyanate reagent) is mixed into the beads (or other particles) with agitation until each individual bead (or other particle) has been substantially coated with the resin. The macroglycol (curing) reagent is then added to the resin/bead mixture and mixing is continued until the glycol has been evenly distributed throughout the mixture. The polymerization reaction commences with the first addition of the glycol. Preferably, the material is moved to the awaiting mold, which has been coated with a suitable release agent, in an expeditious fashion to assure sufficient working time for filling all parts of the mold uniformly. After the mold is filled, it is closed to assure compression of the mixture as the polyurethane mixture generates gas. The mold can be opened after about 10 up to about 30 minutes, depending upon nature of the mixture and the article or material prepared. The process can then be repeated to prepare additional articles or material. An article is generally fully cured to final physical characteristics after about twenty-four hours. The curing process can be accelerated by adding supplemental heat to the forms and/or the liquid components.

When using the one component formulation, the procedure is substantially the same up to the point where the resin has been mixed with the porous particulate material. At that point, a stoichiometric amount of water (to effect cure) is sprayed into the agitated mix, the final mixture is added to the mold as described previously, and the mold is closed with compression.

Preparation of invention materials in continuous mode can be carried out as follows. One or more storage tanks are provided containing porous particulate material, one or more tanks are provided containing the components of the gas-generating polymerizable component, and one or more tanks are provided containing any other components to be incorporated into the finished article. Each of these components are metered and fed to a mixer extruder, either in a single mixing step or in stages (e.g., the isocyanate precursor of a polyurethane resin can be blended with suitable porous particulate material, then polyol subsequently added thereto). The mixed blend of components is then delivered to the site where formation of invention material is desired.

### EXAMPLE 4

### Performance Properties of Invention Structural Materials

Structural materials prepared according to the invention were subjected to a variety of tests to determine the physical properties thereof, as summarized in Table 4. The material was prepared using expanded polystyrene beads having a diameter of 1.5 mm and an IPS urethane mixture (50 wt. %/50 wt. %) with carbon black and fire retardant added. The beads were added to the mold at an excess (115% of the volume of the mold). These tests were conducted in accordance with American Society for Testing and Materials (ASTM) standards to determine the strength and performance of PetriFoam™ brand structural materials in terms of compression, flex, strain and shear. Additionally, PetriFoam™ brand structural materials were evaluated for performance characteristics relating to thermal conductivity, water resistance, peel strength, fatigue resistance, impact resistance and sound attenuation.

TABLE 4

| TESTS | STANDARD | PROPERTIES |
|---|---|---|
| Compression Strength | ASTM 1621 | 175 |
| (Yield), psi | | |
| Compression Strength | ASTM 1621 | 210 |
| (10% Strain), psi | | |
| Compression Modulus, | ASTM 1621 | 8600 |
| psi | | |
| Flexural Modulus, psi | ASTM 790 | 10,000-14,000 |
| Flexural Strength, psi | ASTM 790 | 350-375 |
| Strain to Failure, % | ASTM 790 | 4 |
| Shear Modulus, psi | NFT 56118 | 3185 |
| Poisson's Ratio | | 0.35 |
| Density (lb/ft³) | | 10.5 |
| Thermal Conductivity* | By Fourier | 0.037 |
| | Law | |
| % Water Absorption in | 0 | 0 |
| 24 Hours* | | |
| Peel Strength* | | Superior |
| Fatigue Resistance* | | Superior |
| Impact Resistance* | | Superior |
| Sound Attenuation* | | Superior |

*Estimate based upon other testing

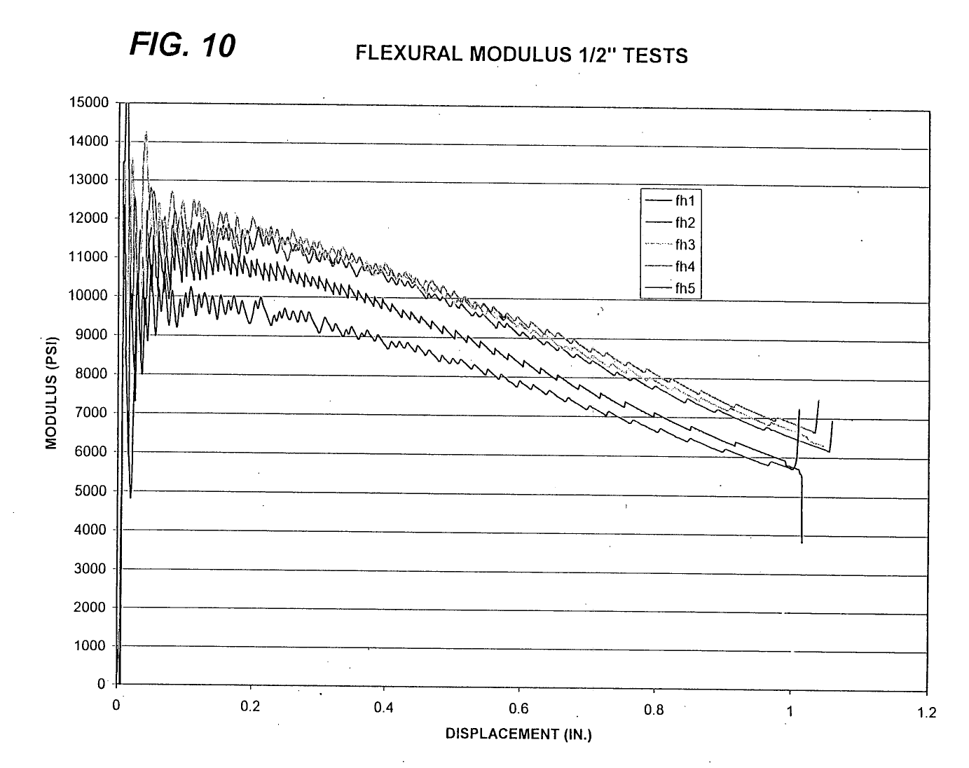

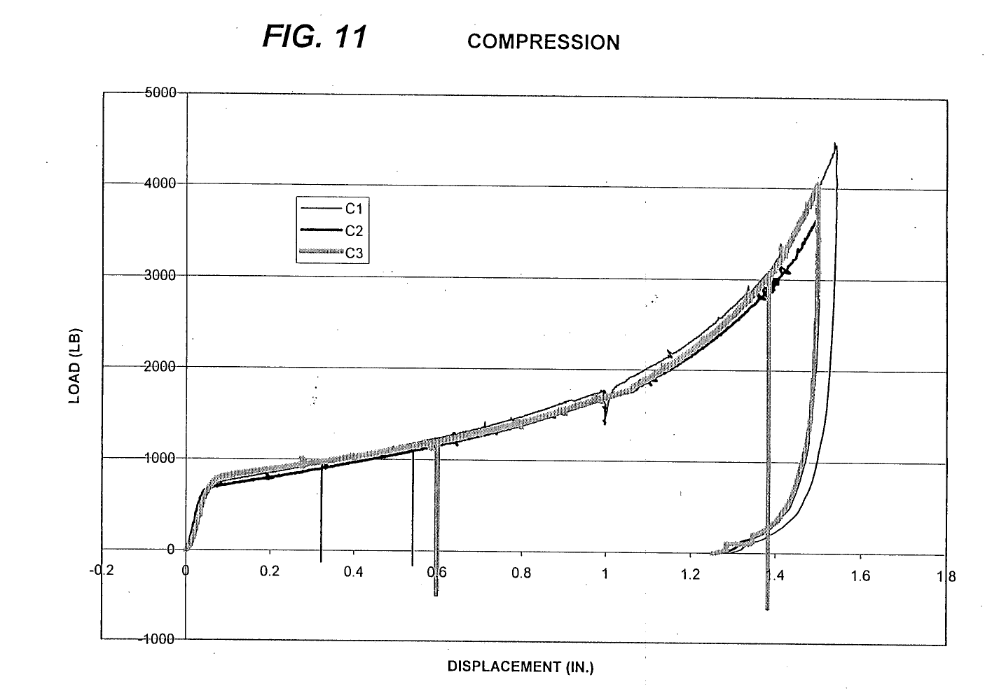

The test results presented in Table 4, and the flexural modulus and compression test results presented in FIGS. 10 and 11 demonstrate that PetriFoam™ brand structural materials possess superior performance characteristics and properties. The primary tests conducted included ASTM 1621, “Compression Testing of Rigid Cellular Plastics”; and ASTM 790, “Standard Test Methods for Flexural Properties of Unreinforced Plastics and Electrical Insulation.” These tests show that PetriFoam™ brand structural materials have many times the compressive strength and flexural strength of most polyurethane foams and styrofoams. Typical polyurethane foams have a compressive strength in the range of 40 psi to 100 psi, while typical styrofoams have a compressive strength in the range of 5 psi to 30 psi. As demonstrated by the data provided herein, PetriFoam™ brand structural materials can be made to exhibit conclusively superior materials that can deliver exponentially greater strength characteristics than conventional materials.

### EXAMPLE 5

### Preparation of Structural Panels

Structural panels were prepared that were configured to be employed with standards, rails, channel, and other steel parts that provide the rigid framework to carry a fabric or other decoratively covered office panel. Conventional panels are constructed out of wood or particleboard and both surfaces are covered with MASONITE®, which is finished with padding and fabric or other decorative material, depending upon model and office decor. Assembling all the parts is labor intensive and very expensive. Also, shipping is expensive since the finished panels are quite heavy. Any water immersion of the panel, such as by normal floor mopping, causes the particleboard to swell and degrade. Panels prepared from materials according to the preferred embodiments exhibit superior water resistance, weigh less, and can be inserted into conventional frames using conventional fasteners.

A mold was fabricated with suitable inside dimensions using one inch Douglas Fir plywood as the base, two inch angle iron welded in the corners for the sides and four pieces of 1′2′ steel plate hinged on the one long dimension of the angle iron to make the top side of the mold. The free sides of the top sections were configured to be bolted down against the opposing angle iron to keep the material mixture placed within constrained as it polymerized, expanded, and cured. The form was filled to the top with expanded polystyrene beads, and then a small quantity of additional beads was added. The beads were then transferred to a container and mixed with Part A of a urethane using a substantial mixer (a mixer similar to that used to mix mud for finishing interior walls) until the beads were thoroughly wetted with the resin. Part B of the urethane was then added, and the resulting mixture was mixed for two minutes. The formula used was 48% Part A with 52% Part B by weight of the mixture (corresponding to 37 oz beads, 100 oz A and 115 oz B). Three panels were prepared.

### EXAMPLE 6

### Use of Surfacing Materials

A mold was fabricated with inside dimensions of 12″×12″×2.″ The top and bottom were one inch thick Douglas Fir plywood approximately 18″ square, with sides comprising 2″×2″ stock prepared from cut down 2″×4″ stock. Twelve ⅜″ inch bolts with washers, top and bottom, through the bottom, sides, and top at the four corners and midpoints of the sides, were used to secure the top and constrain the expanding mixture. Spacers were cut from thin plywood 12″ square, which were placed in the mold to vary the thickness of the final product: 2″, 1″, and ½″. SC Johnson® Paste Wax was employed as the form release agent.

Various surface materials were placed in the mold before adding the mixture. Superior adhesion of the covering material to the body of the material was observed for all coverings tested, including acrylic, wood veneer, KEVLAR™, and metal mesh. Half-inch material covered with impregnated KEVLAR™ was exceedingly strong and resistant to torsion. The materials also readily accept fiberglass-type gel coat to yield a beautiful surface with a minimum number of coats, especially on a fully skinned sample.

### EXAMPLE 7

### Effects of Bead Size and Incorporation of Surface Materials

Different bead sizes and varying amounts of resin were tested to affect different final weights of the sample board. The proportions of the A and B components were maintained relatively constant at their optimized proportions. Quantitative studies indicate that the smaller the bead size, the stronger the board. Also, increasing the proportion of the total resin regardless of bead size strengthens the board.

Cure times to opening the mold were relatively constant and at two-inch thickness or less, and the heat generated by the exothermic polymerization reaction hardly warmed the exterior of the wooden mold.

### EXAMPLE 8

### Effects of Bead Size and Incorporation of Surface Materials

A 8″×9″×9″ mold was prepared. The mold included a one inch thick spacer on the inside of the top to allow for ease in placing 110 vol. % or more of the fill in the mold, the optimum amount depending upon bead size and subsequent compression of the mixture. The superior insulation characteristic of the material and the heat generated by the exothermic polymerization reaction caused the “cure until opening time” to exceed an hour or more. If opened prematurely, the material was hot, spongy, and not dimensionally stable. Therefore, the greater the thickness of the shortest dimension of the material required for an application, the preferably slower the production of the material.

To prepare a 9″×9″×7″ block of material, 110% by volume of beads is added to the mold, along with 21 oz of urethane Part A and 20 oz of urethane Part B. The resulting block is fully skinned, which results in increased torsional and compression strength.

### EXAMPLE 9

### Preparation of Exemplary Composites Based on Porous Materials Comprising Interpenetrating Polymer Networks and Copolymers

Exemplary porous materials contemplated for use in the practice of the present invention include, among other materials, polyolefin beads comprising, e.g., polyethylene, polypropylene, polystyrene, and the like, as well as copolymers, mixtures and other combinations thereof. By varying aspects and proportions of the porous materials, one can readily generate composites exhibiting a range of structural, performance and other properties as desired for a particular application.

As illustrative examples of the use of porous materials comprising interpenetrating polymer networks (IPNs) and copolymers, and of the use of such materials to generate a variety of composites, beads which are formed as an interpenetrating network of polymers (one of which is itself a copolymer) were incorporated into a range of formulations. A variety of copolymer-based, IPN-based, SIPN-based and other beads are commercially available. For this example, beads formed as an IPN of a first polymer which is polystyrene (PS) and a second polymer which is an ethylene vinyl acetate copolymer (EVAC) in a ratio of approximately 70:30 (PS:EVAC), and having a density of approximately 2.17 pounds per cubic foot or 0.035 grams per cubic centimeter (available, for example, as “Arcel” beads from Nova Chemical, Moon Township, Pa.) were employed. The average bead size used was approximately 2 to 3 mm. The “A” component of the polymer used for the polymer matrix in this example comprised 4,4-Diphenylmethane Diisocyanate (polymeric “MDI”) and higher oligomers of MDI available as “‘A’ Component Polymeric Isocyanate” from Innovative Polymer Systems, Inc. (“IPS”) of Ontario, Calif. The “B” component of the polymer used for this example comprised Hydroxyl Terminated Poly (Oxyalkylene) Polyether (“polyether polyol”) available as “Rigid ‘B’ Component” from IPS.

As described herein, by varying the relative proportions of porous material and polymerizable components, one can readily generate a range of composite materials exhibiting various combinations of desirable attributes for particular applications. In this example for purposes of illustration, by varying the proportions of PS:EVAC beads (having a density of approximately 0.035 g/cm³) and the polyurethane (PUR) components A and B (having densities of approximately 1.2 and 1.07 g/cm³, respectively), a set of five illustrative materials (referred to as 9A, 9B, 9C, 9D and 9E in the text and tables below) was generated. Blocks of the material were prepared by mixing the PS:EVAC beads with polymer component A until the beads were fairly uniformly coated with the prepolymer, and subsequently introducing polymer component B, mixing for approximately one to two minutes, and then introducing the mixture into a mold which had been pre-treated with a release agent (such as a Carnauba wax). After the mold was closed and clamped using a hydraulic press, it was allowed to substantially cure over approximately fifteen to twenty minutes.

Any given combination of porous material and polymerizable component can be used to produce a variety of different composite products by varying, inter alia, the weight percent and/or volume percent of the porous material within the polymer. By way of illustration, the materials referred to as 9A through 9E in Table 5 comprised varying combinations of the PS:EVAC beads and PUR components, as shown below.

TABLE 5

| | Component | | | |
|---|---|---|---|---|
| | Weights (g): | | | |
| | porous material | Approx. | Approx. | Calculated |
| | (PS:EVAC) | Weight % of | Volume % of | Density of |
| | polymer A (PUR A) | Porous | Porous | Composite |
| Material | polymer B (PUR B) | Material | Material | (g/cm³) |
| 9A | 105.7 | 20.4 | 89.2 | 0.181 |
| | 219.46 | | | |
| | 193.2 | | | |
| 9B | 237 | 43.4 | 96.1 | 0.207 |
| | 164.6 | | | |
| | 144.9 | | | |
| 9C | 118.9 | 27.8 | 92.6 | 0.156 |
| | 164.6 | | | |
| | 144.9 | | | |
| 9D | 118.9 | 45.5 | 96.5 | 0.098 |
| | 75.8 | | | |
| | 66.6 | | | |
| 9E | 118.9 | 62.6 | 98.2 | 0.072 |
| | 37.9 | | | |
| | 33 | | | |

Testing of the resulting materials demonstrated that by varying basic components as described above, the resulting composites exhibited a range of properties making them particularly suitable and readily adaptable to a variety of different applications.

TABLE 6

| | Test | Material | Material | Material | Material | Material |
|---|---|---|---|---|---|---|
| Property | (ASTM) | 9A | 9B | 9C | 9D | 9E |
| Compression | D1621 | 326 | 289 | 217 | 138 | 83 |
| Strength Yield | | | | | | |
| (psi) | | | | | | |
| Compression | D1621 | 367 | 338 | 250 | 158 | 92 |
| Strength 13% | | | | | | |
| (psi) | | | | | | |
| Compression | D1621 | 5250 | 9310 | 6330 | 4510 | 2270 |
| Modulus (psi) | | | | | | |
| Shear Strength | C273- | 166 | 242 | 195 | 162 | 60 |
| (psi) | 00 | | | | | |
| Shear Modulus | C273- | 5640 | 7230 | 6430 | 8900 | 4700 |
| (psi) | 00 | | | | | |
| Tensile Strength | D1623- | 648 | 1366 | 876 | 669 | 307 |
| (ultimate load | 02 | | | | | |
| lbs) | | | | | | |
| Tensile Strength | D1623- | 163 | 346 | 222 | 168 | 78 |
| (psi) | 02 | | | | | |
| Thermal | C518 | 0.0278 | 0.0219 | 0.0259 | 0.0237 | 0.0217 |
| Conductivity | | | | | | |
| (Btu/hr ft ° F.) | | | | | | |
| R Value @ 1″ | C518 | 3 | 3.8 | 3.22 | 3.51 | 3.84 |
| thickness | | | | | | |
| (hr ft² ° F./Btu) | | | | | | |
| Density of | C271 | 11.33 | 12.92 | 9.76 | 6.15 | 4.5 |
| Sample | | | | | | |
| (lb/ft³) | | | | | | |

### EXAMPLE 10

### Preparation of Exemplary Laminated Structures

Invention processes and materials can readily be applied to the preparation of laminated materials. In a preferred aspect of the preparation of laminated materials, one or more layers or lamina of a facing material that is desired to be applied to a structural form or core can be bonded directly to the core in a convenient process involving relatively simultaneous core polymerization and lamination. In such a process, the laminate can be bonded to the core as the core is polymerizing or following polymerization, allowing these steps to be conveniently accomplished together during processing. By way of example, composite materials of the present invention can be prepared in a mold or other container in which a lamina has been placed. It has been found that by placing composite material precursors into the mold and allowing the polymerization process to proceed in apposition to the lamina, strong bonding of the lamina to a structural core can be achieved in a very convenient process.

The ability of invention composite materials to exhibit high shear strengths can be particularly advantageous in the case of “sandwich” laminates. Without wishing to be bound by theory, it is believed that the composite material can effectively act as a relatively stiff and shear resistant core that can greatly improve the flexural stiffness of the overall structure by serving as a shear web between one surface or skin which is subjected to compression and the opposing surface or skin which is subjected to tension. Such properties are believed to contribute to structures having superior structural performance properties in a number of different applications. Additional stiffness and shear strength can be achieved by varying the composite material as described herein and/or by incorporating additional reinforcement structures such as honeycombs or other lattices within the core. By using at least partially open cell lattices, composite material of the present invention may be incorporated into open cells on the surface of the lattice, providing additional integrity to the lattice cell walls, as well as additional surface area for binding to any skin, lamina or coating material that is applied thereto.

As an illustration of the ability of composite materials of the present invention to be bonded to exemplary laminates such as may be useful in components of houses and other structures, the ability of a composite to be adhered to a lamina comprising vinyl, was examined, and the ability of the polymerizable component used to prepare the composite to also serve as an adhesive to bind a lamina to a pre-formed composite material was tested. As an exemplary structure, blocks or structural cores of a composite based on a PS:EVAC IPN (Arcel beads having a density of approximately 2.17 pounds per cubic foot) and polyurethane, mixed in a ratio of 5.57 ounces of beads to 11.58 ounces of “A” and 10.21 ounces of “B”, were prepared, essentially as described above in Example 9 above. As an illustrative lamina to be bound, Revere brand vinyl siding, (which is formed from rigid polyvinyl chloride and is commercially available from Gentek Building Products, Inc. of Woodbridge, N.J. (“Gentek”)) was used. The vinyl lamina was bound to the structural core using the polyurethane system used to prepare the composite or one of three commercially available glues that are purported to be of superior adhering capability: Elmer's “Ultimate Glue”, Liquid Nails “Perfect Glue” or “Gorilla Glue”. After drying each of the samples and then attempting to delaminate the samples by prying of the vinyl lamina, it was found that while all of the glues were effective in binding the lamina to the structural core, the polyurethane system provided substantially stronger bonding than any of the others. The resulting laminated structure was able to be cut with a band saw without causing significant delamination along the cut line.

As an example of simultaneous polymerization and lamination, composite material precursors as described above were prepared and the polymerization reaction carried out in a mold in which a sheet of the vinyl lamina had been placed. When the resulting laminated composite structure was examined by stress testing designed to delaminate the structure, it was found that the integrity of the laminate was even greater following simultaneous polymerization and lamination than the structure obtained by binding the lamina to a core using the polyurethane system as described above.

As additional examples of laminated structural panels that can readily be prepared using simultaneous polymerization and lamination of composites as described herein, composite material precursors as described above were prepared and the polymerization reaction carried out in molds in which a layer of sheet rock (available from general building supply stores) had been placed on one face of the mold, and in which a variety of different lamina used in the housing and other industries were placed on the opposing surface of the composite precursor material to form sandwich structures of varying sorts. The laminas used included vinyl siding (as described above), as well as Revere aluminum siding and steel siding (both available from Gentek). Following on the preceding observations, vinyl lamina were quite effectively bound to such structures but other laminas including aluminum and steel were also very effectively and conveniently bound. Stress testing of the resulting materials revealed that they were strong and lightweight, and were also highly resistant to delamination. As described herein and in the art, a large variety of surface materials are available that can be used for particular applications. In addition to being used to provide desirable surfaces for resistance to environmental conditions and stresses, facilitating use, improving appearance, and the like, such materials can also be used to provide additional strength, thermal insulation, sound dampening, and other potentially desirable performance features. Other materials can be optionally incorporated into or surrounding the structural core to provide similar or additional desirable attributes. By way of illustration, rubber, and the like, can be incorporated to not only alter performance properties of the structural core but to provide additional sound dampening for example. A number of different natural and synthetic rubber materials having various attributes are known and available (see, e.g., Science and Technology of Rubber by J E Mark, B Erman and F R Eirich (1994, Academic Press); and Rubber Technology by Maurice Morton (1987, Von Nostrand).

In cases in which further enhancement of binding is desired between a layer of material to be bound and a composite core of the present invention, this can be accomplished in a variety of ways, including, for example, physically and/or chemically etching the surface of the material to be bound (or the composite core if already formed), or by modifying either the surface material to be bound or the composite core to contain one or more reactive groups that can form a chemical linkage with one or more groups provided in the other material, thereby providing a chemical bond between the layers.

### EXAMPLE 11

### Preparation of Exemplary Surfboards Using Invention Materials

As discussed above, invention processes and materials can be readily applied to the preparation of a number of different structures. The ability to develop structures that can combine properties such as superior physical strength with light weight (and optionally other desirable attributes), particularly when using relatively inexpensive input components and employing relatively simple and cost-effective manufacturing processes, opens the way to re- engineer a large variety of commonly used products such as those listed above.

As an illustrative example of a structural product that can be readily re-engineered according to the present invention, surfboards that exhibit superior strength and yet are lightweight are highly desirable. Since surfboards, like many other such composite structures, typically involve laminations placed onto the surface of underlying cores, they present additional technical issues related to the potential for incompatibility between the laminate and the core, which incompatibility can affect both the manufacture of the composite structure as well as the resulting product. In the latter regard, such laminated structures frequently exhibit a sensitivity to dynamic stresses because of differing mechanical, thermal and other properties of the two components (e.g. differing moduli of elasticity, differing coefficients of thermal expansion, etc.), which underscores the significance of being able to tailor the materials (e.g. to exhibit similar or complementary responses to exogenous stresses) and of effective adhesion. By applying the components and methods of the present invention as described and illustrated above, improvements in these aspects can yield composite structures such as surfboards that are easier to produce, better performing and/or more resistant to dynamic failures such as breakage, warpage, dinging or delamination.

Typically a surfboard is manufactured from a relatively lightweight core, such as a core made of polyurethane, polystyrene or polypropylene foam. In molded production, which is commonly used for non-custom boards, virtually identical cores can be produced in molds and generally further machined after formation (e.g. by planing, sanding or other surface smoothing or finishing). One or more surface layers may be applied to form an outer surface or skin on such boards after formation. In an alternative technique, thermoforming can be used to prepare an outer skin, e.g. by blowing a resin in a mold, which is then injected with a core, e.g., by introducing a foamable polyurethane into the interior. Much custom board manufacture still involves individually shaping boards from “blank” cores. The core is typically surrounded by a rigid outer layer, commonly one or more layers of fiberglass, carbon-based fibers or other fibrous material impregnated and applied using a polyester, epoxy or other resin. For simplicity and ease of manufacture, some attempts have been made to eliminate the use of a core; however, providing sufficient integrity to the upper and lower surfaces has generally required application of additional surface material such that the resulting boards have been undesirably heavy.

The upper surface or top deck may have an additional layer or layers relative to the underside to help enhance structural integrity and generally to present a textured surface that provides friction to assist the rider in maintaining position. The underside is generally designed to present a smooth surface to facilitate gliding in water. Cores are sometimes constructed of two longitudinal halves joined along their center by a stringer, traditionally made of wood. Although boards based on fiberglass coated foams are lighter and can be stronger than earlier boards, they are still relatively labor intensive to produce, are expensive, and remain subject to a number of stresses that can lead to board surface dings, deterioration, delamination and failure. Besides weather and dynamic stresses associated with handling and use, surfboards are also frequently subjected to relatively high unit surface pressures, which may be concentrated in a fairly small area by a surfer's knees for example. Handling these pressures by further strengthening of the top deck generally results in boards that are more durable but at the same time heavier.

A large variety of materials and processing techniques have been applied to addressing several issues that substantially impact surfboard manufacture, particularly the challenges inherent in producing boards that are simultaneously lightweight, durable and strong. In addition, in order to readily accommodate a variety of surfboard shapes and designs suited to particular conditions, means have been sought for producing custom or other specially designed boards at reduced expense. These and other issues have been described in the art, see, e.g., U.S. Pat. Nos. 4,753,836, 4,798,549, 4,961,715, 4,964,825, 5,234,638, 5,514,017, 6,394,864, 6,623,323 and references cited therein. As discussed above, an additional problem associated with laminated composite structures is the tendency of layers of different materials to react differently to various mechanical, thermal and other stresses, which can result in delamination. This problem has likewise affected surfboards, see e.g., U.S. Pat. No. 5,647,784. As will be appreciated by those of skill in the art, the ability to employ a composite material as described herein that provides substantial strength at light weight, that is resistant to delamination, and is readily adaptable to a large variety of different production techniques offers a significant advance.

Since invention materials can be readily prepared to adhere to each other, as described above, the process of prototype design and testing can be greatly facilitated; and can be performed without the need and expense of relying on special molds for prototyping. For example, a surfboard prototype can be readily prepared from blocks of invention materials that are joined to each other. Subsequent shaping and other finishing steps can then be employed to yield a final prototype.

As an initial illustration of the preparation of a surfboard prototype, a porous material comprising an interpenetrating polymer network (IPN) of polystyrene (PS) and an ethylene vinyl acetate copolymer (EVAC), and a polyurethane polymer matrix, was employed to generate a surfboard core structure that is both lightweight and strong. A variety of such copolymer and IPN-based beads are commercially available. For this example, “Arcel” beads (as described above) which comprise an IPN of PS and EVAC a ratio of approximately 70:30, and had a final density of approximately 2.17 pounds per cubic foot were employed. The average bead size was approximately 2 to 3 mm. The “A” and “B” components of the polymer used for this example were as described above for Example 9, except that for this Example the components were mixed in the following ratio (in ounces): 8.76:19.85:17.5 for bead:A:B; and used to prepare fourteen 12″×12″×3″ blocks.

The blocks were prepared by mixing the beads with polymer component A until the beads were fairly uniformly coated with the prepolymer, and subsequently introducing polymer component B and additive, mixing for approximately one to two minutes, and then introducing the mixture into a mold which had been pre-treated with wax as a release agent. After the mold was closed and clamped, it was allowed to remain for approximately two minutes and was then inverted to facilitate distribution of the liquid components around the beads. The material was substantially cured after approximately fifteen minutes.

Since the structure derives significant strength from the use of invention materials, it was possible to further reduce weight and increase buoyancy by removing a substantial portion of the interior of the core. In this illustrative example, about 30% of the interior was removed (by milling in the case of the block-constructed prototype) to generate a board core being only about one half inch thick with trusses running from top to bottom between the pieces. The form of polyurethane polymer used to prepare the blocks was subsequently utilized to join blocks together by applying to the block surfaces to be bound and then clamping the blocks together for a period of time sufficient for the polyurethane to cure (generally becoming relatively dry and hard to the touch after approximately fifteen minutes). After trimming the bound blocks to create the desired overall shape, a polyurethane or other material can also be applied to the surface of the structure to fill any potential voids and facilitate subsequent sanding, painting or other finishing. A variety of such formulations are commonly available. For this example, a two-component water-based aliphatic urethane (available from Innovative Polymer Systems, Inc. (“IPS”) of Ontario, Calif.) was employed. The “A” component of the polymer used for this example was “Aliphatic Polymeric Isocyanate” comprising Dicyclohexylmethane 4,4-Diisocyanate (“hydrogenated MDI”); and the “B” component was “Elastomer ‘B’ Component” comprising Hydroxyl Terminated Poly (Oxyalkylene) Polyether (“polyether polyol”).

As an exemplary laminated structure of the present invention, a fiberglass surface was applied to the above-described surfboard prototype. For this illustration, the core was passivated prior to application of a polyester/styrene resin by applying a spackling compound (comprising water, acrylic copolymer and amorphous silicate and commercially available as Interior/Exterior Lightweight Spackling from Custom Building products) to the surface for such purpose, and then the entire surface of the board was sprayed with the water-based aliphatic urethane as described above. The board was then painted and laminated with fiberglass using one layer of four ounce per square yard material and polyester/styrene resin on the bottom and two layers of the same fiberglass material to form the top deck of the board. The total weight of the finished board was approximately thirteen pounds and its density was approximately 7.2 pounds per cubic feet.

As described and illustrated herein, lighter composite structures can be readily prepared as desired for particular applications by, for example, using a less dense porous material, increasing the volume percentage of the porous material, decreasing the extent of penetration of polymer into the porous material, introducing larger cavities within the composite structure, or combinations thereof. Another approach involves the incorporation of a smaller bead or other lightweight porous particulate that can fill some of the space between larger beads that would otherwise be filled with higher density polymer. By employing other combinations of porous material and polymer matrix, and other coatings or facings, even lighter weight boards can be produced which nevertheless exhibit desirable performance characteristics. In the case of coatings or facings, materials comprising polyamides such as aramid fibers (e.g. Kevlar), and other materials providing strength with little additional weight, can be used to wrap a segment of the composite core (e.g. to create a band running vertically over the upper and/or lower surface of the board), or, when even greater strength is desired, to wrap the entire board. By varying these features as described and illustrated herein, one can readily generate a graded range of structures such as surfboards exhibiting a range of desirable features such as size and shape, weight, flexibility, and the like that make them particularly suited to specific surfing conditions.

The relative ease of prototype construction as illustrated above can be used to facilitate the design and preparation of structures of the present invention (without the need and expense of mold production). Once desirable compositions and structures are thus generated, molds and other devices and techniques designed for large-scale manufacture can be readily employed.

Since surfboards generated using composites of the present invention can be sufficiently strong even with the incorporation of cavities or hollow channels within the surfboard core as described above, they allow for the production of specialty surfboards in which a fixed mass, or a fluid or another movable mass, can be incorporated into one or more cavities or channels within the board. Fixed masses can assist in providing balance and/or handling benefits making them particularly suitable for certain styles of surfing or wave conditions. Moving masses such as fluids can serve as inertial counterweights flowing or redistributing at desired rates to create boards having specifically enhanced performance attributes. The ability to incorporate such fixed or movable masses can be used to promote stability on the board thereby facilitating use by beginners or enhancing stability and/or handling for experts under various conditions.

### EXAMPLE 12

### Preparation of Exemplary Hot Tubs

As described herein, invention processes and materials can be applied to the production of a variety of different sizes and shapes, including for example various weight- bearing containers and other structures that benefit from the incorporation of a lightweight yet strong material. Further benefits obtained from the incorporation of such composite material can include, for example, thermal insulation. While composite material can be used by itself to form rigid containers, in many cases it is desirable to incorporate different interior and/or exterior surfaces of the container to optimize the structure for interactions with, e.g., the contents to be contained or external factors affecting the outside of the structure, respectively. In that regard, the ability to incorporate these composite materials into a variety of different structures (e.g. by lamination), and the ability to form tightly adhering multi- component structures, e.g., by polymerizing and simultaneously bonding the composite material to another material, make it particularly well suited for the manufacture of various multi-component structures, particularly ones in which a rigid but relatively lightweight component is desirable.

Hot tubs serve as one illustration of such multi-component structures. Typically, a hot tub or portable spa comprises a water-impermeable interior surface that is commonly shaped to provide for a number of seating or other internal areas of the spa, and may be textured or otherwise modified to provide a resilient and desired surface for occupants. This interior surface or shell is often extended at the top to form a crowned lip that may serve as the top surface or deck of the spa. The shell is often made of a thermoformable acrylic or other plastic, and may be formed within a female mold, over a male mold or between female and male molds. For example, shells may be manufactured from acrylic or other material applied to the interior of a female mold, frequently with the use of vacuum to promote adherence. After being allowed to harden, the shell is typically removed from the female mold, and is subsequently treated with one or more commonly multiple layers of material designed to provide strength to the structure, such as fiberglass, as described below. Shells may also be manufactured from formable sheets which are heated and applied over a male mold having vacuum capacity to draw the sheet into intimate contact with the mold. As is known in the art, the acrylic or other composition of the shell may further comprise one or more additives such as colorants, color stabilizers, ultraviolet radiation stabilizers, antioxidants, antistatic agents, texturizers, fillers and other materials to modify properties of the shell or enhance its longevity. A variety of polyacrylates, polycarbonates, and various optional additives are known in the art, see, e.g., U.S. Pat. No. 6,692,683 and references cited therein.

After formation, the shell is typically surrounded by a rigid layer or layers designed to provide increased structural integrity. For example, the exterior of the shell may be coated with one or more layers of fiberglass applied with an epoxy or polyester resin. Typically this involves painting or spraying a layer of resin which is then covered with a coating of fiberglass that is pressed into the resin. After curing of one layer, additional layers are typically applied to develop sufficient integrity. This tends to be a relatively time consuming process, which typically requires rolling and other processes to obtain an evenly adhered rigid layer. Another problem is that the application of polyester resin and fiberglass layers typically results in the emission of volatile organic compounds which can pose health hazards to exposed workers. After curing, the tub may be functionally modified, e.g., by cutting desired holes for jets, and the like, for hydropneumatic circulation, and may have hoses and other elements attached to the tub; after which a layer of foam such as a polyurethane may be applied to provide thermal insulation and lock elements in place. The tub typically has equipment to provide for heat, water flow, filtration, controls and other desired functions, and generally also has a rigid bottom or pan applied to provide additional support and to distribute loads. A commonly used material for the bottom layer or pan is an ABS (acrylonitrile-butadiene-styrene) resin, which generally comprises a rigid styrene/acrylonitrile phase in combination with a butadiene elastomer phase. Compatibility between these phases may be enhanced by inclusion of a bridging graft copolymer comprising styrene and acrylonitrile grafted onto butadiene chains. Polyethylenes (PE) and other materials are also sometimes used as spa pans. ABS and other resins for use in spas frequently also comprise one or more additives such as stabilizers, processing agents, flame retardants, and the like. In addition to the bottom layer or pan, other supports may be incorporated into the spa composite structure to provide additional strength and integrity. The tub is generally contained within a frame which may be designed to provide additional structural support but typically just provides support for an external skirt or covering. In many case, to achieve additional insulation, areas between the tub and the frame may be filled with additional insulation, although this can also make the equipment and tub more difficult to repair. These and other issues relevant to hot tub manufacture and use are described in the art; see, e.g., U.S. Pat. Nos. 4,233,694, 4,844,944, 5,199,116, 5,428,849, 5,482,668, 6,349,427 and 6,692,683.

By applying materials and processes of the present invention, one or more rigid layers of composite material can be incorporated into the hot tub design to provide a multi- component structure that is readily manufactured and exhibits significant structural integrity. For example, composites comprising a porous material and polymerizable component as described herein can be employed to form a rigid structural layer surrounding a hot tub shell. Advantageously, the composite material can be designed as described herein to provide both significant structural rigidity as well as thermal insulation and other desirable features. In that regard, the composite may be used to replace a structural foam layer in a hot tub. As with a typical portable spa, the composite material may be conveniently applied to a thermoplastic shell, such as an acrylic shell. The composite material may for example be contained within a female mold which will define the exterior of the composite reinforced shell; and held, and optionally compressed, within the mold for a period of time to allow polymerization of the composite. The thermoplastic or other shell may be formed prior to polymerization or may alternatively be formed coincident with or following polymerization. In the case of a preformed shell such as a preformed acrylic shell commonly used in the industry, the shell may be used as a sort of male mold to contain the composite material in between the shell and an outer female mold. As another alternative, the shell and composite may be formed or contained between a separate male mold and a female mold (e.g. forming a sandwich of male mold-shell-composite-female mold). The shell and composite may also be formed as a single integrated layer; for example, one in which a portion of the composite (e.g. excess polymer matrix) forms a toughened skin of material concentrated in the position of the shell.

The same or a different composite material of the present invention (or another material) may optionally be applied to or placed beneath the bottom of the reinforced shell to serve as a base structure designed to support the hot tub shell without the need for a separate pan or external supports. The shell may contain or be modified to contain one or more reactive groups that may form a chemical linkage with one or more groups provided in the composite material to further enhance binding between the layers. Alternatively or in addition the shell may be modified by physical or chemical etching to further promote adhesion between the layers. The composite may be varied according to any number of parameters (e.g. by varying components, including additives, altering steps in polymerization, etc.) to further enhance properties of the structure. Analogous approaches can be employed for other such structures designed to provide support such as tubs, shower stalls, basins and other standing containers, as well as floating structures, and the like. As will be appreciated by those of skill in the art, a number of potential variations may be employed in connection with these process, and invention processes and materials may be incorporated into any of a variety of structures especially those in which a lightweight rigid layer is desired.

### EXAMPLE 13

### Generation of Composite Materials Exhibiting Varying Degrees of Void Space

As described herein, the ratio of polymer to porous material used can be varied to generate materials exhibiting a range of densities, performance and other features. In addition, compression during preparation can be used to further modify the properties of the resulting composite material. Compression can be accomplished using a number of different techniques in practice, but for this illustrative example was accomplished by overloading the mold with precursor materials and then subjecting to compression within the mold. It is believed that varying the polymer to porous material ratio, and/or varying the extent of compression, can be used to alter the extent of voids per unit volume remaining in the material after polymerization, a feature which can substantially affect the strength and other properties of the resulting material.

As an illustrative example of these features, a range of materials was generated having varying ratios of polyurethane (PUR) polymer with either of two different porous materials. The first sample porous material was expanded polyethylene (EPE) beads having a density of approximately 1.25 pounds per cubic foot (CAS # 9002-88-4, bead size approximately 4 to 6 mm in diameter; available, for example, as “Eperan” beads from Kaneka Texas Corp., Pasadena, Tex.). The second porous material was an expanded bead comprising an interpenetrating polymer network (IPN) of a first polymer which is polystyrene (PS) and a second polymer which is an ethylene vinyl acetate copolymer (EVAC) in a ratio of approximately 70:30 (PS:EVAC), and having a density of approximately 2.17 pounds per cubic foot (bead size approximately 2 to 3 mm in diameter; available, for example, as “Arcel” beads from Nova Chemical, Moon Township, Pa.).

A series of materials was made up with a target of 3.25 lb/ft³ density for purposes of illustration. The two variables changed were the ratio of the expanded beads to the PUR, and the percent compression of the sample. For this example, the changes to the ratio of beads to PUR and the compression were achieved by adding more beads and deducting the appropriate amount of PUR to maintain the target density. The beads were added in volumes corresponding to 100%, 125% or 150% of the final sample volume. For this example, a 3″ deep square foot sample was used so that the 100% baseline would be the volume of beads required to exactly fill a 12″×12″ by 3″ thick (¼ cubic foot) space. In a similar manner, a 125% sample would be 1.25 times the volume of beads required to exactly fill the volume of the final product (i.e. 3.75″ depth of beads for a 3″ sample). In order to keep the density of the product constant (at approximately 3.25 lb/ft³), the equivalent weight of the extra 0.75″ of beads was subtracted from the weight of the PUR. In a similar manner, a 150% sample would be 1.50 times the volume of beads required to exactly fill the volume of the final product (i.e. 4.5″ depth of beads for a 3″ sample), and the equivalent weight of the extra 1.5″ of beads was subtracted from the weight of the PUR. The final products can then be visually or otherwise examined to assess which condition promoted minimization of voids between porous particles and other potentially desirable characteristics.

By way of illustration, a general procedure to generate varying formulations of this sort was as follows, taking the following considerations into account:
(i) a sample size of a 3″ deep square foot was chosen, with a final density of 3.25 lb/ft³; thus, the 3 inch sample would be ¼ of the total weight in I cubic foot, i.e. 0.8125 lbs (368.5 grams);
(ii) using the 1.9 lb/ft³ density expanded polyethylene beads, 0.475 lbs (215.5 grams) would be required to fill 100% of the 12″×12″×3″ mold;
(iii) the total weight of the final material (368.5 grams), minus the weight of the beads (215.5 grams), leaves 153 grams of PUR (A+B);
(iv) CO₂ and other potential matter is generally given off as a by-product; the amount of weight lost can be taken into account as well (previous reactions allowed calculation of a weight ratio for product to starting materials which for these materials was approximately 1.11 (referred to herein as the Weight Loss Factor (WLF)));
(v) for the desired 3″ thick 3.25 lb/ft³ final density material, the amount of polyurethane needed (taking into account the WLF) is 153 grams×1.11 WLF=169.83 gram of PUR (A+B);
(vi) using a percentage of A to B of 52% to 48%, the amounts required are 88.31 grams of A and 81.52 grams of B;
(vii) the final formulation for a 12″×12″ by 3″ thick block of 3.25 lb/ft³ final density material made with 100% mold fill (3″ for a 3″ block) of 1.9 lb/ft³ expanded polyethylene (EPE) is therefore:
   215.5 grams of EPE,
   88.31 grams A and
   81.52 grams of B.

A 12″×12″ by 3″ thick block of 3.25 lb/ft³ final density material made with 125% mold fill (3.75″ for a 3″ block) of 1.9 lb/ft³ expanded polyethylene (EPE) requires 215.5×1.25=269.4 grams of EPE. In order to keep the same density of 3.25 lb/ft³, 53.9 grams of PUR (269.4−215.5) must be subtracted from the formulation. Thus, the amount of polyurethane needed (taking into account the WLF) was 169.83 grams (see paragraph [177], section (v) above)−53.9=115.93 grams A+B. The final formulation for a 12″×12″ by 3″ thick block of 3.25 lb/ft³ final density material made with 125% mold fill (3.75″ for a 3″ block) of 1.9 lb/ft³ expanded polyethylene (EPE) is therefore 269.4 grams EPE, 60.28 grams A and 55.65 grams of B.

Analogously, a 12″×12″ by 3″ thick block of 3.25 lb/ft³ final density material made with 150% mold fill (4.5″ for a 3″ block) of 1.9 lb/ft³ expanded polyethylene (EPE) was prepared using 323.25 grams EPE, 32.28 grams A, and 29.8 grams of B. Analogous formulations were prepared using Arcel beads as an exemplary porous material, as described above. The formulations were then mixed and composite materials prepared essentially following the procedures described above in Example 9.

When these samples were prepared and visually examined there was a marked decrease in voids as one went from 100% to 125% to 150% fill. This trend is consistent across all the beads and densities evaluated (expanded polyethylene at 1.2 lb/ft³ density and 1.9 lb/ft³ density, as well as Arcel at 1.25 lb/ft³ density and 2.17 lb/ft³ density). It appears therefore that there is a minimizing of voids as the mold fill was increased in this manner. This would be consistent with a model of deformable spheres having a set interstitial spacing (volume) at zero compression. Upon compression, in this model, the interstitial volume would become some fractional amount of the original; which would require less of the foaming (expanding) urethane to fill the interstitial spaces. In this model the rate of loss of volume in the interstitial spaces from the deformation (compression) of the beads is greater than the volume loss associated with the necessary decrease of urethane required to maintain density.

In order to provide a quantitative assessment of the extent of void formation as a function of compression and particulate to polymer ratio, one can prepare an exemplary range of materials in which density is kept relatively constant but the volume of particulate is varied relative to the volume of the final block, and then the resulting materials can be examined to evaluate the effects on void formation. By way of example, an exemplary range of materials was prepared in which density was kept relatively constant (at about 3.1 to 3.2 lb/ft³) but the amount of EPE beads was varied from 100% to approximately 150% of the final block, essentially as described above, and then the resulting materials were examined under magnification (6×), and the number of voids in a 27.5 mm diameter were recorded. The results observed are summarized in Table 7 below:

TABLE 7

| | | | # of Voids |
|---|---|---|---|
| | Density | | (per 27.5 mm |
| Sample | (lb/ft³) | % Mold Fill | diameter circle) |
| A | 3.1 | 100 | 21 |
| B | 3.1 | 125 | 18 |
| C | 3.2 | 150 | 14 |

Following from the discussion above, it can be seen that by varying the formulation along parameters such as described, one can readily generate materials exhibiting varying extents of void formation. Depending on the desired application, any of a variety of simple qualitative assessments can be performed to initially evaluate materials produced along a range of such parameters. By way of illustration, by increasing mold fill (and decreasing the extent of voids) along the range of exemplary materials above, qualitative assessments of compressive and shear stresses can be readily examined by, e.g., squeezing the resulting material and/or pulling it outward. In this case, along the range exemplified by Samples A through C in Table 7 above (100 to 150% mold fill), it was readily apparent that susceptibility to deformation forces decreased as mold fill increased (and as voids decreased). It was also observed that the materials produced with greater mold fill exhibited smoother and more uniform surfaces to cutting. As described and illustrated herein and in the art, numerous additional qualitative as well as quantitative tests can be performed to evaluate particular structural and/or performance attributes.

As illustrated herein, by varying parameters such as those described, one can readily generate a range of materials having desirable performance and other properties making them particularly suitable for specific applications.

### EXAMPLE 14

### Generating Composite Materials Using a Mixture of Porous Materials of Varying Size and Density

As described herein, a variety of porous materials can be incorporated to generate composite materials exhibiting a variety of weight, performance and other properties. Without wishing to be bound by theory, it is believed that relatively smaller particles can generally be useful for enhancing strength and related performance attributes while larger particles can be used to generally reduce the overall weight and increase buoyancy. In addition, mixtures of porous materials can be particularly useful for certain applications, as exemplified below.

For this experiment, two different sizes of Arcel beads (70:30 PS:EVAC Interpenetrating Polymer Network (IPN)) were used: (i) “larger” beads of approximately 1.25 lb/ft³ density Arcel, which were typically in the range of about 4-6 mm in diameter; and (ii) “smaller” beads of approximately 2.17 lb/ft³ density Arcel, which were typically in the range of about 2-3 mm in diameter. 12″×12″ by 1″ thick blocks of 6.5 lb/ft³ density were made with both of these Arcel materials. By filling the mold to, e.g., 150% with the expanded particulate and using a correspondingly reduced amount of polymer, voids in the composite can be reduced. By choosing a density target of approximately 6.5 lb/ft³ and a mold fill of 150%, an illustrative range of mono-particulate and mixed-particulate materials was generated as follows:
A. 100% 2.17 lb/ft³ (“smaller”) Arcel
B. 25% 2.17 lb/ft³ (smaller) Arcel and 75% 1.25 lb/ft³ (“larger”) Arcel
C. 50%/50% (smaller/larger)
D. 75%/25% (smaller/larger)
E. 100% 1.25 lb/ft³ (larger) Arcel

All samples were prepared as 12″×12″ by 1″ thick blocks, with 150% mold fill of Arcel, and a target density of approximately 6.5 lb/ft³. These percentages could be used to generate a range of weight or volume percent. Since the focus of these experiments was to identify changes in the void volume between beads, volume percent was used for this example.

The weight of material to be in the mold at the end of the reaction (to yield the desired final density) was calculated as follows:
6.5 lb/ft³ material×16 oz/lb=112 oz/ft³;
112 oz/ft³/12 inch/foot=8.66 oz/inch/ft²;
8.66 oz/inch/ft²×28.4 grams/oz=245.7 grams/inch/ft² of material.

The weight of expanded beads required to fill 150% of the final mold volume (½″ of beads in a 1″ mold) was calculated as follows:
(a) for 1.25 lb/ft³ Arcel
1.25 lb/ft³ Arcel×16 oz/lb=20 oz/ft³;
20 oz/ft³/12 inch/foot=1.666 oz/inch/ft²;
1.666 oz/inch/ft²×28.4 grams/oz=47.2 grams/inch/ft² Arcel (for 100% mold fill); and
47.2 grams×1.5=70.9 grams (for 150% mold fill).

(b) for 2.17 lb/ft³ Arcel
2.17 lb/ft³×16 oz/lb=34.7 oz/ft³;
34.7 oz/ft³/12 inch/foot=2.9 oz/inch/ft²;
2.9 oz/inch/ft²×28.4 g/oz=82.0 g/inch/ft² Arcel (for 100% mold fill); and
82.0 g×1.5=123 g (for 150% mold fill).

The weight of each bead required to achieve the desired ratio of particulate materials (e.g., for 25%/75%) and the amount of polymer required to achieve the desired final density was calculated as follows:
123 g (2.17 lb/ft³ Arcel)×0.25=30.75 g;
70.9 g (1.25 lb/ft³ Arcel)×0.75=53.2 g;
30.8 g+53.2 g=84 g (total Arcel);
245.7 total grams of material−84=161.7 grams PUR (A+B);
161.7 g×1.11 (estimated weight loss factor)=179.5 g PUR.

Several mixed formulations were prepared consistent with the considerations set forth above:
Mixed Formulation “A”: (12″×12″ by 1″ thick 6.5 lb/ft³ density material at 150% mold fill, with 25% bead volume of 2.17 lb/ft³ Arcel and 75% bead volume 1.25 lb/ft³ Arcel:)
30.8 g 2.17 lb/ft³ Arcel;
53.2 g 1.25 lb/ft³ Arcel;
93.3 g A component of PUR;
86.2 g B component of PUR;
161.7 g×1.11 (estimated weight loss factor)=179.5 g PUR.
Mixed Formulation “B”: (12″×12″ by 1″ thick 6.5 lb/ft³ density material at 150% mold fill, with 50% bead volume of 2.17 lb/ft³ Arcel and 50% bead volume 1.25 lb/ft³ Arcel):
   61.5 g 2.17 lb/ft³ Arcel;
   35.45 g 1.25 lb/ft³ Arcel;
   85.86 g A component of PUR;
   79.25 g B component of PUR;
   148.75×1.11 (estimated weight loss factor)=165.11 g PUR.
Mixed Formulation “C”: (12″×12″ by 1″ thick 6.5 lb/ft³ density material at 150% mold fill, with 75% bead volume of 2.17 lb/ft³ Arcel and 25% bead volume 1.25 lb/ft³ Arcel):
   92.3 g 2.17 lb/ft³ Arcel;
   17.7 g 1.25 lb/ft³ Arcel;
   78.33 g A component of PUR;
   72.3 g B component of PUR;
   135.7×1.11 (estimated weight loss factor)=150.63 g PUR.

Analogously, for the 100% formulation, e.g., of 2.17 lb/ft³ Arcel, 123 g of Arcel were used; approximately 122.7 g of PUR (245.7 total minus 123 g Arcel)×1.11 (weight loss factor) or 136.2 g of PUR; the A and B components of PUR being used at a ratio of 52:48, for a final amount of 70.8 g PUR A and 65.4 g PUR B.

The formulations were then mixed and composite materials prepared essentially following the procedures described above in Example 9, to generate an exemplary range of materials as follows:
12″×12″ by 1″ thick 6.5 lb/ft³ density material @ 150% mold fill, with 100% bead volume of 2.17 lb/ft³ Arcel,
12″×12″ by 1″ thick 6.5 lb/ft³ density material @ 150% mold fill, with 25% bead volume of 2.17 lb/ft³ Arcel and 75% bead volume 1.25 lb/ft³ Arcel (based on Mixed Formulation “A”),
12″×12″ by 1″ thick 6.5 lb/ft³ density material @ 150% mold fill, with 50% bead volume of 2.17 lb/ft³ Arcel and 50% bead volume 1.25 lb/ft³ Arcel (based on Mixed Formulation “B”),
12″×12″ by 1″ thick 6.5 lb/ft³ density material @ 150% mold fill, with 75% bead volume of 2.17 lb/ft³ Arcel and 25% bead volume 1.25 lb/ft³ Arcel (based on Mixed Formulation “C”), and
12″×12″ by 1″ thick 6.5 lb/ft³ density material @ 150% mold fill, with 100% bead volume of 1.25 lb/ft³ Arcel.

The materials produced revealed that the incorporation of the smaller beads resulted in a decrease in void volume. Without wishing to be bound by theory, it is believed that the incorporation of smaller beads into the interstitial spaces tends to further stabilize the overall structure, especially to shear and/or compressive stresses.

The resulting composite materials were tested for shear strength and shear modulus (according to the methodology of ASTM C273). The properties of these materials are summarized in Table 8 below:

TABLE 8

| Sample (smaller:larger) | Shear | Shear |
|---|---|---|
| (2.17 lb/ft³:1.25 lb/ft³) | Strength (psi) | Modulus (psi) |
| 100:0 | 127 | 4,290 |
| 75:25 (“C”) | 118 | 4,690 |
| 50:50 (“B”) | 78 | 1,830 |
| 25:75 (“A”) | 99 | 2,570 |
| 0:100 | 70 | 2,180 |

From the data shown above, it is apparent that mixtures of different porous materials can be readily combined to generate composites exhibiting a variety of performance attributes making them particularly useful for various applications.

### EXAMPLE 15

### Application of Resins to Exemplary Materials

As described herein, a variety of different surfaces and laminates can be applied to invention materials depending on the particular use or application desired. By way of illustration, applying a fiberglass and/or a resin layer onto a core material of the present invention can be used to improve properties such as overall strength, hardness and other potentially desirable features for particular applications. Two commonly used resins for laminates are polyester (which is generally a polyester/styrene mix) and epoxy. While certain epoxies can yield enhanced physical properties, they are often more expensive and difficult to work with than polyester/styrene resins, making the latter a frequent choice for many industrial applications. When applying such materials, however, there is a potential tendency for like to dissolve like, e.g. for styrene-based resins to potentially dissolve styrene-based core materials. Appreciating this possibility, one can readily determine the extent of potential dissolution for a given combination of materials. Depending on the actual use intended, some amount of dissolution is acceptable and may in some circumstance be desirable since it can potentially promote bonding between layers. By way of example a commonly used polyester styrene resin was tested with several exemplary core materials.

The illustrative resin used was a polyester styrene resin comprising approximately 61-64% unsaturated polyester base resin and 35-38% styrene (as well as a UV stabilizer) that is routinely used for providing clear laminating coats on articles such as surfboards (available, for example, as Silmar brand SIL66BQ-249A resin manufactured by Interplastic Corporation, based in St. Paul, Minn., www.interplastic.com). For purposes of illustration, three different composite core samples were prepared using a polyurethane polymer and either of two different porous materials:
1.25 lb/ft³ expanded polyethylene (EPE) (available, for example, as Eperan beads from Kaneka Texas Corp., Pasadena, Texas), or
bead comprising a 70:30 interpenetrating polymer network of polystyrene (PS) and an ethylene vinyl acetate copolymer (EVAC) in a ratio of approximately 70:30 (PS:EVAC), and having a density of approximately 2.17 pounds per cubic foot (available, for example, as Arcel beads from Nova Chemical, Moon Township, Pa.).

Following the basic formulation procedure and method of Example 9, three different core articles were prepared, as follows:
11.2 lb/ft³ density material based on 2.17 lb/ft³ Arcel,
6.2 lb/ft³ density material based on 2.17 lb/ft³ Arcel, and
4.1 lb/ft³ density material based on 1.25 lb/ft³ Expanded Polyethylene.

The general procedure followed for the preparation of the above-described core articles was as follows:
(i) Samples were cut and measured along each axis;
(ii) a 6 oz. jar with 5 oz. uncatalyzed polyester resin was placed in the oven at 165° F. (˜74° C.) and heated for 15 minutes;
(iii) the cut and measured samples were immersed in the resin and held down with the cap;
(iv) the resin with the samples were put in the oven at 165° F. (˜74° C.) along with cut and measured controls (not treated with the resin);
(v) the samples and controls were kept in the oven for 30 minutes;
(vi) samples and controls were removed from the oven and samples were removed from the resin (use nitrile gloves) and excess resin was removed from samples with paper towels;

(vii) samples were measured and changes from initial measurements were recorded, and were also visually compared to controls. The dimensions of the samples are summarized in Table 9 below:

TABLE 9

| | Dimensions | Dimensions |
|---|---|---|
| Sample | Before (inches) | After (inches) |
| A. 11.2 lb/ft³ Arcel | x = 1 1/64 | x = 1 1/64 |
| | y = 1 2/64 | y = 1 2/64 |
| | z = 53/64 | z = 53/64 |
| B. 6.2 lb/ft³ Arcel | x = 1 1/64 | x = 1 1/64 |
| | y = 1 2/64 | y = 1 1/64 |
| | z = 53/64 | z = 53/64 |
| C. 4.1 lb/ft³ EPE | x = 1 1/64 | x = 1 1/64 |
| | y = 63/64 | y = 63/64 |
| | z = 59/64 | z = 59/64 |

As can be seen from the results presented in Table 9, the samples were essentially unchanged, with only the 6.2 lb/ft³ Arcel exhibiting an apparent dimensional change that was only 1/64″ in one direction. It appeared that the polyethylene beads were essentially inert to the polyester/styrene resin. Without wishing to be bound by theory, it is presently believed that the Arcel samples exhibited resistance to the polyester/styrene resin principally because of the protective contribution from the polymer (in this case polyurethane).

Upon examination of the samples it appeared that the surface styrene did exhibit limited dissolution, however the polyurethane polymer (which formed an essentially continuous phase extending from the interior to the surface of the sample) did not exhibit any apparent dissolution. Therefore, it appears that the polymer effectively served to maintain the overall dimensions of the article while the exposed surface in the case of the Arcel formulation (which comprises polystyrene) exhibited some dissolution. Depending on the particular application and process, these results can be employed to advantage because while the overall structure is maintained, the generation of partially dissolved styrene on the surface can be used to act as a bonding agent or tie coat to enhance binding to an adjacent material in a laminate.

### EXAMPLE 16

### Incorporation of Rubber into Composite Materials

As described herein, rubber and rubber-based materials can be incorporated into composite materials of the present invention either as relatively inert fillers or to modify one or more performance properties of the materials to make the resulting article particularly desirable for certain applications. By way of illustration, rubber can be used to enhance the sound dampening properties of composite materials or to alter various other performance properties of the materials. As an example of the latter, one performance property that can potentially be modified by the incorporation of rubbers is resistance to nail pull, since incorporation of rubbers can contribute to a high rebound and friction, thereby increasing nail pull resistance. One convenient and inexpensive source of rubber-based materials is used tires which can be recycled to remove various debris and to provide rubber in a variety of different mesh sizes. A number of natural and synthetic rubbers and rubber-like substances are available and their properties described in the art (see, e.g., Science and Technology of Rubber by J E Mark, B Erman and F R Eirich (1994, Academic Press); and Rubber Technology by Maurice Morton (1987, Von Nostrand)).

For this illustrative example, a range of rubber materials available as 5, 10 or 20 mesh (i.e. rubber of less than about 0.2, 0.1 and 0.05 inches diameter, respectively) were incorporated into composites comprising polyurethane (PUR, provided as PUR “A”+PUR “B”) as polymer, and 2.17 lb/ft³ density Arcel beads as porous material, each as described above. Samples were made 1 inch thick, using enough of the Arcel to fill the mold to 150% (1½″ Arcel in a 1″ cavity), and using enough polymer to bring the final density to 12.5 lb/ft³. Various meshes of rubber were added on a percent basis (% w/w) relative to the Arcel. An example of the calculation for the recipe is:
a 12″×12″×1″ thick sample having a density of 12.5 lb/ft³ would weigh 472.5 grams;
to fill 150% of a 12″×12″×1″ thick cavity with Arcel having a density of 2.17 lb/ft³ requires 123 grams;
472.5 total grams of material minus 123 g Arcel=349.5 g of the polyurethane needed.

Since the reaction gives off by-products (and there are other slight losses during processing) not all the weight introduced into the mold before the reaction will remain after the reaction. Therefore a correction factor for this weight loss was empirically determined and multiplied by the weight of polyurethane (PUR). Examining historical product versus reactant weights for these materials allowed calculation of a weight loss factor (WLF) of 1.11. Thus,
349.5 g (final) of PUR×1.11 WLF=387.9 g (corrected) PUR;
PUR was added as 52% component A and 48% component B:
   387.9×0.52=201.7 g component A; and
   387.9×0.48=186.2 g component B.

The general composition for a 12″×12″×1″ thick sample having a density of 12.5 lb/ft³ (with Arcel having a density of 2.17 lb/ft³) at 150% mold fill was:
123 g Arcel,
201.7 g PUR “A”,
186.2 g PUR “B”,
plus varying % (w/w) rubber.

For purposes of illustration and to generate a range of materials, samples were made comprising added rubber at 5, 10, 25, 50, 100 and/or 200% (w/w relative to the porous material, e.g. Arcel). For a sample with 123 g Arcel, the quantity of rubber added was as follows:
5%=6.15 g,
10%-12.3 g,
25%=30.75 g,
50%=61.5 g,
100%=123 g, and
200%=246 g.

Samples were made with the 5, 10 and 20 mesh rubbers as follows:
5 mesh: 5, 10, 25, 50, 100, and 200%,
10 mesh: 5, 10, 25, 50, 100, and 200%, and
20 mesh: 50, 100, and 200%.

In the qualitative nail pull test there was a significant improvement (i.e., increase) in resistance strength as compared to control materials not incorporating the rubber.

Results of exemplary testing of the 100% w/w samples of composite materials for shear strength and shear modulus (according to the methodology of ASTM C 273) are presented in Table 10 as follows:

TABLE 10

| Sample (rubber | Shear Strength | Shear |
|---|---|---|
| mesh, 100% mixture) | (psi) | Modulus (psi) |
| 5 | 168 | 5,440 |
| 10 | 197 | 6,560 |
| 20 | 191 | 4,720 |

From the data shown above, it is apparent that combinations of porous materials can be readily combined to generate composites exhibiting a variety of performance attributes making them particularly useful for various applications.

### EXAMPLE 17

### Incorporation of Perlite into Composite Materials

As described herein, a number of different materials can be used to prepare composite materials of the present invention and to potentially modify one or more performance properties of the composites to make them particularly desirable for certain applications. Thus a variety of relatively lightweight partially porous particulates are available which can be readily incorporated into composites following the general approaches described and illustrated. An example of an inorganic partially porous particulate which can be used in accordance with the present invention is Perlite, a type of expanded siliceous volcanic glass (CAS# 93763-70-3). Perlite is available in a variety of different forms exhibiting a range of sizes and densities (see, e.g., the publications and websites of The Perlite Institute, www.perlite.org). Expanded Perlite beads are generally partially porous in that they comprise a largely closed-cell interior surrounded by a relatively porous exterior. Typically, Perlite can be manufactured to form densities of between 2 and 25 lb/ft³, and can be used to provide a light-weight filler, e.g., to add thermal insulation, enhance fire retardance and/or reduce noise transmission.

For this illustrative example, Perlite having a density of approximately 5.5 lb/ft³ (available, for example, as Perlite “SP” from Aztec Perlite of Escondido, Calif.) was used. Following the general procedures essentially as described above, a 1″ by 12″ by 12″ sample block of composite material was prepared comprising Perlite SP and PUR A+B from a batch having the following composition:
207.9 g Perlite SP (5.5 lb/ft³),
393 g PUR “A”, and
362.4 g PUR “B”.

After mixing and filling a mold (to approximately 100% volume), the press was closed and the polymerization reaction was allowed to proceed for approximately twenty minutes. The density of the resulting block was determined to be approximately 22.4 lb/ft³.

Testing of the resulting composite material for shear strength and shear modulus (according to the methodology of ASTM C273) showed that it exhibited the following properties:
Shear strength—134 psi, and
Shear modulus—12,410 psi.

### EXAMPLE 18

### Use of a Mixture of Organic and Inorganic Porous Materials

As described herein, a number of different porous materials, as well as mixtures or blends thereof, can be incorporated into composite materials of the present invention to modify one or more performance properties of the resulting composite materials to make the resulting composite materials particularly desirable for certain applications.

An example of a mixture of an organic and an inorganic porous particulate which has been used according to the present invention comprises:
as the organic porous particulate—an interpenetrating polymer network (IPN) of a first polymer (which is polystyrene (PS)) and a second polymer (which is an ethylene vinyl acetate copolymer (EVAC)) in a ratio of approximately 70:30 (PS:EVAC), and having a density of approximately 2.17 pounds per cubic foot (available, for example, as “Arcel” beads from Nova Chemical, Moon Township, Pa.)), and
as the inorganic particulate—Perlite having a density of approximately 5.5 lb/ft³ (available, for example, as Perlite “SP” from Aztec Perlite of Escondido, Calif.).

As also described and illustrated herein, by varying the ratios of such components, one can generate a range of materials exhibiting various densities and performance attributes that may be desirable for particular applications. By way of illustration, in addition to using Perlite SP as the sole porous material as in the preceding example (referred to herein as “100% Perlite”), a series of samples were generated in which the Perlite ratio was reduced (to 75%, 50%, 25% and 10% of the porous material) and the remainder of the porous material comprised Arcel beads as an exemplary organic particulate.

Following the general procedures essentially as described above, a 1″ by 12″ by 12″ sample block of composite material was prepared comprising Perlite SP and PUR A+B from batches having the compositions set forth in Table 11, with the final material having an overall density as also set forth in Table 11:

TABLE 11

| | Blend | Perlite | Arcel | PUR A | PUR B | Density |
|---|---|---|---|---|---|---|
| Sample | (Perlite:Arcel) | (g) | (g) | (g) | (g) | (lb/ft³) |
| A | 75:25 | 156 | 52 | 393 | 362.4 | 22.8 |
| B | 50:50 | 104 | 104 | 393 | 362.4 | 21.5 |
| C | 25:75 | 52 | 156 | 393 | 362.4 | 16 |
| D | 10:90 | 20.8 | 187.2 | 393 | 362.4 | 11 |

After mixing and filling a mold (to approximately 100% volume), the press was closed and the polymerization reaction was allowed to proceed for approximately twenty minutes.

The resulting composite materials were tested for shear strength and shear modulus (according to the methodology of ASTM C273). Test results are summarized in Table 12, as follows:

TABLE 12

| Sample | Shear Strength (psi) | Shear Modulus (psi) |
|---|---|---|
| A | 239 | 20,760 |
| B | 241 | 20,500 |
| C | 256 | 15,700 |
| D | 145 | 7,890 |

From the data presented in Table 12, it is apparent that combinations of porous materials can be readily combined to generate composites exhibiting a range of density and performance attributes making them particularly useful for various applications.

### EXAMPLE 19

### Preparation of Exemplary Materials for Use in Platforms Such as Diving Boards

Specialty platforms such as diving boards constitute another exemplary class of manufactured articles that can benefit by combining characteristics of light weight and high strength, particularly when they can be prepared relatively simply and with low-cost materials and procedures, such as those described and illustrated herein. Additional potential advantages for the product can include, for example, additional spring or other performance characteristics that facilitate or enhance uses of materials according to the present invention, such as preparation of diving boards. For example, by varying the relative stiffness versus flexibility of a board, desirable levels of spring can be achieved. While overall board spring can also be enhanced by external devices, these not only add to expense but also have a tendency to lose their effectiveness over time. Additional potential advantages associated with using materials and processes of the present invention in place of traditional cores can include, for example, avoidance of trimming or other processing steps associated with the preparation of cores from materials such as wood.

In a variety of commonly employed processes for the manufacture of diving boards, for example, a core of wood or other material may be trimmed or modified to provide a desired substrate for application of one or more coatings, such as acrylic and/or fiberglass coatings. The core is typically surrounded by a rigid outer layer, commonly one or more layers of fiberglass, carbon-based fibers or other fibrous material impregnated and applied using a polyester, epoxy or other resin. In a typical application, a wood core, which may comprise one of more beams or stringer members, is reinforced with one or more layers of fiberglass, carbon-based fibers or other fibrous material impregnated and applied using a polyester, epoxy or other resin. Typically the top surface of the board also comprises a coating such as an acrylic or polyester resin that may be further modified to present a slip- resistant surface. Modifications to increase slip-resistance can include, for example, creating a grooved or textured surface, applying a sheet or layer comprising a grit or sandpaper-like finish, and incorporating directly into a surface layer one or more particles that can form a grit (such as crystalline silica materials, aluminum silica, silicon carbide, boron nitride, oxides of aluminum, titanium, zinc, and the like, as known in the art). A variety of techniques for preparing diving boards and other specialty platforms are known in the art (see, e.g., the descriptions provided in references such as U.S. Pat. Nos. 3,502,327; 3,544,104; 3,861,674; 4,049,263; 6,194,051; and PCT Publication No. WO2004/042137; and see, e.g., various diving boards in common manufacture from sellers such as Inter-Fab Incorporated (www.inter-fab.com) and S. R. Smith (www.srsmith.com)).

Use of wood cores can be relatively expensive, particularly as very high grade woods may be required, and also relatively resource-intensive to process, particularly as wood generally requires milling and/or other modifications to generate a finished form that is suitable for use as a core. Wood is further limited in that performance properties may vary in relatively unpredictable ways depending on factors such as the particular natural source material and circumstances of its subsequent processing, handling, storage conditions, etc. Not only are such wood cores relatively expensive and subject to these additional potential concerns, but it can also be difficult and/or expensive to modify performance properties that may be associated with the core since wood is a natural product generally available with relatively limited and predefined attributes.

As described and illustrated herein, structural and other composite materials of the present invention can be easily molded into any of a variety of desired shapes and can be readily generated to exhibit desirable structural and performance attributes making them suitable for incorporation into a variety of relatively light-weight high-strength articles. By way of example, composite materials or combinations thereof may themselves be formed to constitute a finished article or they may be used to constitute a core which can then be modified by the application of one or more coatings or laminas as described herein and known in the art. Furthermore composite materials of the present invention can readily be prepared to exhibit any of a range of potentially desirable characteristics such as flexural, shear, tensile and compression strengths. Applying the foregoing for use in the preparation of platforms or other structures, such as diving boards for purposes of illustration, a variety of different boards can be constructed essentially out of composite materials of the present invention; or such materials can be used to form diving board cores which are then modified to provide an external surface exhibiting properties that make the boards particularly desirable. As described and illustrated herein, various composite materials can be prepared and procedures employed that facilitate application of external lamina.

As further illustrations of the foregoing, materials and procedures such as those described herein were employed to generate three exemplary diving board cores, as described in Examples 19A, 19B and 19C below:

### EXAMPLE 19A

A diving board core was prepared using beads of expanded polystyrene (EPS) having a density of approximately 1.8 lb/ft³ and a polyurethane polymer provided as a combination of an “A” and a “B” component, which were subsequently mixed and processed, essentially as described above in Example 9. For this sample, the components were combined as follows:
76.8 g of EPS,
167 g of PUR A, and
154 g of PUR B.

### EXAMPLE 19B

A second diving board core was prepared using a 75:25 (w:w) combination of beads of (i) Perlite, SP grade, having a density of approximately 5.5 lb/ft³ and (ii) EPS having a density of approximately 1.8 lb/ft³; and polyurethane polymer provided as a combination of an “A” and a “B” component, which were subsequently mixed and processed, essentially as described above in Example 9. For this sample, the components were combined as follows:
106.3 g Perlite,
35.4 g of EPS,
275 g of PUR A, and
253.8 g of PUR B.

### EXAMPLE 19C

A third diving board core was prepared using a 66:33 (w:w) combination of (i) rubber (10-mesh) and (ii) EPS having a density of approximately 1.8 lb/ft³; and polyurethane polymer provided as a combination of an “A” and a “B” component, which were subsequently mixed and processed, essentially as described above in Example 9. For this sample, the components were combined as follows:
153.6 g rubber,
76.8 g of EPS,
167 g of PUR A, and
154 g of PUR B.

Boards of the preceding examples, prepared in desired shapes and dimensions and using procedures essentially as described in previous examples, can then be modified by application of any of a variety of surface layers that may be desired. For example, in diving board manufacturing techniques that employ wood cores which are then wrapped in one or more layers of fiberglass, cores prepared using materials and procedures as described herein can be used to replace the wood or other cores used in current procedures. As further described herein, the components of the present invention can be readily combined in a range of formulas to generate any of a variety of process, structural and/or performance attributes making them particularly useful for a desired application. Again, this makes the employment of materials and procedures of the present invention much more readily adaptable to particular applications than materials such as woods.

### EXAMPLE 20

### Rapid Testing Method

As described herein, the materials and methods of the present invention can readily be applied to the generation of a variety of composite materials exhibiting a range of performance characteristics. In order to provide a rapid means for assessing the performance characteristics of various combinations, a modified four-point stress to fracture test was developed.

By way of illustration, a composite sample to be tested can be suspended atop two evenly spaced test beams, a third beam placed atop the sample and weights gradually added to the third beam until the sample exhibits structural failure. The degree of resistance of a sample to structural failure is generally considered to reflect a combination of shear, tensile and compression strengths and can be used to provide a rapid testing method to compare new samples to other materials (including, for example, control materials that have already been tested using defined ASTM methods such as those described above).

As an example of such a test, a set of three wooden test beams were used, each having dimensions of 2″×4″×12″, and weighing approximately 0.3 to 0.5 kilograms. Two of the test beams were stood on their narrowest (2″) side and placed parallel to each other at a distance of 8″ apart to yield two parallel support beams (each 4″ high and 12″ long). A sample of composite material to be tested was prepared having dimensions of 1″×12″×12″ and was then cut to yield three test samples, each 1″×3″×12″ (with a left-over piece available for additional testing). The test sample was then placed on its 3″ wide side atop and perpendicular to the support beams such that the first 2″ of its 12″ length rested squarely on one support beam and the last 2″ rested squarely on the other. The suspended portion of the test sample thus represented a central portion of the sample which was 8″ in length, 3″ in width and 1″ in height. The third test beam was centered atop the sample, parallel to the first two test beams. Weights were placed along the center of the top beam until they caused structural failure of the test sample. Typically, the left-over slightly thinner piece of test sample was used for an initial weight-to-failure test, then approximately 90% of that weight was placed onto a sample to be tested and the weight increased in 2.5 pound increments until structural failure.

### EXAMPLE 21

### Illustration of a Range of Composite Materials Assessed by Rapid Test Method

The rapid test method described above was applied to the assessment of a variety of different composite materials prepared essentially as described and illustrated in preceding examples. Following the basic mixing procedures as illustrated in Example 9 and subsequent examples, the following materials were generated and samples were tested, in triplicate, using the rapid test method of Example 20:

### EXAMPLE 21A

For this example, the formulation employed was as follows (using reagents as described above):
(i) 102.1 g expanded polystyrene (EPS) 1.8ρ (lbs/ft³);
(ii) 157.1 g polyurethane component “A” (PUR A); and
(iii) 145.0 g polyurethane component “B” (PUR B).
   Final ρ (lbs/ft³)=9.7.

Using the rapid test method described above, the resulting stress fracture (SF) values were as follows: 70 lbs, 67.5 lbs, 60 lbs. Average SF (lbs)=65.8 (N=3).

It is believed that the modest differences in break or fracture values observed among some samples may reflect non-uniform mixing and/or slight differences in the dimensions of the cut samples. Another composite material batch, prepared in accordance with the same formulation as above, was tested and the differences observed between samples was negligible, with a mean value of 65 (N=3), indicating a relatively high degree of consistency between test results.

### EXAMPLE 21B

For this example, the formulation was as follows (using reagents as described above):
(i) 141.7 g Perlite 5.5ρ (density, lbs/ft³);
(ii) 47.2 g EPS 1.8ρ (lbs/ft³);
(iii) 370.9 g PUR A; and
(iv) 342.4 g PUR B.
   Final ρ (lbs/ft³)=20.5.

Using the rapid test method described above, the resulting SF values were as follows: 105 lbs, 107.5 lbs, 120 lbs. Average SF (lbs)=110 (N=3).

### EXAMPLE 21C

For this example, the formulation was as follows (using reagents as described above):
(i) 105.7 g Arcel 2.17ρ (density, lbs/ft³);
(ii) 219.4 g PUR A; and
(iii) 193.2 g PUR B.
   Final ρ (lbs/ft³)=11.2.

Using the rapid test method described above, the resulting SF value was as follows: 85 lbs (N=1).

### EXAMPLE 21D

For this example, the formulation was as follows (using reagents as described above):
(i) 123 g Arcel 2.17ρ (density, lbs/ft³);
(ii) 159.5 g PUR A; and
(iii) 147.3 g PUR B.
   Final ρ (lbs/ft³)=10.3.

Using the rapid test method described above, the resulting SF values were as follows: 75 lbs, 77.5 lbs, 75 lbs. Average SF (lbs)=76 (N=3).

### EXAMPLE 21E

For this example, the formulation was as follows (using reagents as described above):
(i) 123 g Arcel 2.17ρ (density, lbs/ft³);
(ii) 61.5 g Rubber (20 mesh);
(iii) 201.7 g PUR A; and
(iv) 186.2 g PUR B.
   Final ρ (lbs/ft³)=13.4.

Using the rapid test method described above, the resulting SF values were as follows: 100 lbs, 100 lbs, 100 lbs. Average SF (lbs)=100 (N=3).

### EXAMPLE 21F

For this example, the formulation was as follows (using reagents as described above):
(i) 72.8 g Perlite 5.5ρ (density, lbs/ft³);
(ii) 72.8 g Rubber (10 mesh);
(iii) 62.4 g EPS 1.8ρ (lbs/ft³);
(iv) 370.9 g PUR A; and
(v) 342.4 g PUR B.
   Final ρ (lbs/ft³)=21.

Using the rapid test method described above, the resulting SF values were as follows: 135 lbs, 140 lbs, 123 lbs. Average SF (lbs)=133 (N=3). In addition to exhibiting increased resistance to breakage, this sample was also observed to exhibit very high resistance to nail pull.

### EXAMPLE 21G

For this example, the formulation was as follows (using reagents as described above):
(i) 207.9 g Perlite 5.5ρ (density, lbs/ft³);
(ii) 207.9 g rubber (10 mesh);
(iii) 370.9 g PUR A; and
(iv) 342.4 g PUR B.
   Final ρ (lbs/ft³)=26.5.

Using the rapid test method described above, the resulting SF values were as follows: 100 lbs, 105 lbs, 125 lbs. Average SF (lbs)=110 (N=3).

### EXAMPLE 21H

For this example, the formulation was as follows (using reagents as described above):
(i) 204.1 g EPS 1.8ρ (density, lbs/ft³);
(ii) 204.1 g rubber (10 mesh);
(iii) 222.5 g PUR A; and
(iv) 205.4 g PUR B.
   Final ρ (lbs/ft³)=15.7.

Using the rapid test method described above, the resulting SF values were as follows: 70 lbs, 72.5 lbs, 70 lbs. Average SF (lbs)=71 (N=3).

### EXAMPLE 21I

For this example, the formulation was as follows (using reagents as described above):
(i) 194.9 g Perlite 5.5ρ (density, lbs/ft³);
(ii) 65.0 g EPS 1.8ρ (density, lbs/ft³);
(iii) 381.8 g PUR A; and
(iv) 352.4 g PUR B.
   Final ρ (lbs/ft³)=22.4.

Using the rapid test method described above, the resulting SF values were as follows: 135 lbs, 120 lbs, 100 lbs. Average SF (lbs)=118 (N=3).

### EXAMPLE 21J

For this example, recycled PetriFoam material that had been previously prepared from EPS and PUR A and PUR B essentially as described in preceding examples was incorporated to form a 6.2 lbs/ft³ block which was then ground for recycling. The formulation comprising recycled material was as follows (using reagents as described above):
(i) 102.1 g EPS 1.8ρ (density, lbs/ft³);
(ii) 51.0 g ground recycled EPS-based PetriFoam 6.2ρ (density, lbs/ft³);
(iii) 157.1 g PUR A; and
(iv) 145.0 g PUR B.
   Final ρ (lbs/ft³)=10.3.

Using the rapid test method described above, the resulting SF values were as follows: 70 lbs, 75 lbs, 70 lbs. Average SF (lbs)=71.6 (N=3).

### EXAMPLE 21K

For this example, an illustrative organic fiber was incorporated into the composite material. The formulation was as follows (using reagents as described above):
(i) 102.1 g EPS 1.8ρ (density, lbs/ft³);
(ii) 51.0 g cotton linters (e.g., Bright White/Paper Casting—Papermaking/Papermaking supplies available from Michael's Crafts; Supplier: Greg Markim Inc. P.O. Box 13245; Milwaukee, Wis. 53213);
(iii) 157.1 g PUR A; and
(iv) 145.0 g PUR B.
   Final ρ (lbs/ft³)=10.9.

Using the rapid test method described above, the resulting SF values were as follows: 70 lbs, 60 lbs, 87.5 lbs. Average SF (lbs)=72.5 (N=3).

### EXAMPLE 21L

For this example, beads of glass were incorporated into the composite material. The formulation was as follows (using reagents as described above):
(i) 102.1 g EPS 1.8ρ (density, lbs/ft³);
(ii) 51.0 g glass beads (approximately 2 mm diameter, available, for example, as glass beads 10/0 from Jewelry & Craft Essentials Item # JC9960-123 Multi; made in China; Supplier: Hirschberg Schultz & Co., Inc. (Union, N.J. 07083));
(iii) 157.1 g PUR A; and
(iv) 145.0 g PUR B.
   Final ρ (lbs/ft³)=10.7.

Using the rapid test method described above, the resulting SF values were as follows: 62.5 lbs, 67.5 lbs, 65 lbs. Average SF (lbs)=65 (N=3).

### EXAMPLE 21M

For this example, an illustrative fire retardant was incorporated into the composite material. The formulation was as follows (using reagents as described above):
(i) 102.1 g EPS 1.8ρ (density, lbs/ft³);
(ii) 157.1 g PUR A; and
(iii) 145.0 g PUR B, wherein the combination of (i), (ii) and (iii) further comprise a fire retardant (Tris-2-chloroisopropyl-n-phosphate, CAS# 13674-84-5, available as Product code: 3001-13FR; Lot # 2408 9955; Supplier: IPS (Innovative Polymer Systems); 301 S. Doubleday Ave.; Ontario, Calif. 91761).
   Final ρ (lbs/ft³)=8.0.

Using the rapid test method described above, the resulting SF values were as follows: 55 lbs, 55 lbs. Average SF (lbs)=55 (N=2).

As the preceding examples illustrate, a variety of materials and formulations can be used to generate a number of different composite materials according to the present application and rapid tests such as the structural fracture test described above can be used to quickly provide an initial assessment of the performance attributes of particular compositions. Additional testing such as the ASTM test methods described above and in the art can be applied to isolate and further assess particular performance attributes that may be desired for individual applications of the materials.

### EXAMPLE 22

### Incorporation of Honeycomb Lattice Structures

One type of reinforcement structure that can be combined with composite materials is a lattice or honeycomb structure which can be used to form structures having high strength-to-weight ratios, making them particularly suitable for certain applications. In such combinations, the honeycomb structure can form a layer that is coated or surrounded by composite material, that is adhered to the outside of a core of composite material, or that is integrated within composite material, depending on the desired application.

By way of illustration, for many applications employing structural cores, a physical property of particular interest is shear. Often both the shear strength and modulus are of interest. In contexts such as these, a honeycomb material can be incorporated to act as a form of truss for the structure, potentially impart resistance to deformation by shear as well as compression. Exemplary honeycomb reinforcing materials range from relatively higher- tech materials such as aluminum and other metallic or engineered honeycombs to relatively inexpensive lightweight materials, including paper or other fiber-based honeycombs, as well as polypropylene and other polymer-impregnated paper honeycombs, and the like.

In this illustrative example, EPS-based composites similar to those described in Example 21A were prepared incorporating a 1 inch thick aluminum honeycomb (for this example, an aluminum honeycomb material available as PCGA-XR1-1.4-1.000-N-3003 from Plasticore (Zeeland, Mich.)) was used, and introduced into a composite material generated from the following formulation: (i) 102.1 g EPS 1.8ρ (lbs/ft³); (ii) 213.8 g PUR A; (iii) 197.4 g PUR B. Final ρ (lbs/ft³)=11.9.

Using the rapid test method, the resulting stress fracture (SF) values were as follows: 100 lbs, 105 lbs, 100 lbs. Average SF (lbs)=101.7 (N=3).

Comparing these results to those of Example 21A, it can be seen that incorporation of the 1 inch aluminum honeycomb, as illustrated in this example, resulted in a greater than 50% increase in the relative stress fracture value of the composite.

### EXAMPLE 23

### Incorporation of Reinforcement Fibers

Another type of reinforcement materials that can be combined with composite materials are fibers which can be incorporated to form structures having high strength-to- weight ratios and/or to exhibit other performance features making them particularly suitable for certain applications. In such combinations, the reinforcement fibers can be incorporated to form one or more layers on or within the composite material, for example, or may be substantially dispersed within the composite material, depending on the desired application.

As will be appreciated by those of skill in the art, a number of different natural and synthetic fibers are available that can be incorporated into composite materials of the present invention. For applications in which high strength (such as shear and/or tensile strength) is desired, the incorporation of relatively high strength fibers, which may be dispersed within the composite material, can be used to substantially enhance strength, making the resulting composites particularly useful for applications in which high strength- to-weight ratios are desired.

As an illustration of the incorporation of reinforcement fibers into composites of the present invention, a polyaromatic amide or aramid fiber (available, for example, as Kevlar™ fiber from DuPont) was introduced into an EPS-based composite prepared essentially as in Example 21A. As an exemplary synthetic fiber, para-aramid fibers such as Kevlar can exhibit very high tensile strength-to-weight, structural rigidity, high dimensional and thermal stability, and other performance attributes making them particularly desirable for certain applications. Kevlar para-aramid fiber consists essentially of long molecular chains produced from poly-paraphenyl terephthalamide, in which the chains are highly oriented with strong interchain bonding.

In this illustrative example, EPS-based composites similar to those described in Example 21A were prepared, incorporating small (approximately half inch) pieces of Kevlar fabric that had been prepared by chopping a Kevlar sheet (for this example, Product 549-A (a 17×17 4HS weave material), available from Fibre Glast Developments Corporation (Brookville, Ohio) was used). The exemplary formulation was prepared as above from the following components: (i) 68 g EPS 1.8ρ (lbs/ft³); (ii) 34 g Kevlar (chopped); (iii) 157.1 g PUR A; and (iv) 145.0 g PUR B. Final ρ (lbs/ft³)=9.3.

Using the rapid test method, the resulting stress fracture (SF) values were as follows: 65 lbs, 105 lbs, 95 lbs. Average SF (lbs)=87 (N=3).

Comparing these results to those of Example 21A, it can be seen that incorporation of the reinforcement fibers, as illustrated in this example, resulted in a substantial increase in the relative stress fracture value of the composite. It is believed that the relatively low SF observed with the first sample resulted from a non-uniform distribution of Kevlar material within the composite. Enhancing the extent of distribution, such as by incorporating smaller pieces or even strands of Kevlar, would therefore be expected to yield even greater strength-to-weight ratios in the resulting composites.

### EXAMPLE 24

### Illustrative Composites Comprising Various Fibers

As described herein, a variety of different fibers and other materials can be combined with structural and other composite materials of the present invention to form structures having resistance, performance, aesthetic features, and the like that make them particularly suitable for particular desired applications. In such combinations, the fibers or other materials can be incorporated to form one or more layers on or within the composite material, for example, or may be substantially dispersed within the composite material, depending on the desired application. Effects of such materials on composite strength and other performance features can be quickly assessed using the rapid test methods described above, and then desired composites can subjected to additional evaluations as described above and in the art, depending on which particular applications the material is desired to be used for.

By way of illustration, the following composite materials were prepared incorporating various additives. In each of these compositions, the amount of additive is expressed as a relative weight percent (i.e. weight of additive as a percentage of the weight of the porous particulate component used). For these illustrative examples EPS having a density of approximately 1.8 lb/ft³ was used; and polyurethane polymer provided as a combination of an “A” and a “B” component; and optional additives; which were subsequently mixed and processed, essentially as described above in Example 9.

As an illustrative example, metallic fibers (from chopped aluminum screen, available for example as “Brite” aluminum screen from Phifer Wire Products, Tuscaloosa, Ala.) were incorporated into an EPS formulation similar to that described above: (i) 68 g EPS 1.8ρ (lbs/ft³); (ii) 34 g aluminum fibers (chopped screen); (iii) 157.1 g PUR A; and (iv) 145.0 g PUR B. Final ρ (lbs/ft³)=9.3. Using the rapid test method, the resulting stress fracture (SF) values were as follows: 72.5 lbs, 70 lbs, 77.5 lbs. Average SF (lbs)=73 (N=3).

As another illustrative example of the addition of fibers, filler paper (at 100% w/w porous particulate) was incorporated into an EPS formulation similar to that described above: (i) 102.1 g EPS 1.8ρ (lbs/ft³); (ii) 102.1 g filler paper; (iii) 157.1 g PUR A; and (iv) 145.0 g PUR B. Final ρ (lbs/ft³)=11. Using the rapid test method, the resulting stress fracture (SF) values were as follows: 120 lbs, 100 lbs, 100 lbs. Average SF (lbs)=106.7 (N=3).

As another illustrative example of the addition of fibers, polypropylene fibers (available for example as “Fibermesh” fibers from SI Concrete Systems (www.fibermesh.com), ¼ inch cut, at 50% w/w porous particulate) was incorporated into an EPS formulation similar to that described above: (i) 102.1 g EPS 1.8ρ (lbs/ft³); (ii) 51 g fiber mesh; (iii) 157.1 g PUR A; and (iv) 145.0 g PUR B. Final ρ (lbs/ft³)=10.1. Using the rapid test method, the resulting stress fracture (SF) values were as follows: 100 lbs, 100 lbs, 105 lbs. Average SF (lbs)=101.7 (N=3).

As another illustrative example of the addition of fibers, excelsior “moss” wood fibers (available for example as Great Lakes Aspen natural excelsior moss, uncut, at 50% w/w porous particulate) were incorporated into an EPS formulation similar to that described above: (i) 102.1 g EPS 1.8ρ (lbs/ft³); (ii) 51 g excelsior moss fiber; (iii) 157.1 g PUR A; and (iv) 145.0 g PUR B. Final ρ (lbs/ft³)=10. Using the rapid test method, the resulting stress fracture (SF) values were as follows: 90 lbs, 70 lbs, 70 lbs. Average SF (lbs)=76.7 (N=3).

As another illustrative example of the addition of fibers, acrylic fibers (available for example as “Silkssence” microfiber from Coats and Clark of Greenville, South Carolina, ¼ and ½ inch cut, at 50% w/w porous particulate) were incorporated into an EPS formulation similar to that described above: (i) 102.1 g EPS 1.8ρ (lbs/ft³); (ii) 51 g acrylic fibers; (iii) 157.1 g PUR A; and (iv) 145.0 g PUR B. Final ρ (lbs/ft³)=10.3. Using the rapid test method, the resulting stress fracture (SF) values were as follows: 70 lbs, 95 lbs, 75 lbs. Average SF (lbs)=80 (N=3).

As another illustrative example of the addition of fibers, pipe cleaner (¼ inch cut, at 200% w/w porous particulate) was incorporated into an EPS formulation similar to that described above: (i) 102.1 g EPS 1.8ρ (lbs/ft³); (ii) 204.2 g pipe cleaners; (iii) 157.1 g PUR A; and (iv) 145.0 g PUR B. Final ρ (lbs/ft³)=11. Using the rapid test method, the resulting stress fracture (SF) values were as follows: 120 lbs, 100 lbs, 100 lbs. Average SF (lbs)=106.7 (N=3)

### EXAMPLE 25

### Illustrative Composite Exhibiting Enhanced Nail Pull Resistance

As described herein, the methods and compositions of the present invention can be applied to the generation of any of a variety of composite materials exhibiting structural, performance and/or aesthetic features making them desirable for particular applications. Many of these features can be evaluated in relatively simple test methods to facilitate identifying and assessing exemplary composites.

By way of illustration, one feature that is desirable in many different sorts of applications is an increased resistance to nail pull. Applying the methods as described herein, the nail pull resistance was examined of a composite material based on the following formulation: (i) 72.8 g Perlite (5.5 lbs/ft³); (ii) 72.8 g Rubber (10 Mesh); (iii) 62.4 g EPS (1.8 lbs/ft³); (iv) 370.9 g PUR “A”; (v) 342.4 g PUR “B”; each provided and combined as described above to generate a composite block having dimensions of approximately 1″×12″×12″ and having a density of approximately 21 lbs/ft³.

The resulting block was then cut into four 3″ wide strips. Pairs of strips were taken and one was placed on top of the other. The resulting stacked Petrifoam™ structure was nailed together with a THS Masonry 2½ nail manufactured by Grip Rite™ Fas'ners.

A standard claw hammer was then applied to pry the nails out of the composite structure. It was observed that the 2½″ masonry nails could only be pried out of the composite by applying such force that the nails bent and became noticeably hot to the touch.

### EXAMPLE 26

### Illustrative Composite Exhibiting Enhanced Railroad Spike Pull Resistance

As described herein, the methods and compositions of the present invention can be applied to the generation of any of a variety of composite materials exhibiting various features that are desirable for particular applications, which features can be evaluated in relatively simple test methods to facilitate identifying and assessing exemplary composites.

By way of illustration, one feature that is desirable in applications such as the production of railroad ties is an increased resistance to railroad spike pull. Applying the methods as described herein, the railroad spike pull resistance was examined of a composite material based on the following formulation: (i) 600.3 g Perlite (5.5 lbs/ft³); (ii) 600.3 g Rubber (10 Mesh); (iii) 514.5 g EPS (1.8 lbs/ft³); (iv) 2969.9 g PUR “A”; (v) 2741.5 g PUR “B”; each provided and combined as described above to generate a composite block having dimensions of approximately 1.5″×12″×66″ and having a density of approximately 21.8 lbs/ft³.

The resulting composite material was then cut into 1 to 2′ sections. Two of these sections were then stacked on top of each other. A ½″ inch spade drill bit was uses to pre- drill a pilot hole through the two layers of PetriFoam™. A square railroad spike with dimensions of 0.5″ per side (having a corner to corner diagonal distance of 0.7″) was then hammered into the pilot hole.

Following insertion of the railroad spike into the composite material, a number of unsuccessful attempts were made to remove the spike by applying force. Even placing feet on the sample flanking the spike and pulling with both hands proved inadequate to remove the spike from the composite.

### EXAMPLE 27

### Generation of Molded Composites and Illustrative Mold Release Agents and Separators

Among the advantages of structural and other composite materials of the present invention are their inherent susceptibility to preparation in any of a variety of molded forms which can be used to make an essentially unlimited variety of objects of various shapes. Ease of molding can also be an important advantage in multi-stage processing. For example, channels incorporated into a composite article in a first stage can be used to facilitate and direct introduction of liquids used in subsequent processing stages.

A variety of compositions known in the art can be used to facilitate release of composite articles from molds. By examining the ease of release of articles from test molds that have been treated with a variety of available agents, those that are particularly useful with a particular combination of composite material and other process components can be readily determined. Without wishing to be bound by theory, it is believed that composite materials of the sort exemplified above are generally more readily released from surfaces of relatively lower energy (such as surfaces coated with wax or other low energy releasing agent) than surfaces of relatively higher energy (such as metals to which the composites can bind relatively tightly).

By way of illustration of the preparation of multiple molded samples of composite that can then be separated from each other after curing, an EPS-based composite was prepared using 1.8 lb/ft³ EPS beads as follows: EPS 51 g, PUR A 78.5 g, PUR B 72.5 g. This formulation was mixed and poured into a mold set for a 12″×12″×½″ thick block. After mixing, thin strips (approximately ⅛″ thick×½″ high×12″ long) of two relatively low energy materials were inserted into the mix vertically to cause the material to be formed into five separate blocks (each of approximately 2¼″×½″×12″). Two strips comprised polytetrafluoroethylene (PTFE) and two strips comprised high density polyethylene (HDPE). The mold was filled to approximately 150% and then compressed using a Carver press for approximately 20 minutes.

After removal from press, and removal of the material from the mold, it was observed that with the slightest bending pressure the sample readily and cleanly separated into five component blocks. There appeared to be slightly more residue on the HDPE surface than with PTFE but both could be readily cleaned up with solvents such as acetone.

### EXAMPLE 28

### Generation of Multi-Component Shaped Composites

Many multi-component composite structures employing foam cores are known in the art. Most commonly these incorporate foam cores that are supplied as flat sheets or blocks. For the many applications in which a core other than a simple sheet or block form is desired, it has often been prepared by using scored foam core materials that are held together with a scrim and which can then be bent into certain limited shapes (particularly those involving a relatively low radius of curvature). Preparation can also involve cutting of desired component shapes which can then be glued into place. These additional steps and manipulations add complexity and cost to production processes needed to produce articles comprising such “shaped cores”.

Another series of problems faced in industries making shaped objects out of rectilinear foam cores relate to the health and environmental concerns regarding a number of foam core processing procedures. For example, where foam cores are incorporated into sandwich structures, it is typical that a lightweight but relatively weak core is laminated or coated with one or more materials designed to provide a strong outer surface to the article, such as fiberglass and/or resins. Two commonly used types of resins for such purposes are polyester (typically polyester/styrene mixes) and epoxy resins. While the latter tends to result in a tougher physical surface it is also generally more expensive and more difficult to work with, making polyester/styrene resins the choice for many common applications. Fiberglass is typically applied by “laying up” the fiberglass which may be already impregnated with resin and/or is subsequently coated with resin. Due to the manipulations involved, this process is often carried out in an open system (accessible to workers), in which case volatile organic compounds (VOCs) that are given off by the resin can impact workers. Even with protections for workers, the VOCs may be released into the environment, a concern which is the subject of increasing protections and reduction requirements.

As a result of the foregoing and related issues, there are a number of advantages to and/or needs for using closed molding systems such as vacuum bagging for resin application. In those regards, composites and methods of the present invention can be used to substantially facilitate such production procedures by being able to provide, inter alia, (i) cores in the actual shape desired (i.e. not requiring subsequent modifications or manipulations); and (ii) cores that have surface features such as grooves or channels that can be used to facilitate the movement of subsequently-applied materials such as resins over all desired parts of the core surface.

To exemplify the ability of composites and methods of the present invention to be applied to more complex shapes, such as those involving relatively high radii of curvature, composite articles were prepared shaped as annular rings or pipe sections. As an illustrative example, an annular ring was prepared having approximate dimensions as follows: 3 3/16″ high×2⅝″ thick (outer diameter 6⅛″ and inner diameter 3½″). For this example, an outer flexible retaining ring was held in place by a surrounding annular clamp and an inner retaining ring having an outer diameter of 3½″ was used to form the inner diameter of the composite article.

As an exemplary composite formulation, a perlite-EPS-polyurethane mix was used, as follows: perlite (5.5 lb/ft³) 67.7 g; EPS beads (1.8 lb/ft³) 22.6 g; PUR A 156.2 g; PUR B 144.2 g.

Two annular rings having dimensions as described above were readily formed. In order to also assess the strength of the resulting composite structures, the second annular ring was subsequently cut cross-sectionally to yield two smaller annular rings having heights of approximately 2″ and 1″ (and inner and outer diameters as described above). Each of the three resulting rings was then positioned on its side and a force of approximately 210 lbs was applied along the direction of the radius to assess whether the rings would yield to crushing or distorting forces. It was observed that even the thinnest composite ring, having a height of only about 1 inch, successfully supported the applied 210 pound force.

As those of skill in the art will appreciate based on the detailed descriptions and illustrative examples provided herein, there are a number of known alternatives of components described and/or illustrated herein which can be employed to practice aspects of the present invention, and these are regularly being supplemented by additional components. Numerous technical references describing such alternatives, and methods applicable to the preparation and/or testing of such alternatives are available. For example, references describing various plastic polymers, additives, composites and related systems and processes include the following: Plastics Encyclopedia, by Dominick Rosato, 1993; Physics Of Plastics: Processing, Properties and Materials Engineering, by Jim Batchelor et al. 1992; Reaction of Polymers, by Wilson Gum et al., 1992; Plastics for Engineers: Materials, Properties and Applications, by Hans Dominghaus, 1993; Polymer Chemistry, by Raymond Seymour et al., Marcel Dekker Publ. 1988; Reactive Polymer Blending, by Warren E. Baker et al., 2001; Plastics Additives Handbook, by Hans Zweifel, 2001; Polymeric Foams and Foam Technology, by Daniel Klempner (ed.), Hanser Gardner Publ. 2004; Guide to Short Fiber Reinforced Plastics, by Roger F. Jones, 1998; Coloring of Plastics: Fundamentals, Colorants, Preparations, by Albrecht Muller, 2003; Plastics Flammability Handbook: Principles, Testing, Regulation and Approval, by Jurgen H. Troitzsch, 2004; Fire Retardant Materials, Horrocks and D. Price (eds), CRC Press, 2000; Discovering Polyurethanes, Konrad Uhlig, 1999; Polyurethane Handbook: Chemistry, Raw Materials, Processing, Application, Properties, by Gunter Oertel, 1994; Introduction to Industrial Polymers, by Henri Ulrich, 1993; Performance of Plastics, by Witold Brostow, 2000; Rheology of Polymeric Systems, by Pierre J. Carreau et al., 1997; Plastics: How Structure Determines Properties, by Geza Gruenwald, 1993; Polymeric Material and Processing: Plastics, Elastomers and Composites, by Jean-Michel Charrier et al., 1990; Composite Materials Technology: Processes and Properties, by P. K. Mallick, 1990; Compression Molding, by Bruce Davis et al, 2003; Plastics Failure Guide: Cause and Prevention, by Meyer Ezrin, 1996; Failure of Plastics, by Witold Brostow, 1986; Wear in Plastics Processing: How to Understand, Protect, and Avoid, by Gunter Menning, 1995; Polymer Interfaces: Structure and Strength, by Richard P. Wool, 1995; Polymer Engineering Principles, by Richard C, Progelhof et al., 1993; Polymer Mixing, by Chris Rauendaal, 1998; Polymeric Compatibilizers: Uses and Benefits in Polymer Blends, by Sudhin Datta et al., 1996; Materials Science of Polymers for Engineers, by Georg Menges, 2003; Reaction Injection Molding, by Christopher W. Makosko, 1988; Successful Injection Molding, by John Beaumont et al., 2002; Injection Molding Handbook, by Paul Gramann, 2001; Mold Engineering, by Herbert Rees, 2002; Mold Making Handbook for the Plastics Engineer, by Gunter Menning, 1998; Total Quality Process Control for Injection Molding, by Joseph M. Gordon, Jr., 1992; Adhesion and Adhesives Technology, by Alphonsus V. Pocius, 2002; Performance Enhancement in Coatings, by Edward W. Orr, 1998; Plastics and Coatings, by Rose Ryntz, 2001; Advanced Protective Coatings for Manufacturing and Engineering, by Wit Grzesik, 2003; and the like.

As those of skill in the art will appreciate based on the detailed descriptions and illustrative examples provided herein, the references cited in the preceding section are considered particularly pertinent to the extent that they relate to components and/or processes as described or illustrated herein as well as to alternatives of such components or processes.

The above description discloses several methods and materials of the present invention. This invention is susceptible to modifications in the methods and materials, as well as alterations in the fabrication methods and equipment. Such modifications will be apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims. All patents, applications, and other references cited herein are hereby incorporated by reference in their entirety.

1. A structural material comprising:
a porous material, wherein the porous material has a largest dimension in the range of about 0.05 mm up to about 60 mm, and a bead density in the range of about 0.1 kg/m³ up to about 1000 kg/m³, and
a polymer, wherein the polymer is prepared from a polymerizable component capable of curing at a temperature below the melting point of the porous material, wherein the polymer comprises a substantially solid matrix which encapsulates the porous material, and wherein filaments or other projections comprising the polymer extend into the porous material.

2. The structural material of claim 1, wherein the polymerizable component comprises a first polymerizable component which is capable of polymerizing within pores of the porous material, and a second polymerizable component which is capable of binding to polymers of the first polymerizable component, either directly or through a linker,
wherein the polymerizable components, upon curing, produce a substantially solid matrix which encapsulates and partially penetrates the porous material.

3. The structural material of claim 1 wherein the porous material is selected from the group consisting of polyolefins, gravel, glass beads, ceramics, vermiculite, perlite, lytag, pulverized fuel ash, unburned carbon, activated carbon, and mixtures of any two or more thereof.

4. The structural material of claim 1 wherein the porous material is an expanded bead comprising a polyolefin.

5. The structural material of claim 1 wherein the porous material comprises polystyrene.

6. The structural material of claim 1 wherein the porous material comprises expanded polystyrene beads.

7. The structural material of claim 5 wherein the porous material further comprises a copolymer of vinyl acetate ethylene.

8. The structural material of claim 7 wherein the porous material comprises an interpenetrating polymer network of polystyrene and a copolymer of vinyl acetate ethylene.

9. The structural material of claim 1 wherein the polymerizable component is selected from the group consisting of polyethylenes, polypropylenes, polyvinyl resins, acrylonitrile-butadiene-styrenes, polyurethanes, and mixtures of any two or more thereof.

10. The structural material of claim 1 wherein the polymerizable component is a polyurethane.

11. The structural material of claim 10 wherein the polyurethane is prepared from at least one aromatic diisocyanate selected from the group consisting of m- phenylene diisocyanate, p-phenylene diisocyanate, 4,4′-diphenylmethane diisocyanate, 2,4- tolylene diisocyanate, 3,3′-dimethyl-4,4′-biphenylene diisocyanate, durene diisocyanate, 4,4′-diphenylisopropylidene diisocyanate, 4,4′-diphenyl sulfone diisocyanate, 4,4′-diphenyl ether diisocyanate, biphenylene diisocyanate, and 1,5-naphthalene diisocyanate, and at least one polyol selected from the group consisting of ethylene glycol, 1,2-propanediol, 1,4- butanediol, 1,4-cyclohexanediol, glycerol, 1,2,4-butanetriol, trimethylol propane, poly(vinyl alcohol), and partially hydrolyzed cellulose acetate.

12. The structural material of claim 10 wherein the polyurethane is prepared from a two-component system comprising a polymeric isocyanate and a polyether polyol.

13. The structural material of claim 12 wherein the polymeric isocyanate comprises 4,4′-diphenylmethane diisocyanate and the polyether polyol comprises hydroxyl terminated poly(oxyalkylene) polyether.

14. The structural material of claim 1 further comprising at least one additive selected from the group consisting of flow enhancers, plasticizers, cure retardants, cure accelerators, strength enhancers, UV protectors, dyes, pigments, fillers, and fire retardants.

15. The structural material of claim 1 wherein the largest dimension of the porous material falls in the range of about 0.4 mm up to about 5 mm.

16. The structural material of claim 1 wherein the porous material comprises in the range of about 80 up to about 99 volume percent of the structural material.

17. The structural material of claim 1 wherein the porous material comprises in the range of about 15 wt. % up to about 40 wt. % of the structural material.

18. The structural material of claim 1 wherein the compression modulus of the structural material is at least about 8000 psi.

19. The structural material of claim 1 wherein the compression modulus of the structural material falls in the range of about 8000 psi up to about 10,000 psi.

20. The structural material of claim 1 wherein the flexural modulus of the structural material is at least about 10,000 psi.

21. The structural material of claim 1 wherein the flexural modulus of the structural material falls in the range of about 10,000 psi up to about 14,000 psi.

22. The structural material of claim 1 wherein the material has an R-value per inch thickness of at least 3.

23. The structural material of claim 1 further comprising one or more reinforcement structures contained within, wherein the reinforcement structure is a lattice comprising rigid fiber, plastic, metal or a combination thereof.

24. The structural material of claim 1 further comprising one or more reinforcement materials selected from the group consisting of natural fibers, synthetic fibers, and combinations thereof.

25. The structural material of claim 1 further comprising at least one facing material applied thereto.

26. The structural material of claim 25 wherein the facing material is selected from the group consisting of metal, polymer, cloth, glass, ceramic, natural fiber, synthetic fiber, and combinations of any two or more thereof.

27. The structural material of claim 25 wherein the facing material is selected from the group consisting of a solid surface, a porous surface, a surface that can be chemically etched, a chemically etched surface, a surface that can be physically abraded, a physically abraded surface, and combinations of any two or more thereof.

28. The structural material of claim 1 wherein the structural material emits substantially no off-gases.

29. The structural material of claim 1 wherein the matrix is flexible.

30. The structural material of claim 1 wherein the matrix is rigid.

31. The structural material of claim 1 wherein the structural material is essentially water proof, UV stable, and substantially resistant to degradation caused by exposure to insects, fungi, moisture, and atmospheric conditions.

32. A structural material comprising:
a porous material, wherein the porous material has a largest dimension in the range of about 0.05 mm up to about 60 mm, and a bead density in the range of about 0.1 kg/m³ up to about 1000 kg/m³, and
a flexible polymeric matrix, wherein the polymeric matrix is prepared from a gas-generating polymerizable component capable of curing at a temperature below the melting point of the porous material, wherein the polymeric matrix comprises a resilient, substantially impervious matrix providing a dimensionally stable structure which encapsulates the porous material, and wherein filaments or other projections comprising the polymer extend into the porous material.

33. A material comprising:
a porous material, and
a polymer, wherein the polymer comprises a matrix which substantially encapsulates the porous material, wherein the matrix is substantially solid, and wherein filaments or other projections comprising the polymer extend into the porous material.

34. An article having a defined shape, compression strength exceeding 40 psi, and shear strength exceeding 40 psi, the article comprising a polymer matrix containing a porous material substantially uniformly distributed therethrough, wherein filaments or other projections comprising the polymer extend into the porous material.

35. The article of claim 34 wherein the compression modulus is at least about 8000 psi.

36. The article of claim 34 wherein the compression modulus of the structural material falls in the range of about 8000 psi up to about 10,000 psi.

37. The article of claim 34 wherein the flexural modulus is at least about 10,000 psi.

38. The article of claim 34 wherein the matrix is rigid.

39. The article of claim 38 wherein the article is selected from the group consisting of a building panel, a structural reinforcement, soundproofing, insulation, waterproofing, a countertop, a swimming pool, a swimming pool cover, a surfboard, a hot tub, a hot tub cover, a cooling tower, a bathtub, a shower unit, a storage tank, an automotive component, and a personal watercraft component.

40. The article of claim 38 wherein the article is a surfboard.

41. The article of claim 40 wherein the polymer matrix comprises polyurethane and the porous material comprises expanded polyolefin beads.

42. The article of claim 38 wherein the article is a hot tub.

43. The article of claim 42 wherein the hot tub comprises a rigid shell surrounded by a layer comprising the polymer matrix containing a porous material substantially uniformly distributed therethrough.

44. The article of claim 42 wherein the polymer matrix comprises polyurethane and the porous material comprises expanded polyolefin beads.

45. The article of claim 39 wherein the matrix is flexible.

46. The article of claim 45 wherein the article is selected from the group consisting of soundproofing, insulation, waterproofing, an automotive component, furniture padding, and impact absorption barriers.

47. A method of making a structural material according to claim 33, the method comprising:
combining porous material and a polymerizable component, and
subjecting the resulting combination, in a mold, to conditions suitable to cure the polymerizable component, whereby any gases generated during curing are substantially absorbed by the porous material, and wherein a portion of the polymerizable component is forced into the porous material, thereby producing the structural material, wherein the structural material comprises the porous material encapsulated in a substantially solid polymer matrix, and wherein filaments or other projections comprising the polymer extend at least partially into the porous material.

48. The method of claim 47 wherein the resulting combination is further contacted with a second polymerizable component, wherein the first polymerizable component polymerizes substantially within the porous material and the second polymerizable component polymerizes substantially outside of the porous material, and wherein the first and second polymerizable components become joined to each other either directly or through a linker.

49. The method of claim 47 wherein curing is conducted under conditions whereby substantially no foam is generated in the solid polymer matrix.

50. The method of claim 47 wherein combining comprises substantially completely coating a surface of the porous material with a precursor of the polymerizable component.

51. The method of claim 47 wherein conditions suitable to allow the polymerizable component to polymerize comprise adding a polymerizing agent to the combination of porous material and precursor of the polymerizable component.

52. The method of claim 51 wherein the combination comprising the porous material, the precursor of the polymerizable component, and the polymerizing agent is vibrated after introduction of polymerizing agent thereto.

53. The method of claim 47 wherein the polymerizable component has a viscosity in the range of about 200 up to about 50,000 centipoise.

54. The method of claim 47 wherein the polymerizable component is stable to temperatures of at least about 50° C.

55. The method of claim 47 wherein substantially no off-gases are generated upon cure.

56. The method of claim 47, further comprising applying a coating to the structural material, wherein the coating is selected from the group consisting of a fireproof coating, a fire retardant coating, a non-slip coating, a wood facing, an acrylic facing, and a woven fabric facing.

57. The method of claim 47, further comprising forming the structural material into a predetermined shape.

58. The method of claim 47, further comprising subjecting the structural material to compression energy sufficient to reduce a thickness of the structural material.

59. The method of claim 47, further comprising cutting the structural material into a defined shape.

60. The method of claim 47, further comprising drilling a defined shape into the structural material.

61. The method of claim 47 wherein at least a portion of the porous material is recycled (ground) structural material.

62. The method of claim 47, further comprising grinding and recycling the structural material.

63. The method of claim 47, further comprising subjecting the structural material to at least one of chemical etching and physical etching.

64. The method of claim 47, further comprising subjecting the structural material to a compression pressure for a time sufficient to increase the compression modulus of the structural material to at least 20,000 psi, and to increase the flexural modulus of the structural material to at least about 10,000 psi up to about 14,000 psi.

65. A method of making a structural material according to claim 33, the method comprising subjecting the combination of a porous material and a gas- generating polymerizable component, in a closed mold, to conditions suitable to cure the gas- generating polymerizable component, whereby gases generated during curing are substantially absorbed by the porous material, and wherein a portion of the polymerizable component is forced into the porous material, thereby producing the structural material, wherein the structural material comprises the porous material encapsulated in a solid polymer matrix, and wherein filaments or other projections comprising the polymer extend at least partially into the porous material.

66. A product produced by the method of claim 47.

67. A formulation comprising:
a porous material,
a gas-generating or other polymerizable component, and
at least one additive selected from the group consisting of flow enhancers, plasticizers, cure retardants, cure accelerators, strength enhancers, UV protectors, dyes, pigments and fillers,
wherein the porous material has a largest dimension in the range of about 0.05 mm up to about 60 mm, and a bead density in the range of about 0.1 kg/m³ up to about 1000 kg/m³, and
wherein the gas-generating or other polymerizable component is capable of curing at a temperature below the melting point of the porous material, wherein the gas-generating or other polymerizable component, upon curing, produces a substantially impervious solid matrix which encapsulates the porous material, and wherein filaments or other projections comprising the polymer extend at least partially into the porous material.

68. A formulation comprising:
a porous material, and
a gas-generating or other polymerizable component,
wherein the porous material is not expanded polystyrene, and has a largest dimension in the range of about 0.05 mm up to about 60 mm, and a bead density in the range of about 0.1 kg/m³ up to about 1000 kg/m³, and
wherein the gas-generating or other polymerizable component is capable of curing at a temperature below the melting point of the porous material, wherein the gas-generating or other polymerizable component, upon curing, produces a substantially impervious solid matrix which encapsulates the porous material, and wherein filaments or other projections comprising the polymer extend at least partially into the porous material.

69. A formulation comprising:
a porous material, and
a gas-generating or other polymerizable component,
wherein the porous material has a largest dimension in the range of about 0.05 mm up to about 60 mm, and a bead density in the range of about 0.1 kg/m³ up to about 1000 kg/m³, and
wherein the gas-generating or other polymerizable component is not a polyurethane, and is capable of curing at a temperature below the melting point of the porous material, wherein the gas-generating or other polymerizable component, upon curing, produces a substantially impervious solid matrix which encapsulates the porous material, and wherein filaments or other projections comprising the polymer extend at least partially into the porous material.

70. A method of modifying an article according to claim 34, said article comprising a flexible or rigid polymeric matrix containing porous material, substantially uniformly distributed therethrough, wherein filaments or other projections comprising the polymer extend at least partially into the porous material, the method comprising applying a fireproof coating thereon, a non-slip coating, a wood facing thereon, an acrylic facing thereon, or a woven fabric facing thereon.

71. A method of modifying an article according to claim 34, said article comprising a flexible or rigid polymeric matrix containing porous material, substantially uniformly distributed therethrough, wherein filaments or other projections comprising the polymer extend at least partially into the porous material, the method comprising forming the article into a predetermined shape.

72. A method of modifying an article according to claim 34, said article comprising a rigid polymeric matrix containing porous material substantially uniformly distributed therethrough, wherein filaments or other projections comprising the polymer extend at least partially into the porous material, the method comprising subjecting the article to sufficient compression energy to reduce the thickness thereof.

73. A method of modifying an article according to claim 34, said article comprising a flexible or rigid polymeric matrix containing porous material substantially uniformly distributed therethrough, wherein filaments or other projections comprising the polymer extend at least partially into the porous material, the method comprising cutting and/or drilling desirable shapes into the article.

74. A product produced by the method of claim 65.
